(19) United States
(12) Patent Application Publication
(10) Pub. No.: US 2026/0141659 A1
(43) Pub. Date: May 21, 2026

(54) PLACEMENT OF REMOTE USERS IN THREE-DIMENSIONAL ENVIRONMENTS WITHIN MULTI-USER COMMUNICATION SESSIONS

(71) Applicant: Apple Inc., Cupertino, CA (US)

(72) Inventors: Kevin LEE, San Jose, CA (US); Anish KANNAN, Sunnyvale, CA (US); Alexander Burling RODRIGUEZ, Woodside, CA (US); Connor A. SMITH, San Jose, CA (US)

(21) Appl. No.: 19/379,603

(22) Filed: Nov. 4, 2025

Related U.S. Application Data
(60) Provisional application No. 63/721,709, filed on Nov. 18, 2024.
(60) Provisional application No. 63/765,162, filed on Feb. 28, 2025.
(60) Provisional application No. 63/813,209, filed on May 28, 2025.

(51) Int. Cl. G06T 19/20; G06F 3/04815

(52) U.S. Cl. CPC G06T 19/20; G06F 3/04815; G06T 2219/024; G06T 2219/2004

(57) ABSTRACT

Some examples of the disclosure are directed to systems and methods for determining a placement location for a visual representation of a remote user in a three-dimensional environment that includes a shared application within a multi-user communication session that includes a group of collocated users when initiating the multi-user communication session. Some examples of the disclosure are directed to systems and methods for displaying a visual representation of a remote user in a three-dimensional environment within a multi-user communication session that includes a group of collocated users when initiating the multi-user communication session.

### CROSS-REFERENCE TO RELATED APPLICATIONS

This application claims the benefit of U.S. Provisional Application No. 63/813,209, filed May 28, 2025, U.S. Provisional Application No. 63/765,162, filed Feb. 28, 2025, and U.S. Provisional Application No. 63/721,709, filed Nov. 18, 2024, the contents of which are herein incorporated by reference in their entireties for all purposes.

### FIELD OF THE DISCLOSURE

This relates generally to systems and methods of establishing multi-user communication sessions in which at least a subset of participants within the multi-user communication sessions is collocated in a physical environment.

### BACKGROUND OF THE DISCLOSURE

Some computer graphical environments provide two-dimensional and/or three-dimensional environments where at least some objects displayed for a user's viewing are virtual and generated by a computer. In some examples, the three-dimensional environments are presented by multiple devices communicating in a multi-user communication session. In some examples, an avatar (e.g., a representation) of each non-collocated user participating in the multi-user communication session (e.g., via the computing devices) is displayed in the three-dimensional environment of the multi-user communication session. In some examples, content can be shared in the three-dimensional environment for viewing and interaction by multiple users participating in the multi-user communication session.

### SUMMARY OF THE DISCLOSURE

Some examples of the disclosure are directed to systems and methods for determining a placement location for a visual representation of a remote user in a three-dimensional environment that includes a shared application within a multi-user communication session that includes a group of collocated users when initiating the multi-user communication session. In some examples, a method is performed at a first electronic device in communication with one or more displays and one or more input devices, wherein the first electronic device is collocated with a second electronic device in a physical environment. In some examples, while in a multi-user communication session with the second electronic device and while presenting, via the one or more displays, a shared object in a three-dimensional environment, the first electronic device detects an indication of a request to add a third electronic device, different from the first electronic device and the second electronic device, to the multi-user communication session, wherein the third electronic device is non-collocated with the first electronic device and the second electronic device in the physical environment. In some examples, in response to detecting the indication, the first electronic device adds the third electronic device to the multi-user communication session that includes the first electronic device and the second electronic device, including: determining a placement location relative to the shared object in the three-dimensional environment at which to present a visual representation of a user of the third electronic device, wherein the placement location is determined based on a first location of the first electronic device in the physical environment and a second location of the second electronic device in the physical environment; and presenting, via the one or more displays, the visual representation of the user of the third electronic device at the placement location that is relative to the shared object in the three-dimensional environment.

Some examples of the disclosure are directed to systems and methods for determining a placement location for a visual representation of a remote user in a three-dimensional environment that includes a shared application within a multi-user communication session that includes a group of collocated users when initiating the multi-user communication session. In some examples, a method is performed at a first electronic device in communication with one or more displays and one or more input devices, wherein the first electronic device is collocated with a second electronic device in a physical environment. In some examples, while in a multi-user communication session with the second electronic device and while presenting, via the one or more displays, a shared object in a three-dimensional environment, the first electronic device detects an indication of a request to add a third electronic device, different from the first electronic device and the second electronic device, to the multi-user communication session, wherein the third electronic device is non-collocated with the first electronic device and the second electronic device in the physical environment. In some examples, in response to detecting the indication, the first electronic device adds the third electronic device to the multi-user communication session that includes the first electronic device and the second electronic device, including associating the multi-user communication session with a first spatial template in the three-dimensional environment. In some examples, associating the multi-user communication session with the first spatial template includes: identifying a first spatial group that includes the first electronic device and the second electronic device, wherein the first spatial group is based on a first location of the first electronic device in the physical environment and a second location of the second electronic device in the physical environment; and aligning the first spatial group with a first plurality of seats within the first spatial template in the three-dimensional environment.

Some examples of the disclosure are directed to systems and methods for displaying a visual representation of a remote user in a three-dimensional environment within a multi-user communication session that includes a group of collocated users when initiating the multi-user communication session. In some examples, a method is performed at a first electronic device in communication with one or more displays and one or more input devices, wherein the first electronic device is collocated with a second electronic device in a physical environment. In some examples, while in a multi-user communication session with the second electronic device, the first electronic device detects an indication of a request to add a third electronic device, different from the first electronic device and the second electronic device, to the multi-user communication session, wherein the third electronic device is non-collocated with the first electronic device and the second electronic device in the physical environment. In some examples, in response to detecting the indication, the first electronic device adds the third electronic device to the multi-user communication session that includes the first electronic device and the second electronic device, including: determining a placement location in the three-dimensional environment at which to present a two-dimensional representation of a user of the third electronic device, wherein the placement location is determined based on a first pose of the first electronic device in the physical environment and a second pose of the second electronic device in the physical environment; and presenting, via the one or more displays, the two-dimensional representation of the user of the third electronic device at the placement location in the three-dimensional environment.

Some examples of the disclosure are directed to systems and methods for displaying a visual representation of a remote user in a three-dimensional environment within a multi-user communication session that includes a group of collocated users when initiating the multi-user communication session. In some examples, a method is performed at a first electronic device in communication with one or more displays and one or more input devices, wherein the first electronic device is collocated with a second electronic device in a physical environment. In some examples, while in a multi-user communication session with the second electronic device, the first electronic device detects an indication of a request to add a third electronic device, different from the first electronic device and the second electronic device, to the multi-user communication session, wherein the third electronic device is non-collocated with the first electronic device and the second electronic device in the physical environment. In some examples, in response to detecting the indication, the first electronic device adds the third electronic device to the multi-user communication session that includes the first electronic device and the second electronic device. In some examples, the first electronic device identifies a first spatial group that includes the first electronic device and the second electronic device, wherein the first spatial group is based on a first location of the first electronic device in the physical environment and a second location of the second electronic device in the physical environment. In some examples, the first electronic device determines a placement location relative to the first spatial group in the three-dimensional environment at which to present a visual representation of a user of the third electronic device. In some examples, the first electronic device presents, via the one or more displays, the visual representation of the user of the third electronic device at the placement location that is relative to the first spatial group in the three-dimensional environment.

Some examples of the disclosure are directed to systems and methods for updating a spatial arrangement of virtual content in a three-dimensional environment relative to a group of collocated users within a hybrid multi-user communication session. In some examples, a method is performed at a first electronic device in communication with one or more displays and one or more input devices, wherein the first electronic device is collocated with a second electronic device in a physical environment. In some examples, while in a multi-user communication session with the second electronic device and a third electronic device, different from the first electronic device and the second electronic device, wherein the third electronic device is non-collocated with the first electronic device and the second electronic device in the physical environment, the first electronic device concurrently presents, via the one or more displays, a visual representation of a user of the third electronic device and a shared object corresponding to content in a three-dimensional environment. In some examples, while concurrently presenting the visual representation of the user of the third electronic device at the first location and the shared object corresponding to the content in the three-dimensional environment, the first electronic device detects an indication of a request to cease sharing the content within the multi-user communication session. In some examples, in response to detecting the indication, the first electronic device ceases presenting, via the one or more displays, the shared object corresponding to the content in the three-dimensional environment, including: identifying one or more candidate locations corresponding to openings in a first spatial arrangement of the first electronic device and the second electronic device in the physical environment; determining an updated placement location for the visual representation of the user of the third electronic device relative to the one or more candidate locations in the three-dimensional environment; and presenting, via the one or more displays, the visual representation of the user of the third electronic device at the updated placement location in the three-dimensional environment.

The full descriptions of these examples are provided in the Drawings and the Detailed Description, and it is understood that this Summary does not limit the scope of the disclosure in any way.

### BRIEF DESCRIPTION OF THE DRAWINGS

For improved understanding of the various examples described herein, reference should be made to the Detailed Description below along with the following drawings. Like reference numerals often refer to corresponding parts throughout the drawings.

FIG. 1 illustrates an electronic device presenting an extended reality environment according to some examples of the disclosure.

FIG. 2 illustrates a block diagram of an example architecture for a system according to some examples of the disclosure.

FIG. 3 illustrates an example of a spatial group in a multi-user communication session that includes a first electronic device and a second electronic device according to some examples of the disclosure.

FIGS. 4A-4W illustrate examples of displaying one or more visual representations of non-collocated users in a three-dimensional environment within a multi-user communication session that includes collocated and non-collocated users according to some examples of the disclosure.

FIGS. 5A-5M illustrate examples of displaying one or more visual representations of non-collocated users in a three-dimensional environment within a multi-user communication session that includes collocated and non-collocated users according to some examples of the disclosure.

FIGS. 6A-6V illustrate examples of displaying one or more visual representations of non-collocated users in a three-dimensional environment within a multi-user communication session that includes collocated and non-collocated users according to some examples of the disclosure.

FIG. 7 illustrates a flow diagram illustrating an example process for establishing a multi-user communication session among a plurality of electronic devices in which at least a subset of the plurality of electronic device are non-collocated according to some examples of the disclosure.

FIG. 8 illustrates a flow diagram illustrating an example process for establishing a multi-user communication session among a plurality of electronic devices in which at least a subset of the plurality of electronic device are non-collocated according to some examples of the disclosure.

FIG. 9 illustrates a flow diagram illustrating an example process for establishing a multi-user communication session among a plurality of electronic devices in which at least a subset of the plurality of electronic device are non-collocated according to some examples of the disclosure.

FIGS. 10A-10K illustrate examples of displaying one or more visual representations of non-collocated users in a three-dimensional environment within a multi-user communication session that includes collocated and non-collocated users according to some examples of the disclosure.

FIG. 11 illustrates a flow diagram illustrating an example process for establishing a multi-user communication session among a plurality of electronic devices in which at least a subset of the plurality of electronic device are non-collocated according to some examples of the disclosure.

FIG. 12 illustrates a flow diagram illustrating an example process for updating a spatial arrangement of virtual content in a three-dimensional environment relative to a group of collocated users within a hybrid multi-user communication session according to some examples of the disclosure.

### DETAILED DESCRIPTION

Some examples of the disclosure are directed to systems and methods for determining a placement location for a visual representation of a remote user in a three-dimensional environment that includes a shared application within a multi-user communication session that includes a group of collocated users when initiating the multi-user communication session. In some examples, a method is performed at a first electronic device in communication with one or more displays and one or more input devices, wherein the first electronic device is collocated with a second electronic device in a physical environment. In some examples, while in a multi-user communication session with the second electronic device and while presenting, via the one or more displays, a shared object in a three-dimensional environment, the first electronic device detects an indication of a request to add a third electronic device, different from the first electronic device and the second electronic device, to the multi-user communication session, wherein the third electronic device is non-collocated with the first electronic device and the second electronic device in the physical environment. In some examples, in response to detecting the indication, the first electronic device adds the third electronic device to the multi-user communication session that includes the first electronic device and the second electronic device, including: determining a placement location relative to the shared object in the three-dimensional environment at which to present a visual representation of a user of the third electronic device, wherein the placement location is determined based on a first location of the first electronic device in the physical environment and a second location of the second electronic device in the physical environment; and presenting, via the one or more displays, the visual representation of the user of the third electronic device at the placement location that is relative to the shared object in the three-dimensional environment.

Some examples of the disclosure are directed to systems and methods for determining a placement location for a visual representation of a remote user in a three-dimensional environment that includes a shared application within a multi-user communication session that includes a group of collocated users when initiating the multi-user communication session. In some examples, a method is performed at a first electronic device in communication with one or more displays and one or more input devices, wherein the first electronic device is collocated with a second electronic device in a physical environment. In some examples, while in a multi-user communication session with the second electronic device and while presenting, via the one or more displays, a shared object in a three-dimensional environment, the first electronic device detects an indication of a request to add a third electronic device, different from the first electronic device and the second electronic device, to the multi-user communication session, wherein the third electronic device is non-collocated with the first electronic device and the second electronic device in the physical environment. In some examples, in response to detecting the indication, the first electronic device adds the third electronic device to the multi-user communication session that includes the first electronic device and the second electronic device, including associating the multi-user communication session with a first spatial template in the three-dimensional environment. In some examples, associating the multi-user communication session with the first spatial template includes: identifying a first spatial group that includes the first electronic device and the second electronic device, wherein the first spatial group is based on a first location of the first electronic device in the physical environment and a second location of the second electronic device in the physical environment; and aligning the first spatial group with a first plurality of seats within the first spatial template in the three-dimensional environment.

Some examples of the disclosure are directed to systems and methods for displaying a visual representation of a remote user in a three-dimensional environment within a multi-user communication session that includes a group of collocated users when initiating the multi-user communication session. In some examples, a method is performed at a first electronic device in communication with one or more displays and one or more input devices, wherein the first electronic device is collocated with a second electronic device in a physical environment. In some examples, while in a multi-user communication session with the second electronic device, the first electronic device detects an indication of a request to add a third electronic device, different from the first electronic device and the second electronic device, to the multi-user communication session, wherein the third electronic device is non-collocated with the first electronic device and the second electronic device in the physical environment. In some examples, in response to detecting the indication, the first electronic device adds the third electronic device to the multi-user communication session that includes the first electronic device and the second electronic device, including: determining a placement location in the three-dimensional environment at which to present a two-dimensional representation of a user of the third electronic device, wherein the placement location is determined based on a first pose of the first electronic device in the physical environment and a second pose of the second electronic device in the physical environment; and presenting, via the one or more displays, the two-dimensional representation of the user of the third electronic device at the placement location in the three-dimensional environment.

Some examples of the disclosure are directed to systems and methods for displaying a visual representation of a remote user in a three-dimensional environment within a multi-user communication session that includes a group of collocated users when initiating the multi-user communication session. In some examples, a method is performed at a first electronic device in communication with one or more displays and one or more input devices, wherein the first electronic device is collocated with a second electronic device in a physical environment. In some examples, while in a multi-user communication session with the second electronic device, the first electronic device detects an indication of a request to add a third electronic device, different from the first electronic device and the second electronic device, to the multi-user communication session, wherein the third electronic device is non-collocated with the first electronic device and the second electronic device in the physical environment. In some examples, in response to detecting the indication, the first electronic device adds the third electronic device to the multi-user communication session that includes the first electronic device and the second electronic device. In some examples, the first electronic device identifies a first spatial group that includes the first electronic device and the second electronic device, wherein the first spatial group is based on a first location of the first electronic device in the physical environment and a second location of the second electronic device in the physical environment. In some examples, the first electronic device determines a placement location relative to the first spatial group in the three-dimensional environment at which to present a visual representation of a user of the third electronic device. In some examples, the first electronic device presents, via the one or more displays, the visual representation of the user of the third electronic device at the placement location that is relative to the first spatial group in the three-dimensional environment.

Some examples of the disclosure are directed to systems and methods for updating a spatial arrangement of virtual content in a three-dimensional environment relative to a group of collocated users within a hybrid multi-user communication session. In some examples, a method is performed at a first electronic device in communication with one or more displays and one or more input devices, wherein the first electronic device is collocated with a second electronic device in a physical environment. In some examples, while in a multi-user communication session with the second electronic device and a third electronic device, different from the first electronic device and the second electronic device, wherein the third electronic device is non-collocated with the first electronic device and the second electronic device in the physical environment, the first electronic device concurrently presents, via the one or more displays, a visual representation of a user of the third electronic device and a shared object corresponding to content in a three-dimensional environment. In some examples, while concurrently presenting the visual representation of the user of the third electronic device at the first location and the shared object corresponding to the content in the three-dimensional environment, the first electronic device detects an indication of a request to cease sharing the content within the multi-user communication session. In some examples, in response to detecting the indication, the first electronic device ceases presenting, via the one or more displays, the shared object corresponding to the content in the three-dimensional environment, including: identifying one or more candidate locations corresponding to openings in a first spatial arrangement of the first electronic device and the second electronic device in the physical environment; determining an updated placement location for the visual representation of the user of the third electronic device relative to the one or more candidate locations in the three-dimensional environment; and presenting, via the one or more displays, the visual representation of the user of the third electronic device at the updated placement location in the three-dimensional environment.

In some examples, a spatial group or state in the multi-user communication session denotes a spatial arrangement or template that dictates locations of users and content that are located in or otherwise associated with the spatial group. In some examples, users in the same spatial group within the multi-user communication session experience spatial truth according to the spatial arrangement of the spatial group. In some examples, when the user of the first electronic device is in a first spatial group and the user of the second electronic device is in a second spatial group in the multi-user communication session, the users experience spatial truth that is localized to their respective spatial groups. In some examples, while the user of the first electronic device and the user of the second electronic device are grouped into separate spatial groups or states within the multi-user communication session, if the first electronic device and the second electronic device return to the same operating state, the user of the first electronic device and the user of the second electronic device are regrouped into the same spatial group within the multi-user communication session.

As used herein, a hybrid spatial group corresponds to a group or number of participants (e.g., users) in a multi-user communication session in which at least a subset of the participants is non-collocated in a physical environment (e.g., therefore rendering the multi-user communication session a hybrid multi-user communication session). For example, as described via one or more examples in this disclosure, a hybrid spatial group includes at least two participants who are collocated in a first physical environment and at least one participant who is non-collocated with the at least two participants in the first physical environment (e.g., the at least one participant is located in a second physical environment, different from the first physical environment). In some examples, a hybrid spatial group in the multi-user communication session has a spatial arrangement that dictates locations of users and content that are located in the spatial group. In some examples, users in the same hybrid spatial group within the multi-user communication session experience spatial truth according to the spatial arrangement of the spatial group, as similarly discussed above.

In some examples, initiating a multi-user communication session may include interaction with one or more user interface elements. In some examples, a user's gaze may be tracked by an electronic device as an input for targeting a selectable option/affordance within a respective user interface element that is displayed in the three-dimensional environment. For example, gaze can be used to identify one or more options/affordances targeted for selection using another selection input. In some examples, a respective option/affordance may be selected using hand-tracking input detected via an input device in communication with the electronic device. In some examples, objects displayed in the three-dimensional environment may be moved and/or reoriented in the three-dimensional environment in accordance with movement input detected via the input device.

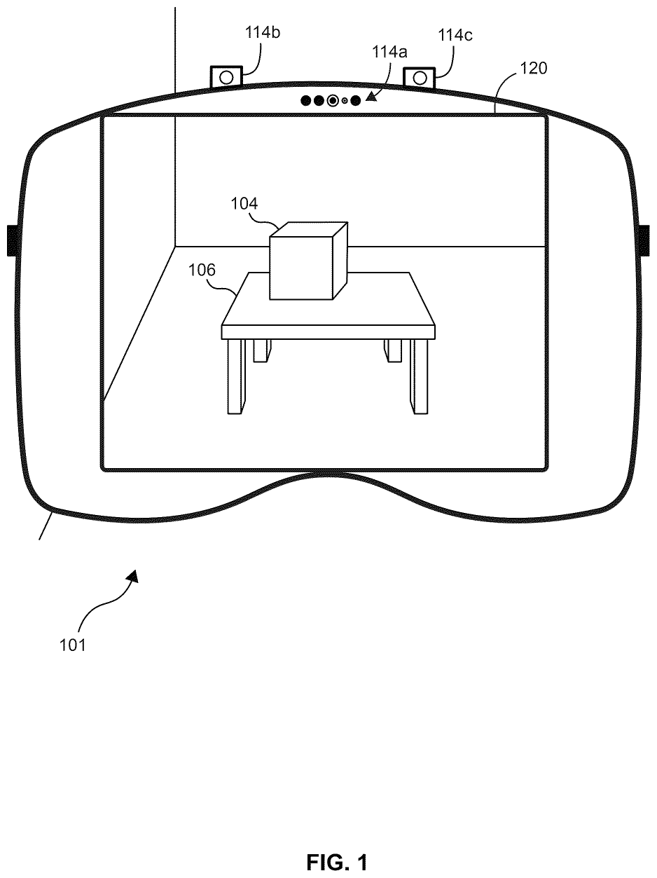

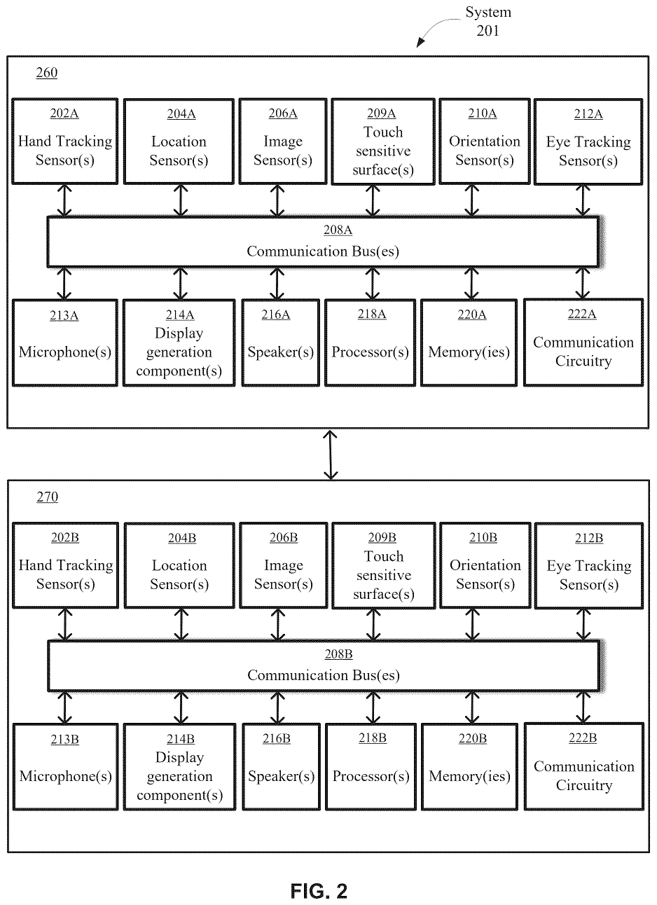

FIG. 1 illustrates an electronic device 101 presenting an extended reality (XR) environment (e.g., a computer-generated environment optionally including representations of physical and/or virtual objects) according to some examples of the disclosure. In some examples, as shown in FIG. 1, electronic device 101 is a head-mounted display or other head-mountable device configured to be worn on a head of a user of the electronic device 101. Examples of electronic device 101 are described below with reference to the architecture block diagram of FIG. 2. As shown in FIG. 1, electronic device 101 and table 106 are located in a physical environment. The physical environment may include physical features such as a physical surface (e.g., floor, walls) or a physical object (e.g., table, lamp, etc.). In some examples, electronic device 101 may be configured to detect and/or capture images of physical environment including table 106 (illustrated in the field of view of electronic device 101).

In some examples, as shown in FIG. 1, electronic device 101 includes one or more internal image sensors 114a oriented towards a face of the user (e.g., eye tracking cameras described below with reference to FIG. 2). In some examples, internal image sensors 114a are used for eye tracking (e.g., detecting a gaze of the user). Internal image sensors 114a are optionally arranged on the left and right portions of display 120 to enable eye tracking of the user's left and right eyes. In some examples, electronic device 101 also includes external image sensors 114b and 114c facing outwards from the user to detect and/or capture the physical environment of the electronic device 101 and/or movements of the user's hands or other body parts.

In some examples, display 120 has a field of view visible to the user (e.g., that may or may not correspond to a field of view of external image sensors 114b and 114c). Because display 120 is optionally part of a head-mounted device, the field of view of display 120 is optionally the same as or similar to the field of view of the user's eyes. In other examples, the field of view of display 120 may be smaller than the field of view of the user's eyes. In some examples, electronic device 101 may be an optical see-through device in which display 120 is a transparent or translucent display through which portions of the physical environment may be directly viewed. In some examples, display 120 may be included within a transparent lens and may overlap all or only a portion of the transparent lens. In other examples, electronic device may be a video-passthrough device in which display 120 is an opaque display configured to display images of the physical environment captured by external image sensors 114b and 114c. While a single display 120 is shown, it should be appreciated that display 120 may include a stereo pair of displays.

In some examples, in response to a trigger, the electronic device 101 may be configured to display a virtual object 104 in the XR environment represented by a cube illustrated in FIG. 1, which is not present in the physical environment, but is displayed in the XR environment positioned on the top of real-world table 106 (or a representation thereof). Optionally, virtual object 104 can be displayed on the surface of the table 106 in the XR environment displayed via the display 120 of the electronic device 101 in response to detecting the planar surface of table 106 in the physical environment 100.

It should be understood that virtual object 104 is a representative virtual object and one or more different virtual objects (e.g., of various dimensionality such as two-dimensional or other three-dimensional virtual objects) can be included and rendered in a three-dimensional XR environment. For example, the virtual object can represent an application or a user interface displayed in the XR environment. In some examples, the virtual object can represent content corresponding to the application and/or displayed via the user interface in the XR environment. In some examples, the virtual object 104 is optionally configured to be interactive and responsive to user input (e.g., air gestures, such as air pinch gestures, air tap gestures, and/or air touch gestures), such that a user may virtually touch, tap, move, rotate, or otherwise interact with, the virtual object 104.

In some examples, displaying an object in a three-dimensional environment may include interaction with one or more user interface objects in the three-dimensional environment. For example, initiation of display of the object in the three-dimensional environment can include interaction with one or more virtual options/affordances displayed in the three-dimensional environment. In some examples, a user's gaze may be tracked by the electronic device as an input for identifying one or more virtual options/affordances targeted for selection when initiating display of an object in the three-dimensional environment. For example, gaze can be used to identify one or more virtual options/affordances targeted for selection using another selection input. In some examples, a virtual option/affordance may be selected using hand-tracking input detected via an input device in communication with the electronic device. In some examples, objects displayed in the three-dimensional environment may be moved and/or reoriented in the three-dimensional environment in accordance with movement input detected via the input device.

In the discussion that follows, an electronic device that is in communication with a display generation component and one or more input devices is described. It should be understood that the electronic device optionally is in communication with one or more other physical user-interface devices, such as a touch-sensitive surface, a physical keyboard, a mouse, a joystick, a hand tracking device, an eye tracking device, a stylus, etc. Further, as described above, it should be understood that the described electronic device, display and touch-sensitive surface are optionally distributed amongst two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device, or touch input received on the surface of a stylus) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

FIG. 2 illustrates a block diagram of an example architecture for a system 201 according to some examples of the disclosure. In some examples, system 201 includes multiple devices. For example, the system 201 includes a first electronic device 260 and a second electronic device 270, wherein the first electronic device 260 and the second electronic device 270 are in communication with each other. In some examples, the first electronic device 260 and the second electronic device 270 are a portable device, such as a mobile phone, smart phone, a tablet computer, a laptop computer, an auxiliary device in communication with another device, a head-mounted display, etc., respectively. In some examples, the first electronic device 260 and the second electronic device 270 correspond to electronic device 101 described above with reference to FIG. 1.

As illustrated in FIG. 2, the first electronic device 260 optionally includes various sensors (e.g., one or more hand tracking sensors 202A, one or more location sensors 204A, one or more image sensors 206A, one or more touch-sensitive surfaces 209A, one or more motion and/or orientation sensors 210A, one or more eye tracking sensors 212A, one or more microphones 213A or other audio sensors, one or more body tracking sensors (e.g., torso and/or head tracking sensors), one or more display generation components 214A, one or more speakers 216A, one or more processors 218A, one or more memories 220A, and/or communication circuitry 222A. In some examples, the second electronic device 270 optionally includes various sensors (e.g., one or more hand tracking sensors 202B, one or more location sensors 204B, one or more image sensors 206B, one or more touch-sensitive surfaces 209B, one or more motion and/or orientation sensors 210B, one or more eye tracking sensors 212B, one or more microphones 213B or other audio sensors, one or more body tracking sensors (e.g., torso and/or head tracking sensors), one or more display generation components 214B, one or more speakers 216, one or more processors 218B, one or more memories 220B, and/or communication circuitry 222B. In some examples, the one or more display generation components 214A, 214B correspond to display 120 in FIG. 1. One or more communication buses 208A and 208B are optionally used for communication between the above-mentioned components of electronic devices 260 and 270, respectively. First electronic device 260 and second electronic device 270 optionally communicate via a wired or wireless connection (e.g., via communication circuitry 222A, 222B) between the two devices.

Communication circuitry 222A, 222B optionally includes circuitry for communicating with electronic devices, networks, such as the Internet, intranets, a wired network and/or a wireless network, cellular networks, and wireless local area networks (LANs). Communication circuitry 222A, 222B optionally includes circuitry for communicating using near-field communication (NFC) and/or short-range communication, such as Bluetooth®.

Processor(s) 218A, 218B include one or more general processors, one or more graphics processors, and/or one or more digital signal processors. In some examples, memory 220A, 220B is a non-transitory computer-readable storage medium (e.g., flash memory, random access memory, or other volatile or non-volatile memory or storage) that stores computer-readable instructions configured to be executed by processor(s) 218A, 218B to perform the techniques, processes, and/or methods described below. In some examples, memory 220A, 220B can include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on compact disc (CD), digital versatile disc (DVD), or Blu-ray technologies, as well as persistent solid-state memory such as flash, solid-state drives, and the like.

In some examples, display generation component(s) 214A, 214B include a single display (e.g., a liquid-crystal display (LCD), organic light-emitting diode (OLED), or other types of display). In some examples, display generation component(s) 214A, 214B includes multiple displays. In some examples, display generation component(s) 214A, 214B can include a display with touch capability (e.g., a touch screen), a projector, a holographic projector, a retinal projector, a transparent or translucent display, etc. In some examples, electronic devices 260 and 270 include touch-sensitive surface(s) 209A and 209B, respectively, for receiving user inputs, such as tap inputs and swipe inputs or other gestures. In some examples, display generation component(s) 214A, 214B and touch-sensitive surface(s) 209A, 209B form touch-sensitive display(s) (e.g., a touch screen integrated with electronic devices 260 and 270, respectively, or external to electronic devices 260 and 270, respectively, that is in communication with electronic devices 260 and 270).

Electronic devices 260 and 270 optionally include image sensor(s) 206A and 206B, respectively. Image sensors(s) 206A/206B optionally include one or more visible light image sensors, such as charged coupled device (CCD) sensors, and/or complementary metal-oxide-semiconductor (CMOS) sensors operable to obtain images of physical objects from the real-world environment. Image sensor(s) 206A/206B also optionally include one or more infrared (IR) sensors, such as a passive or an active IR sensor, for detecting infrared light from the real-world environment. For example, an active IR sensor includes an IR emitter for emitting infrared light into the real-world environment. Image sensor(s) 206A/206B also optionally include one or more cameras configured to capture movement of physical objects in the real-world environment. Image sensor(s) 206A/206B also optionally include one or more depth sensors configured to detect the distance of physical objects from electronic device 260/270. In some examples, information from one or more depth sensors can allow the device to identify and differentiate objects in the real-world environment from other objects in the real-world environment. In some examples, one or more depth sensors can allow the device to determine the texture and/or topography of objects in the real-world environment.

In some examples, electronic devices 260 and 270 use CCD sensors, event cameras, and depth sensors in combination to detect the physical environment around electronic devices 260 and 270. In some examples, image sensor(s) 206A/206B include a first image sensor and a second image sensor. The first image sensor and the second image sensor work in tandem and are optionally configured to capture different information of physical objects in the real-world environment. In some examples, the first image sensor is a visible light image sensor and the second image sensor is a depth sensor. In some examples, electronic device 260/270 uses image sensor(s) 206A/206B to detect the position and orientation of electronic device 260/270 and/or display generation component(s) 214A/214B in the real-world environment. For example, electronic device 260/270 uses image sensor(s) 206A/206B to track the position and orientation of display generation component(s) 214A/214B relative to one or more fixed objects in the real-world environment.

In some examples, electronic device 260/270 includes microphone(s) 213A/213B or other audio sensors. Device 260/270 uses microphone(s) 213A/213B to detect sound from the user and/or the real-world environment of the user. In some examples, microphone(s) 213A/213B includes an array of microphones (a plurality of microphones) that optionally operate in tandem, such as to identify ambient noise or to locate the source of sound in space of the real-world environment.

In some examples, device 260/270 includes location sensor(s) 204A/204B for detecting a location of device 260/270 and/or display generation component(s) 214A/214B. For example, location sensor(s) 204A/204B can include a global positioning system (GPS) receiver that receives data from one or more satellites and allows electronic device 260/270 to determine the device's absolute position in the physical world.

In some examples, electronic device 260/270 includes orientation sensor(s) 210A/210B for detecting orientation and/or movement of electronic device 260/270 and/or display generation component(s) 214A/214B. For example, electronic device 260/270 uses orientation sensor(s) 210A/210B to track changes in the position and/or orientation of electronic device 260/270 and/or display generation component(s) 214A/214B, such as with respect to physical objects in the real-world environment. Orientation sensor(s) 210A/210B optionally include one or more gyroscopes and/or one or more accelerometers.

Electronic device 260/270 includes hand tracking sensor(s) 202A/202B and/or eye tracking sensor(s) 212A/212B (and/or other body tracking sensor(s), such as leg, torso, and/or head tracking sensor(s)), in some examples. Hand tracking sensor(s) 202A/202B are configured to track the position/location of one or more portions of the user's hands, and/or motions of one or more portions of the user's hands with respect to the extended reality environment, relative to the display generation component(s) 214A/214B, and/or relative to another defined coordinate system. Eye tracking sensor(s) 212A/212B are configured to track the position and movement of a user's gaze (eyes, face, or head, more generally) with respect to the real-world or extended reality environment and/or relative to the display generation component(s) 214A/214B. In some examples, hand tracking sensor(s) 202A/202B and/or eye tracking sensor(s) 212A/212B are implemented together with the display generation component(s) 214A/214B. In some examples, the hand tracking sensor(s) 202A/202B and/or eye tracking sensor(s) 212A/212B are implemented separate from the display generation component(s) 214A/214B.

In some examples, the hand tracking sensor(s) 202A/202B (and/or other body tracking sensor(s), such as leg, torso, and/or head tracking sensor(s)) can use image sensor(s) 206A/206B (e.g., one or more IR cameras, 3D cameras, depth cameras, etc.) that capture three-dimensional information from the real-world including one or more body parts (e.g., hands, legs, or torso of a human user). In some examples, the hands can be resolved with sufficient resolution to distinguish fingers and their respective positions. In some examples, one or more image sensors 206A/206B are positioned relative to the user to define a field of view of the image sensor(s) 206A/206B and an interaction space in which finger/hand position, orientation and/or movement captured by the image sensors are used as inputs (e.g., to distinguish from a user's resting hand or other hands of other persons in the real-world environment). Tracking the fingers/hands for input (e.g., gestures, touch, tap, etc.) can be advantageous in that it does not require the user to touch, hold or wear any sort of beacon, sensor, or other marker.

In some examples, eye tracking sensor(s) 212A/212B includes at least one eye tracking camera (e.g., infrared (IR) cameras) and/or illumination sources (e.g., IR light sources, such as LEDs) that emit light towards a user's eyes. The eye tracking cameras may be pointed towards a user's eyes to receive reflected IR light from the light sources directly or indirectly from the eyes. In some examples, both eyes are tracked separately by respective eye tracking cameras and illumination sources, and a focus/gaze can be determined from tracking both eyes. In some examples, one eye (e.g., a dominant eye) is tracked by one or more respective eye tracking cameras/illumination sources.

Electronic device 260/270 and system 201 are not limited to the components and configuration of FIG. 2, but can include fewer, other, or additional components in multiple configurations. In some examples, system 201 can be implemented in a single device. A person or persons using system 201, is optionally referred to herein as a user or users of the device(s). Attention is now directed towards exemplary concurrent displays of a three-dimensional environment on a first electronic device (e.g., corresponding to electronic device 260) and a second electronic device (e.g., corresponding to electronic device 270). As discussed below, the first electronic device may be in communication with the second electronic device in a multi-user communication session. In some examples, an avatar (e.g., a representation of) a user of the first electronic device may be displayed in the three-dimensional environment at the second electronic device, and an avatar of a user of the second electronic device may be displayed in the three-dimensional environment at the first electronic device. In some examples, the user of the first electronic device and the user of the second electronic device may be associated with a spatial group in the multi-user communication session. In some examples, interactions with content in the three-dimensional environment while the first electronic device and the second electronic device are in the multi-user communication session may cause the user of the first electronic device and the user of the second electronic device to become associated with different spatial groups in the multi-user communication session.

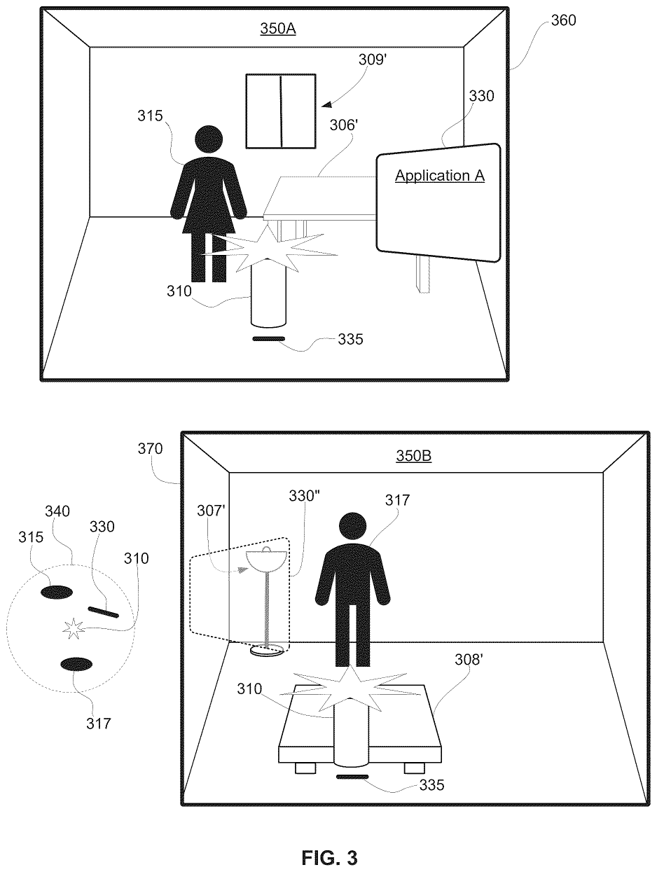

FIG. 3 illustrates an example of a spatial group 340 in a multi-user communication session that includes a first electronic device 360 and a second electronic device 370 according to some examples of the disclosure. In some examples, the first electronic device 360 may present a three-dimensional environment 350A, and the second electronic device 370 may present a three-dimensional environment 350B. The first electronic device 360 and the second electronic device 370 may be similar to electronic device 101 or 260/270, and/or may be a head mountable system/device and/or projection-based system/device (including a hologram-based system/device) configured to generate and present a three-dimensional environment, such as, for example, heads-up displays (HUDs), head mounted displays (HMDs), windows having integrated display capability, displays formed as lenses designed to be placed on a person's eyes (e.g., similar to contact lenses), respectively. In the example of FIG. 3, a first user is optionally wearing the first electronic device 360 and a second user is optionally wearing the second electronic device 370, such that the three-dimensional environment 350A/350B can be defined by X, Y and Z axes as viewed from a perspective of the electronic devices (e.g., a viewpoint associated with the electronic device 360/370, which may be a head-mounted display, for example).

As shown in FIG. 3, the first electronic device 360 may be in a first physical environment that includes a table 306 and a window 309. Thus, the three-dimensional environment 350A presented using the first electronic device 360 optionally includes captured portions of the physical environment surrounding the first electronic device 360, such as a representation of the table 306′ and a representation of the window 309′. Similarly, the second electronic device 370 may be in a second physical environment, different from the first physical environment (e.g., separate from the first physical environment), that includes a floor lamp 307 and a coffee table 308. Thus, the three-dimensional environment 350B presented using the second electronic device 370 optionally includes captured portions of the physical environment surrounding the second electronic device 370, such as a representation of the floor lamp 307′ and a representation of the coffee table 308′. Additionally, the three-dimensional environments 350A and 350B may include representations of the floor, ceiling, and walls of the room in which the first electronic device 360 and the second electronic device 370, respectively, are located.

As mentioned above, in some examples, the first electronic device 360 is optionally in a multi-user communication session with the second electronic device 370. For example, the first electronic device 360 and the second electronic device 370 (e.g., via communication circuitry 222A/222B) are configured to present a shared three-dimensional environment 350A/350B that includes one or more shared virtual objects (e.g., content such as images, video, audio and the like, representations of user interfaces of applications, etc.). As used herein, the term “shared three-dimensional environment” refers to a three-dimensional environment that is independently presented, displayed, and/or visible at two or more electronic devices via which content, applications, data, and the like may be shared and/or presented to users of the two or more electronic devices. In some examples, while the first electronic device 360 is in the multi-user communication session with the second electronic device 370, an avatar corresponding to the user of one electronic device is optionally displayed in the three-dimensional environment that is displayed via the other electronic device. For example, as shown in FIG. 3, at the first electronic device 360, an avatar 315 corresponding to the user of the second electronic device 370 is displayed in the three-dimensional environment 350A. Similarly, at the second electronic device 370, an avatar 317 corresponding to the user of the first electronic device 360 is displayed in the three-dimensional environment 350B.

In some examples, the presentation of avatars 315/317 as part of a shared three-dimensional environment is optionally accompanied by an audio effect corresponding to a voice of the users of the electronic devices 370/360. For example, the avatar 315 displayed in the three-dimensional environment 350A using the first electronic device 360 is optionally accompanied by an audio effect corresponding to the voice of the user of the second electronic device 370. In some such examples, when the user of the second electronic device 370 speaks, the voice of the user may be detected by the second electronic device 370 (e.g., via the microphone(s) 213B) and transmitted to the first electronic device 360 (e.g., via the communication circuitry 222B/222A), such that the detected voice of the user of the second electronic device 370 may be presented as audio (e.g., using speaker(s) 216A) to the user of the first electronic device 360 in three-dimensional environment 350A. In some examples, the audio effect corresponding to the voice of the user of the second electronic device 370 may be spatialized such that it appears to the user of the first electronic device 360 to emanate from the location of avatar 315 in the shared three-dimensional environment 350A (e.g., despite being outputted from the speakers of the first electronic device 360). Similarly, the avatar 317 displayed in the three-dimensional environment 350B using the second electronic device 370 is optionally accompanied by an audio effect corresponding to the voice of the user of the first electronic device 360. In some such examples, when the user of the first electronic device 360 speaks, the voice of the user may be detected by the first electronic device 360 (e.g., via the microphone(s) 213A) and transmitted to the second electronic device 370 (e.g., via the communication circuitry 222A/222B), such that the detected voice of the user of the first electronic device 360 may be presented as audio (e.g., using speaker(s) 216B) to the user of the second electronic device 370 in three-dimensional environment 350B. In some examples, the audio effect corresponding to the voice of the user of the first electronic device 360 may be spatialized such that it appears to the user of the second electronic device 370 to emanate from the location of avatar 317 in the shared three-dimensional environment 350B (e.g., despite being outputted from the speakers of the first electronic device 360).

In some examples, while in the multi-user communication session, the avatars 315/317 are displayed in the three-dimensional environments 350A/350B with respective orientations that correspond to and/or are based on orientations of the electronic devices 360/370 (and/or the users of electronic devices 360/370) in the physical environments surrounding the electronic devices 360/370. For example, as shown in FIG. 3, in the three-dimensional environment 350A, the avatar 315 is optionally facing toward the viewpoint of the user of the first electronic device 360, and in the three-dimensional environment 350B, the avatar 317 is optionally facing toward the viewpoint of the user of the second electronic device 370. As a particular user moves the electronic device (and/or themself) in the physical environment, the viewpoint of the user changes in accordance with the movement, which may thus also change an orientation of the user's avatar in the three-dimensional environment. For example, with reference to FIG. 3, if the user of the first electronic device 360 were to look leftward in the three-dimensional environment 350A such that the first electronic device 360 is rotated (e.g., a corresponding amount) to the left (e.g., counterclockwise), the user of the second electronic device 370 would see the avatar 317 corresponding to the user of the first electronic device 360 rotate to the right (e.g., clockwise) relative to the viewpoint of the user of the second electronic device 370 in accordance with the movement of the first electronic device 360.

Additionally, in some examples, while in the multi-user communication session, a viewpoint of the three-dimensional environments 350A/350B and/or a location of the viewpoint of the three-dimensional environments 350A/350B optionally changes in accordance with movement of the electronic devices 360/370 (e.g., by the users of the electronic devices 360/370). For example, while in the communication session, if the first electronic device 360 is moved closer toward the representation of the table 306′ and/or the avatar 315 (e.g., because the user of the first electronic device 360 moved forward in the physical environment surrounding the first electronic device 360), the viewpoint of the three-dimensional environment 350A would change accordingly, such that the representation of the table 306′, the representation of the window 309′ and the avatar 315 appear larger in the field of view. In some examples, each user may independently interact with the three-dimensional environment 350A/350B, such that changes in viewpoints of the three-dimensional environment 350A and/or interactions with virtual objects in the three-dimensional environment 350A by the first electronic device 360 optionally do not affect what is shown in the three-dimensional environment 350B at the second electronic device 370, and vice versa.

In some examples, the avatars 315/317 are representations (e.g., a full-body rendering) of the users of the electronic devices 370/360. In some examples, the avatar 315/317 is a representation of a portion (e.g., a rendering of a head, face, head and torso, etc.) of the users of the electronic devices 370/360. In some examples, the avatars 315/317 are user-personalized, user-selected, and/or user-created representations displayed in the three-dimensional environments 350A/350B that are representative of the users of the electronic devices 370/360. It should be understood that, while the avatars 315/317 illustrated in FIG. 3 correspond to full-body representations of the users of the electronic devices 370/360, respectively, alternative avatars may be provided, such as those described above.

As mentioned above, while the first electronic device 360 and the second electronic device 370 are in the multi-user communication session, the three-dimensional environments 350A/350B may be a shared three-dimensional environment that is presented using the electronic devices 360/370. In some examples, content that is viewed by one user at one electronic device may be shared with another user at another electronic device in the multi-user communication session. In some such examples, the content may be experienced (e.g., viewed and/or interacted with) by both users (e.g., via their respective electronic devices) in the shared three-dimensional environment. For example, as shown in FIG. 3, the three-dimensional environments 350A/350B include a shared virtual object 310 (e.g., which is optionally a three-dimensional virtual sculpture) that is viewable by and interactive to both users. As shown in FIG. 3, the shared virtual object 310 may be displayed with a grabber affordance (e.g., a handlebar) 335 that is selectable to initiate movement of the shared virtual object 310 within the three-dimensional environments 350A/350B.

In some examples, the three-dimensional environments 350A/350B include unshared content that is private to one user in the multi-user communication session. For example, in FIG. 3, the first electronic device 360 is displaying a private application window 330 in the three-dimensional environment 350A, which is optionally an object that is not shared between the first electronic device 360 and the second electronic device 370 in the multi-user communication session. In some examples, the private application window 330 may be associated with a respective application that is operating on the first electronic device 360 (e.g., such as a media player application, a web browsing application, a messaging application, etc.). Because the private application window 330 is not shared with the second electronic device 370, the second electronic device 370 optionally displays a representation of the private application window 330″ in three-dimensional environment 350B. As shown in FIG. 3, in some examples, the representation of the private application window 330″ may be a faded, occluded, discolored, and/or translucent representation of the private application window 330 that prevents the user of the second electronic device 370 from viewing contents of the private application window 330.

As mentioned previously above, in some examples, the user of the first electronic device 360 and the user of the second electronic device 370 are in a spatial group 340 within the multi-user communication session. In some examples, the spatial group 340 may be a baseline (e.g., a first or default) spatial group within the multi-user communication session. For example, when the user of the first electronic device 360 and the user of the second electronic device 370 initially join the multi-user communication session, the user of the first electronic device 360 and the user of the second electronic device 370 are automatically (and initially, as discussed in more detail below) associated with (e.g., grouped into) the spatial group 340 within the multi-user communication session. In some examples, while the users are in the spatial group 340 as shown in FIG. 3, the user of the first electronic device 360 and the user of the second electronic device 370 have a first spatial arrangement (e.g., first spatial template) within the shared three-dimensional environment. For example, the user of the first electronic device 360 and the user of the second electronic device 370, including objects that are displayed in the shared three-dimensional environment, have spatial truth within the spatial group 340. In some examples, spatial truth requires a consistent spatial arrangement between users (or representations thereof) and virtual objects. For example, a distance between the viewpoint of the user of the first electronic device 360 and the avatar 315 corresponding to the user of the second electronic device 370 may be the same as a distance between the viewpoint of the user of the second electronic device 370 and the avatar 317 corresponding to the user of the first electronic device 360. As described herein, if the location of the viewpoint of the user of the first electronic device 360 moves, the avatar 317 corresponding to the user of the first electronic device 360 moves in the three-dimensional environment 350B in accordance with the movement of the location of the viewpoint of the user relative to the viewpoint of the user of the second electronic device 370. Additionally, if the user of the first electronic device 360 performs an interaction on the shared virtual object 310 (e.g., moves the virtual object 310 in the three-dimensional environment 350A), the second electronic device 370 alters display of the shared virtual object 310 in the three-dimensional environment 350B in accordance with the interaction (e.g., moves the virtual object 310 in the three-dimensional environment 350B).

It should be understood that, in some examples, more than two electronic devices may be communicatively linked in a multi-user communication session. For example, in a situation in which three electronic devices are communicatively linked in a multi-user communication session, a first electronic device would display two avatars, rather than just one avatar, corresponding to the users of the other two electronic devices. It should therefore be understood that the various processes and exemplary interactions described herein with reference to the first electronic device 360 and the second electronic device 370 in the multi-user communication session optionally apply to situations in which more than two electronic devices are communicatively linked in a multi-user communication session.

In some examples, it may be advantageous to provide mechanisms for facilitating a multi-user communication session that includes collocated and non-collocated users (e.g., collocated and non-collocated electronic devices associated with the users). For example, it may be desirable to enable users who are collocated in a first physical environment to establish a multi-user communication session with one or more users who are non-collocated in the first physical environment, such that virtual content may be shared and presented in a three-dimensional environment that is optionally viewable by and/or interactive to the collocated and non-collocated users in the multi-user communication session. As used herein, relative to a first electronic device, a collocated user corresponds to a local user and a non-collocated user corresponds to a remote user. As similarly discussed above, the three-dimensional environment optionally includes visual representations (e.g., avatars) corresponding to the remote users of the electronic devices that are non-collocated in the multi-user communication session. In some examples, as discussed below, the presentation of virtual objects (e.g., avatars and shared virtual content) in the three-dimensional environment within a multi-user communication session that includes collocated and non-collocated users (e.g., relative to a first electronic device) is based on positions and/or orientations of the collocated users in a physical environment of the first electronic device, and optionally relative to a spatial template that is associated with the multi-user communication session.

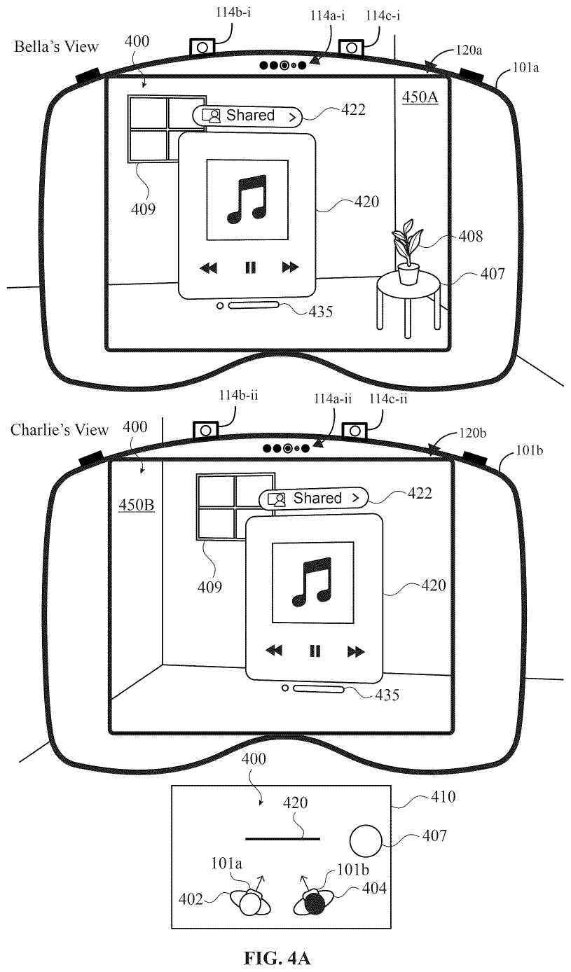

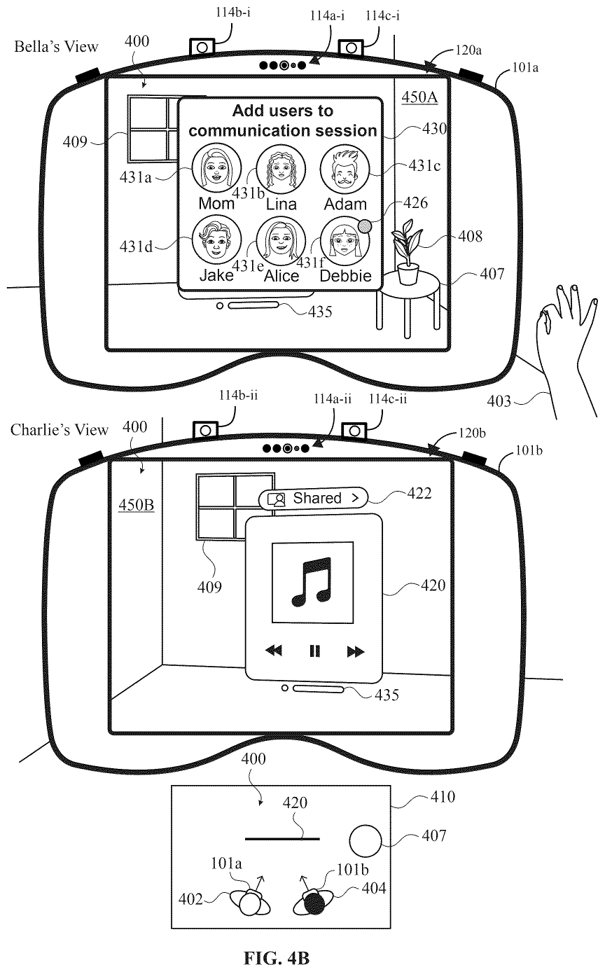

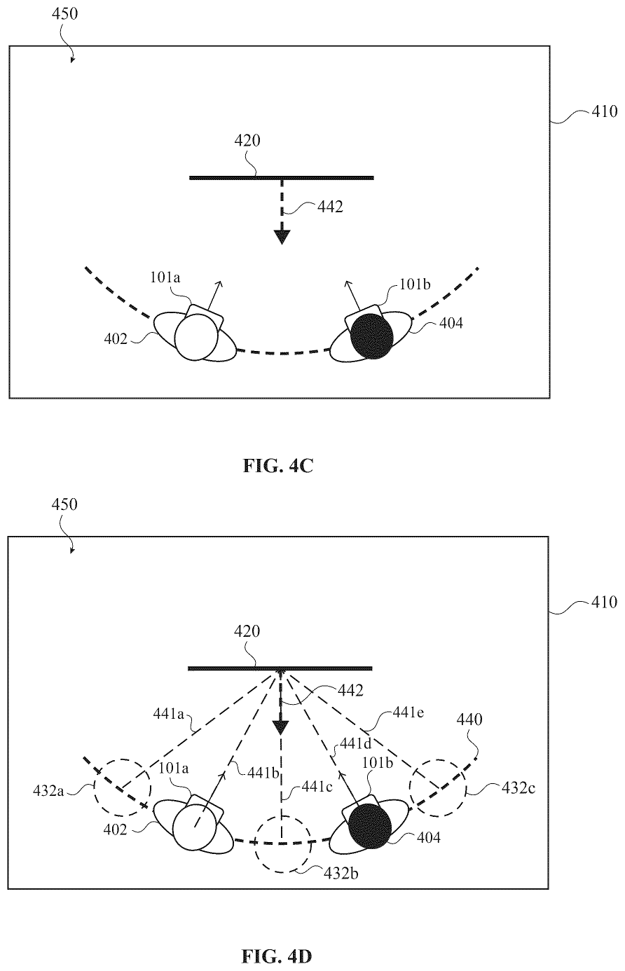

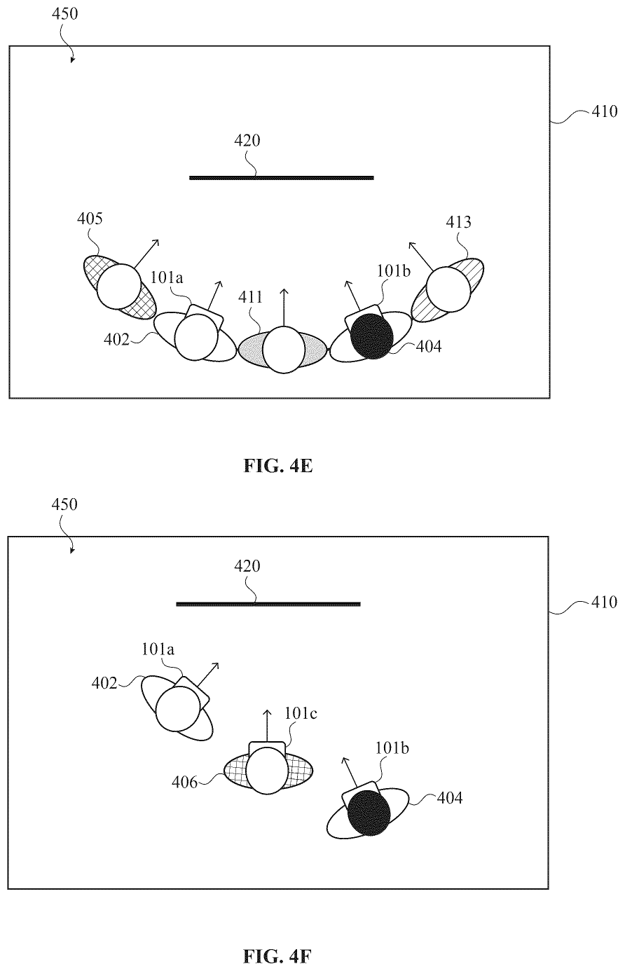

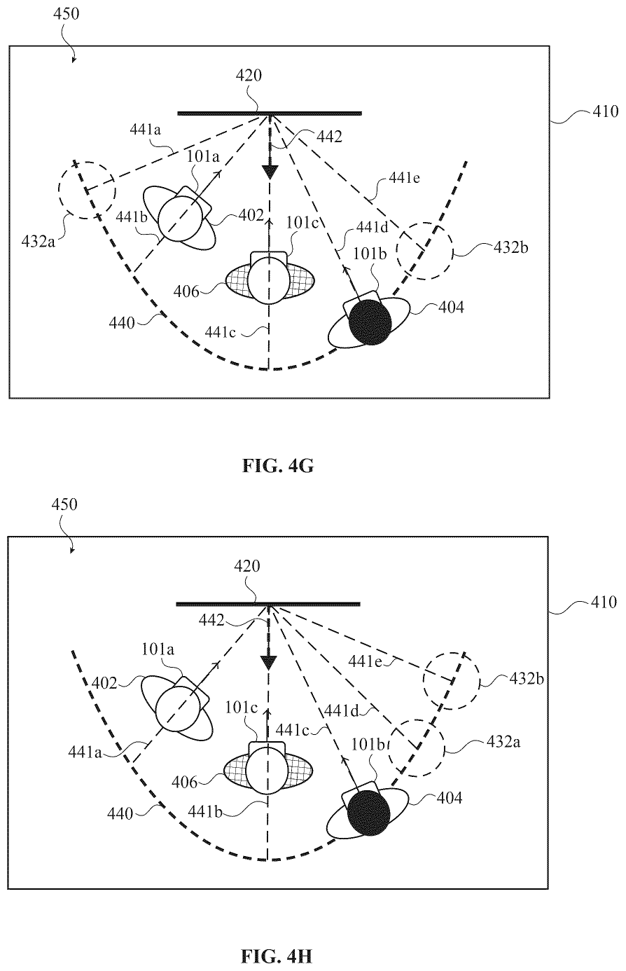

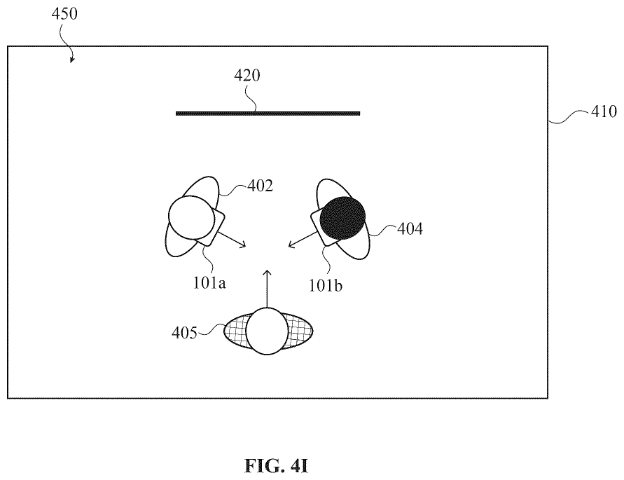

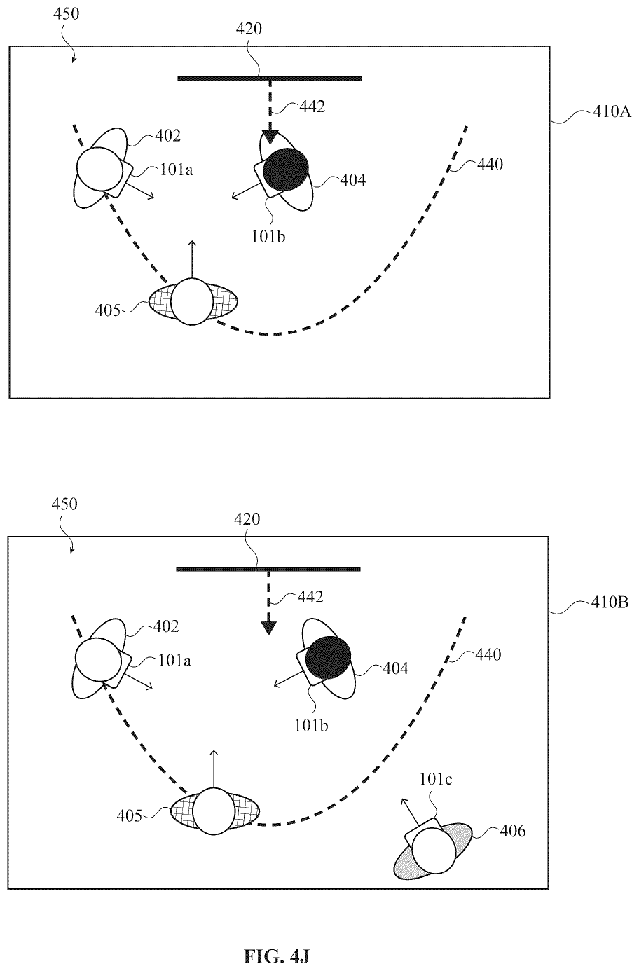

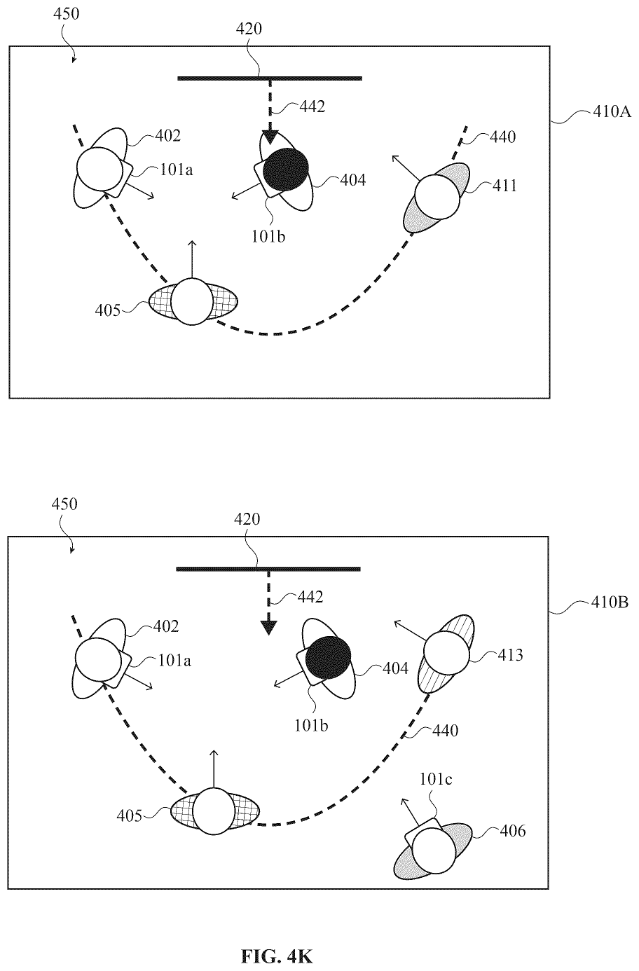

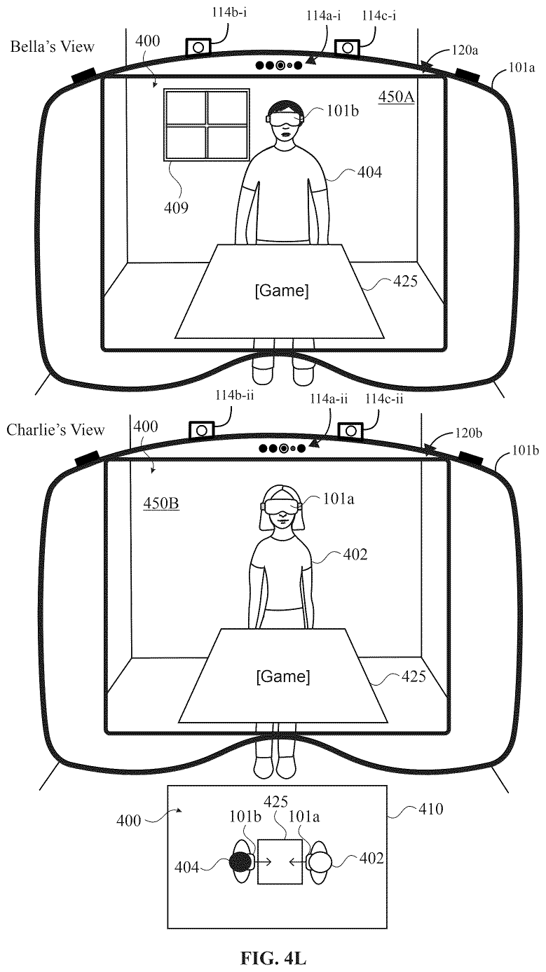

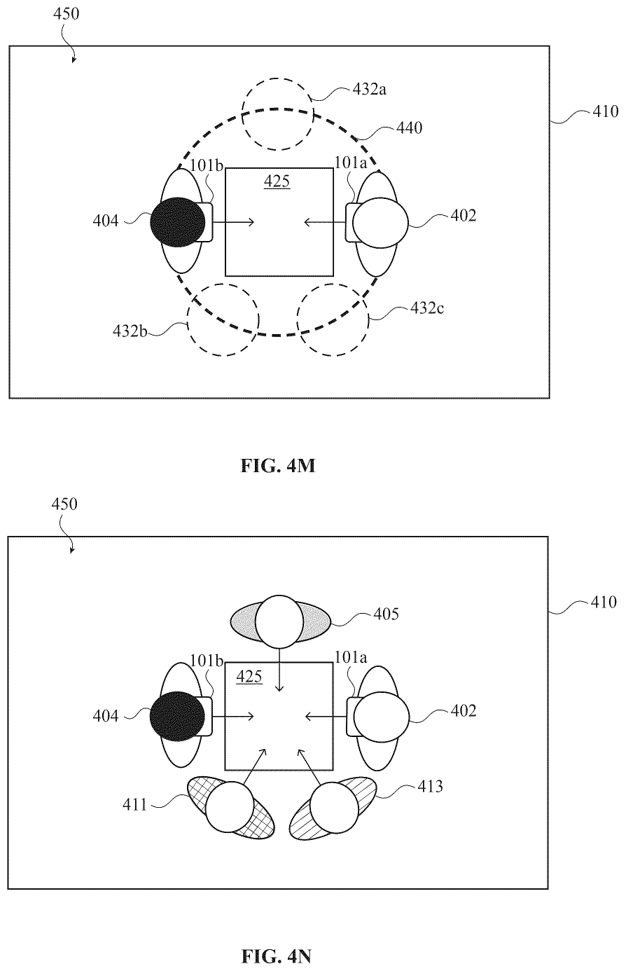

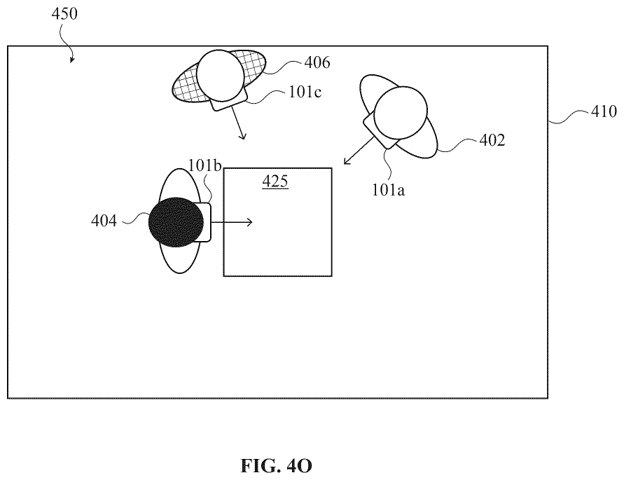

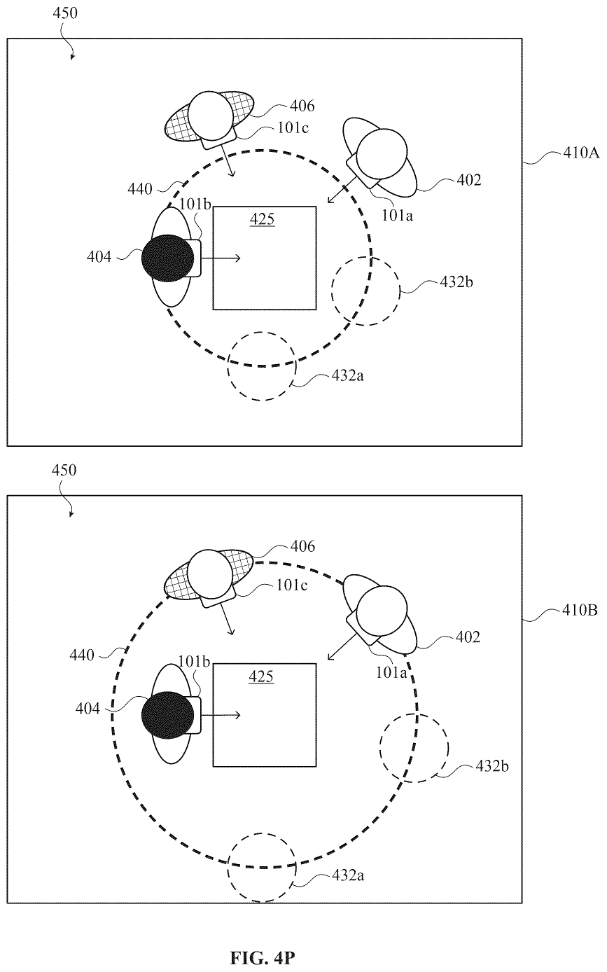

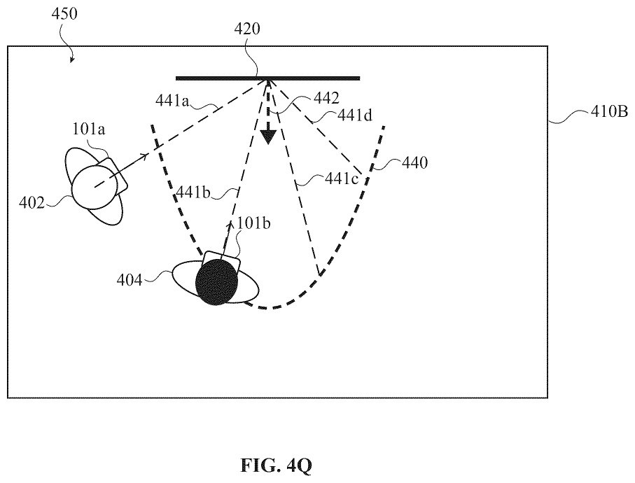

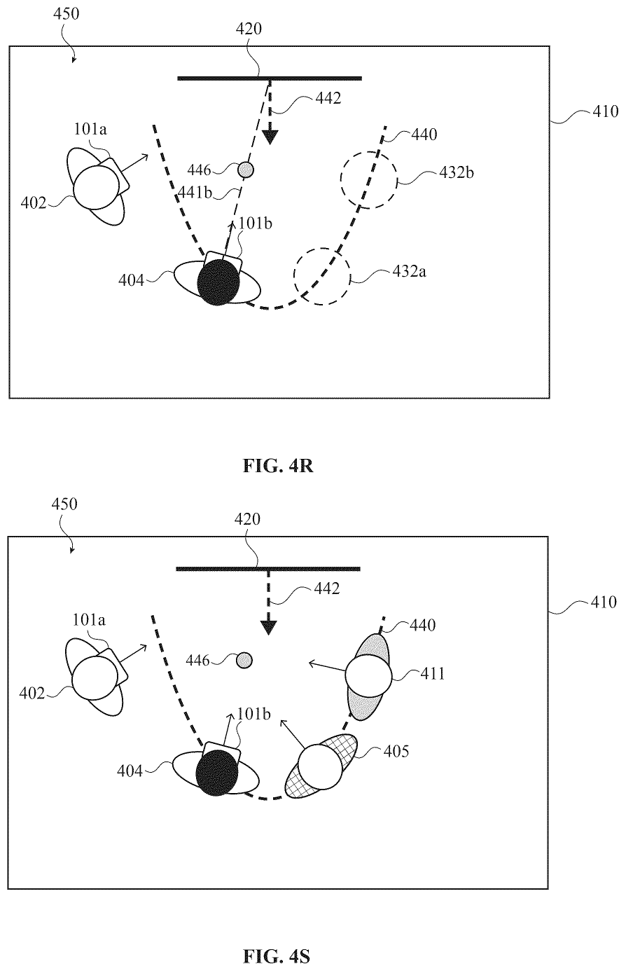

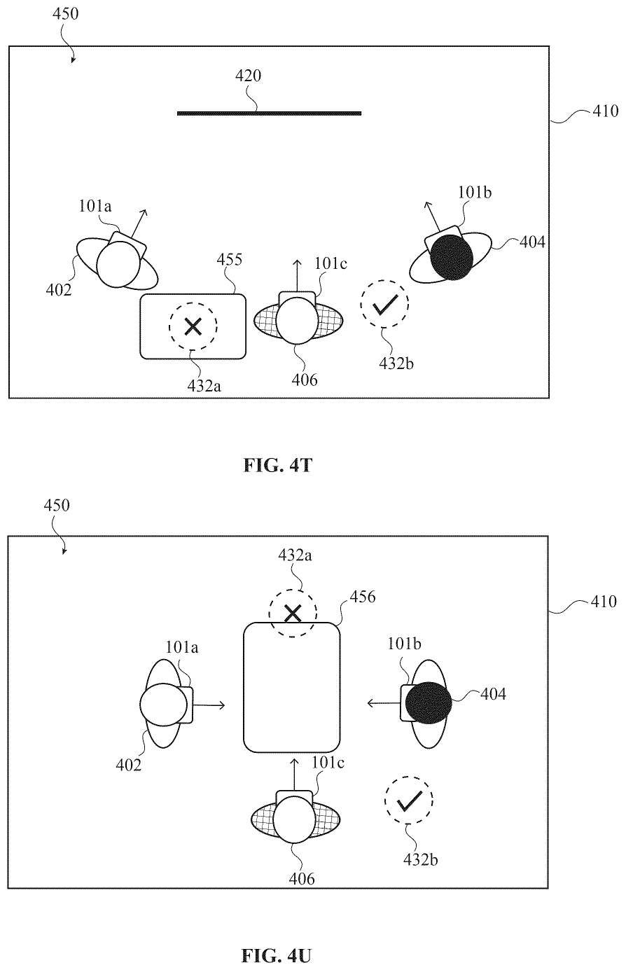

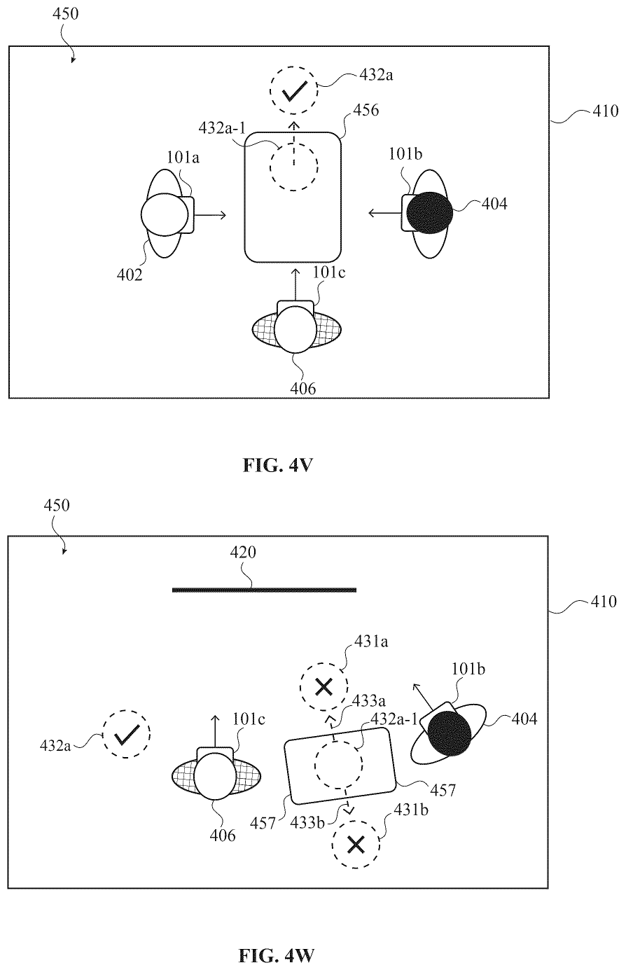

FIGS. 4A-4W illustrate examples of displaying one or more visual representations of non-collocated users in a three-dimensional environment within a multi-user communication session that includes collocated and non-collocated users according to some examples of the disclosure. In some examples, while a first electronic device 101a is in the multi-user communication session with a second electronic device 101b, three-dimensional environment 450A is presented using the first electronic device 101a (e.g., via display 120a) and three-dimensional environment 450B is presented using the second electronic device 101b (e.g., via display 120b). In some examples, the electronic devices 101a/101b optionally correspond to or are similar to electronic devices 360/370 discussed above and/or electronic devices 260/270 in FIG. 2. In some examples, as shown in overhead view 410 in FIG. 4A, the first electronic device 101a is being used by (e.g., worn on a head of) a first user 402 (e.g., Bella) and the second electronic device 101b is being used by (e.g., worn on a head of) a second user 404 (e.g., Charlie).

In FIG. 4A, as indicated in the overhead view 410, the first electronic device 101a and the second electronic device 101b are collocated in physical environment 400. For example, the first electronic device 101a and the second electronic device 101b are both located in a same room that includes window 409, stand 407 and houseplant 408. In some examples, the determination that the first electronic device 101a and the second electronic device 101b are collocated in the physical environment 400 is based on a distance between the first electronic device 101a and the second electronic device 101b. For example, in FIG. 4A, the first electronic device 101a and the second electronic device 101b are collocated in the physical environment 400 because the first electronic device 101a is within a threshold distance (e.g., 0.1, 0.5, 1, 2, 3, 5, 10, 15, 20, etc. meters) of the second electronic device 101b. In some examples, the determination that the first electronic device 101a and the second electronic device 101b are collocated in the physical environment 400 is based on communication between the first electronic device 101a and the second electronic device 101b. For example, in FIG. 4A, the first electronic device 101a and the second electronic device 101b are configured to communicate (e.g., wirelessly, such as via Bluetooth, Wi-Fi, or a server (e.g., wireless communications terminal)). In some examples, the first electronic device 101a and the second electronic device 101b are connected to a same wireless network in the physical environment 400. In some examples, the determination that the first electronic device 101a and the second electronic device 101b are collocated in the physical environment 400 is based on a strength of a wireless signal transmitted between the electronic devices 101a and 101b. For example, in FIG. 4A, the first electronic device 101a and the second electronic device 101b are collocated in the physical environment 400 because a strength of a Bluetooth signal (or other wireless signal) transmitted between the electronic devices 101a and 101b is greater than a threshold strength. In some examples, the determination that the first electronic device 101a and the second electronic device 101b are collocated in the physical environment 400 is based on visual detection of the electronic devices 101a and 101b in the physical environment 400. For example, as shown in FIG. 4L, the second electronic device 101b is positioned in a field of view of the first electronic device 101a (e.g., because the second user 404 is standing in the field of view of the first electronic device 101a), which enables the first electronic device 101a to visually detect (e.g., identify or scan, such as via object detection or other image processing techniques) the second electronic device 101b (e.g., in one or more images captured by the first electronic device 101a, such as via external image sensors 114b-i and 114c-i). Similarly, as shown in FIG. 4L, the first electronic device 101a is optionally positioned in a field of view of the second electronic device 101b (e.g., because the first user 402 is standing in the field of view of the second electronic device 101b), which enables the second electronic device 101b to visually detect the first electronic device 101a (e.g., in one or more images captured by the second electronic device 101b, such as via external image sensors 11b-ii and 114c-ii). In some examples, the determination that the first electronic device 101a and the second electronic device 101b are collocated in the physical environment 400 is based on visual detection of one or more same (e.g., overlapping) features or portions of the physical environment 400. For example, as mentioned above, the physical environment 400 includes one or more physical objects, such as the window 409, the stand 407, and the houseplant 408, and/or one or more physical surfaces, such as the walls, floor, and ceiling of the room in which the electronic devices 101a/101b are located. In the example of FIG. 4A, the first electronic device 101a and the second electronic device 101b determine that the electronic devices are collocated in the physical environment 400 based on visual detection of the window 409 and/or the walls and floor of the room, which are visible in the field of view of both of the electronic devices 101a/101b (e.g., in the one or more images captured by the first electronic device 101a and the second electronic device 101b).

In some examples, as shown in FIG. 4A, the three-dimensional environments 450A/450B include captured portions of the physical environment 400 in which the electronic devices 101a/101b are located. For example, because the first electronic device 101a and the second electronic device 101b are collocated in the physical environment 400, the three-dimensional environments 450A and 450B include the window 409 (e.g., a representation of the window), the stand 407 (e.g., a representation of the stand) and the houseplant 408 (e.g., a representation of the houseplant), but from the viewpoints of the first electronic device 101a and the second electronic device 101b, as shown in FIG. 4A. In some examples, the representations can include portions of the physical environment 400 viewed through a transparent or translucent display of the electronic devices 101a and 101b. In some examples, the three-dimensional environments 450A/450B have one or more characteristics of the three-dimensional environments 350A/350B described above with reference to FIG. 3.

As described above with reference to FIG. 3, while electronic devices are communicatively linked in a multi-user communication session, users may be represented by avatars corresponding to the users of the electronic devices. In FIG. 4A, because the first electronic device 101a and the second electronic device 101b are collocated in the physical environment 400, the users of the electronic devices 101a and 101b are represented in the multi-user communication session via their physical personas (e.g., bodies) that may be visible in passthrough of the physical environment 400 (e.g., rather than via virtual avatars). For example, as indicated in the overhead view 410 in FIG. 4A, the second user 404 is not currently visible in the field of view of the first electronic device 101a and the first user 402 is not currently visible in the field of view of the second electronic device 101b based on the physical locations of the users 404/402 in the physical environment 400, but because the users 404/402 are collocated in the physical environment 400, the first electronic device 101a and the second electronic device 101b forgo displaying visual representations (e.g., avatars) of the users 404/402. As discussed in more detail below, if a third user who is non-collocated in the physical environment 400 (e.g., a remote user) joins the multi-user communication session, the third user is represented via a visual representation (e.g., an avatar) in the three-dimensional environments 450A and 450B.

As similarly described above with reference to FIG. 3, while the first user 402 of the first electronic device 101a and the second user 404 of the second electronic device 101b are collocated in the physical environment 400 and while the first electronic device 101a is in the multi-user communication session with the second electronic device 101b, the first user 402 and the second user 404 may be in a first spatial group within the multi-user communication session. In some examples, the first spatial group has one or more characteristics of spatial group 340 discussed above with reference to FIG. 3. As similarly described above, while the first user 402 and the second user 404 are in the first spatial group within the multi-user communication session, the users have a first spatial arrangement in the shared three-dimensional environment (e.g., represented by the locations of and/or distance between the users 402 and 404 in the overhead view 410 in FIG. 4A) determined by the physical locations of the electronic devices 101a and 101b in the physical environment 400. Particularly, the first electronic device 101a and the second electronic device 101b experience spatial truth within the first spatial group as dictated by the physical locations of and/or orientations of the first user 402 and the second user 404, respectively.

In some examples, as similarly described above with reference to FIG. 3, while the first electronic device 101a is in the multi-user communication session with the second electronic device 101b, virtual content is able to be shared and/or interacted between the first electronic device 101a and the second electronic device 101b in the three-dimensional environments 450A/450B. For example, as shown in FIG. 4A, the first electronic device 101a and the second electronic device 101b are displaying virtual object 420 in the three-dimensional environment 450A/450B. In some examples, the virtual object 420 corresponds to an application window (e.g., a user interface), such as a media player (e.g., music player) application running on the first electronic device 101a and/or the second electronic device 101b. In some examples, the virtual object 420 is shared between the first electronic device 101a and the second electronic device 101b in the multi-user communication session, such that the content of the virtual object 420 (e.g., the music player user interface) is visible to and/or interactive to the first user 402 and the second user 404 via their respective electronic devices 101a/101b, as indicated by pill 422 displayed with the virtual object 420. In some examples, the pill 422 is selectable to initiate one or more sharing operations associated with the virtual object 420. For example, the pill 422 is selectable (e.g., via an air gesture, such as an air pinch or tap gesture) to share (e.g., and/or cease sharing) the content of the virtual object 420 in the multi-user communication session. Additionally, in some examples, as shown in FIG. 4A, the virtual object 420 is displayed with and/or includes grabber bar 435, which is optionally selectable to initiate movement of the virtual object 420 in the three-dimensional environment 450A/450B.

In FIG. 4B, while the first electronic device 101a is collocated with the second electronic device 101b in the physical environment 400 (e.g., and optionally while the first electronic device 101a is in the multi-user communication session with the second electronic device 101b), the first electronic device 101a and/or the second electronic device 101b detect an indication of a request to join a multi-user communication session with a third electronic device. For example, as shown in FIG. 4B, the indication corresponds to an indication of a request to add a third electronic device (e.g., associated with a third user Debbie) to the current multi-user communication session between the first electronic device 101a and the second electronic device 101b. In some examples, as shown in FIG. 4B, while displaying user interface 430 associated with the multi-user communication session, the first electronic device 101a detects a selection input directed to representation 431f in the user interface 430. For example, as shown in FIG. 4B, the first electronic device 101a detects an air pinch gesture performed by hand 403 of the first user 402, optionally while gaze 426 of the first user 402 is directed to the representation 431f of a plurality of representations 431a-431f in the user interface 430. In some examples, the plurality of representations 431a-431f is selectable to initiate a process to add a respective user corresponding to the selected representation to the multi-user communication session between the first electronic device 101a and the second electronic device 101b. In some examples, the users associated with the plurality of representations 431a-431f correspond to contacts associated with a contacts or phone application running on the first electronic device 101a (and/or the second electronic device 101b). It should be understood that additional or alternative inputs are possible, such as air tap gestures, gaze and dwell inputs, verbal commands, etc.

In some examples, the third electronic device (e.g., associated with user Debbie in FIG. 4B) is non-collocated with the first electronic device 101a and the second electronic device 101b. For example, the third electronic device is located in a different (e.g., separate) physical environment than the physical environment 400 in which the first electronic device 101a and the second electronic device 101b are both located. In some examples, while the third electronic device is non-collocated with the first electronic device 101a and the second electronic device 101b in the physical environment 400, the third electronic device is more than the threshold distance (e.g., discussed above) of the first electronic device 101a and the second electronic device 101b. Additionally, in some examples, as shown in FIG. 4B, while the third electronic device is non-collocated with the first electronic device 101a and the second electronic device 101b in the physical environment 400, the third electronic device is not in the field of view of the first electronic device 101a or the second electronic device 101b.

In some examples, in response to detecting the indication corresponding to the request to add the third electronic device to the multi-user communication session that includes the first electronic device 101a and the second electronic device 101b, the first electronic device 101a and the second electronic device 101b initiate a process for presenting a visual representation (e.g., an avatar) corresponding to the third user (e.g., Debbie) of the third electronic device in the three-dimensional environments 450A and 450B, indicative of entering the multi-user communication session with the third electronic device 101c. For example, as mentioned above, because the third user is non-collocated with the first user 402 and the second user 404 in the physical environment 400, the third user is represented via an avatar (or other visual representation) in the three-dimensional environment 450A/450B while in the multi-user communication session. In some examples, as discussed below, initiating the process for presenting the visual representation corresponding to the third user in the three-dimensional environment 450A/450B includes identifying a placement location for the visual representation within the first spatial group of the first user 402 and the second user 404.

In some examples, as shown in FIG. 4C, identifying a placement location for the visual representation corresponding to the third user in the first spatial group includes, as shown in the overhead view 410, analyzing/identifying physical locations of the first electronic device 101a and the second electronic device 101b within a shared (e.g., synchronized) coordinate space/system of the first spatial group. For example, as indicated in the overhead view 410 in FIG. 4C, the first electronic device 101a is located at a first location and the second electronic device 101b is located at a second location, different from the first location, in the physical environment 400. Furthermore, the first electronic device 101a has a first orientation (e.g., indicated by the arrow extending from the first electronic device 101a) and the second electronic device 101b has a second orientation (e.g., indicated by the arrow extending from the second electronic device 101b) in the physical environment 400, as shown in the overhead view 410 in FIG. 4C.

In some examples, identifying a placement location for the visual representation corresponding to the third user includes, as shown in the overhead view 410 in FIG. 4C, applying a best-fit shape to the first electronic device 101a and the second electronic device 101b. For example, as shown in the overhead view 410, a predefined shape (e.g., curve or arc, such as a Bezier curve) 440 is applied to the first electronic device 101a and the second electronic device 101b based on the physical locations of the first electronic device 101a and the second electronic device 101b in the physical environment 400 discussed above. In some examples, the best-fit or predefined shape is selected based on the type of virtual object that is shared and presented in the three-dimensional environment when the indication of the request to add the third user to the multi-user communication session is detected. For example, in FIG. 4C, the virtual object 420 is a vertically oriented virtual object (e.g., the content of the virtual object 420 is displayed on a front-facing surface of the virtual object 420), as shown in the overhead view 410. Accordingly, as shown in FIG. 4C, the best-fit shape is the curve 440 (e.g., as opposed to other shapes, as described in more detail later). In some examples, as illustrated in the overhead view 410 in FIG. 4C, the curve 440 is based on an orientation of the virtual object 420 in the shared three-dimensional environment 450. For example, as shown in FIG. 4C, the curve 440 is centered on the virtual object 420, as illustrated by a vertex of the curve 440 intersecting a vector 442 extending from a center of the front-facing surface of the virtual object 420. Additionally, in some examples, a size of the curve 440 (e.g., defined by endpoints on the curve 440) is based on a size (e.g., width) of the virtual object 420 in the shared three-dimensional environment 450. For example, in FIG. 4C, the endpoints of the curve 440 are offset by a predetermined amount (e.g., distance) from the edges/ends of the virtual object 420 in the shared three-dimensional environment 450.

In some examples, as illustrated in the overhead view 410 in FIG. 4D, one or more placement locations are identified in the shared three-dimensional environment 450 based on the arc 440 in the shared three-dimensional environment 450. For example, as shown in FIG. 4D, the first electronic device 101a and/or the second electronic device 101b identify a first placement location 432a, a second placement location 432b, and a third placement location 432c in the shared three-dimensional environment 450 at which to position visual representations of remote users when adding the remote users to the multi-user communication session. In some examples, as shown in the overhead view 410, the placement locations 432a-432c are positioned along the arc 440 relative to the virtual object 420. For example, determining the placement locations 432a-432c includes defining a plurality of vectors or lines 441a-441d that each extends from a center of the virtual object 420 to a point along the arc 440, where each intersection of the vector or line with a point along the arc 440 corresponds to the placement locations 432a-432c (e.g., a particular angle on the arc or curve 440 in the shared three-dimensional environment 450). Additionally, in some examples, as shown in FIG. 4D, the placement locations 432a-432c correspond to unoccupied locations along the arc 440 that are adjacent to the physical locations of the first user 402 and the second user 404 in the shared three-dimensional environment 450 (e.g., unoccupied by the first user 402 and the second user 404 and/or other physical objects in the physical environment 400, such as the stand 407 and/or the houseplant 408 in FIG. 4A). For example, as shown in the overhead view 410 in FIG. 4D, the line 441b extends between the center of the virtual object 420 and the location of the first user 402 in the shared three-dimensional environment 450 and the line 441d extends between the center of the virtual object 420 and the location of the second user 404 in the shared three-dimensional environment 450. It should be understood that, in some examples, as described herein, the placement locations 432a-432c are identified sequentially as additional remote users join the multi-user communication session in the shared three-dimensional environment 450, rather than in response to the third user joining the multi-user communication session. For example, the first electronic device 101a and/or the second electronic device 101b identify the first placement location 432a in the shared three-dimensional environment 450 relative to the virtual object 420 in response to detecting the indication of the request to add the third user to the multi-user communication session, and in response to detecting a subsequent indication of a request to add an additional remote user to the multi-user communication session (e.g., a fourth user), the first electronic device 101a and/or the second electronic device 101b subsequently identify the second placement location 432b in the shared three-dimensional environment 450 (e.g., following the placement of the visual representation of the third user at the first placement location 432a), and so on.

In some examples, as shown in the overhead view 410 in FIG. 4E, following the determination of the one or more placement locations in the shared three-dimensional environment 450, the first electronic device 101a and the second electronic device 101b display a visual representation of the third user of the third electronic device at one of the placement locations in the shared three-dimensional environment 450. For example, as shown in FIG. 4E, the first electronic device 101a and the second electronic device 101b display avatar 405 corresponding to the third user (e.g., Debbie) at the first placement location 432a of FIG. 4D in the shared three-dimensional environment 450. Additionally, in some examples, as and/or if additional remote users join and/or are added to the multi-user communication session, visual representations of the additional remote users are displayed and/or positioned at the other placement locations identified/determined in the shared three-dimensional environment 450. For example, as shown in the overhead view 410 in FIG. 4E, avatar 411 corresponding to a fourth user of a fourth electronic device (e.g., which is non-collocated with the first electronic device 101a and the second electronic device 101b in the physical environment 400 discussed above) is displayed at the second placement location 432b of FIG. 4D and avatar 413 corresponding to a fifth user of a fifth electronic device (e.g., which is non-collocated with the first electronic device 101a and the second electronic device 101b in the physical environment 400) is displayed at the third placement location 432c of FIG. 4D in the shared three-dimensional environment 450. Additionally, in some examples, as indicated in the overhead view 410 in FIG. 4E, when the avatar 405 (e.g., and subsequently the avatars 411/413) is displayed in the shared three-dimensional environment 450, the avatar 405 is displayed with an orientation that faces toward the virtual object 420, as indicated by the arrow extending from the avatar 405.

In FIG. 4E, after the avatars 411/413 are displayed in the shared three-dimensional environment 450 as discussed above, the identified placement locations in the shared three-dimensional environment 450 that fall along the curve 440 of FIG. 4D are all occupied. In such an instance, to accommodate the adding of further remote users to the multi-user communication session and the display of additional avatars corresponding to the remote users in the shared three-dimensional environment 450, the size of the arc 440 may be increased to enable additional placement locations to be identified in the shared three-dimensional environment 450 relative to the virtual object 420. In some examples, increasing the size of the arc 440 includes increasing the size (e.g., width) of the virtual object 420 in the shared three-dimensional environment 450.

FIGS. 4F-4H illustrate an alternative example of determining placement locations for visual representations of remote users in a multi-user communication session that includes local users. In FIG. 4F, the first user 402 and the second user 404 are collocated with a third user 406 in a physical environment (e.g., physical environment 400 discussed above). For example, as shown in the overhead view 410 in FIG. 4F, the first electronic device 101a, the second electronic device 101b, and a third electronic device 101c are collocated in a same physical environment while engaging in a multi-user communication session. Additionally, as shown in FIG. 4F, while the electronic devices 101a/101b/101c are in the multi-user communication session, the electronic devices 101a/101b/101c are presenting virtual object 420 which is shared among the electronic devices 101a/101b/101c in the shared three-dimensional environment 450 as similarly discussed above. From FIG. 4F to FIG. 4G, the electronic devices 101a/101b/101c detect an indication of a request to add a remote user (e.g., a fourth user of a fourth electronic device) to the multi-user communication session, such as an indication similar to that described above for adding the third user to the multi-user communication session.

In some examples, as similarly described above, in response to detecting the indication, the electronic devices 101a/101b/101c identify a placement location for a visual representation of the fourth user in the shared three-dimensional environment 450. In some examples, as indicated in the overhead view 410 in FIG. 4G, the electronic devices 101a/101b/101c apply the curve 440 (e.g., because the virtual object 420 is a vertically oriented virtual object as previously discussed above) based on the physical locations of the electronic devices 101a/101b/101c in the physical environment. In some examples, the curve 440 is defined in the shared three-dimensional environment 450 based on the location of the electronic device that is farthest from the virtual object 420 in the shared three-dimensional environment 450. For example, as shown in the overhead view 410 in FIG. 4G, the curve 440 is positioned relative to the virtual object 420 based on the location of the second user 404 (e.g., to intersect the location of the second user 404) in the shared three-dimensional environment 450 because the second user 404 is located farthest from the virtual object 420 in the shared three-dimensional environment 450. It should be understood that, alternatively, in some examples, the curve 440 is positioned relative to the virtual object 420 based on the location of the electronic device that is closest to the virtual object 420 in the shared three-dimensional environment 450, such as the location of the first electronic device 101a associated with the first user 402 in FIG. 4G. In some examples, the curve 440 is positioned relative to the virtual object 420 based on the location of the second user 404 (e.g., to intersect the location of the second user 404) in the shared three-dimensional environment 450 because the second user 404 provided input for initially sharing the virtual object 420 in the multi-user communication session. For example, the second electronic device 101b detected input provided by the second user 404, such as one or more inputs directed to the pill 422 associated with the virtual object 420 in the three-dimensional environment 450B in FIG. 4A. In some examples, as illustrated in the overhead view 410 in FIG. 4G and FIG. 4H, following the application of the curve 440 in the shared three-dimensional environment 450, the electronic devices 101a/101b/101c identify a first placement location 432a and a second placement location 432b in the shared three-dimensional environment 450 at which to position a visual representation of the fourth user (e.g., the remote user) in the shared three-dimensional environment 450. For example, as similarly described above, a plurality of lines 441a-441e is defined, each of which extends between the center of the virtual object 420 and a point on the curve 440 in the shared three-dimensional environment 450, as illustrated in the overhead view 410 in FIGS. 4G and 4H. In some examples, as similarly described above, the first placement location 432a and the second placement location 432b correspond to locations on the curve 440 that are not occupied by local users (e.g., the first user 402, the second user 404, and the third user 406) in the shared three-dimensional environment 450 and/or that are not occluded by the local users. For example, as illustrated in the overhead view 410 in FIG. 4G and FIG. 4H, the first placement location 432a and the second placement location 432b correspond to locations on the curve 440 in the shared three-dimensional environment 450 that do not fall behind the locations of the local users (e.g., the first user 402, the second user 404, and the third user 406) in the shared three-dimensional environment 450 relative to the virtual object 420 as defined by the lines 441a and 441b.

FIGS. 4I-4K illustrate an alternative example of determining placement locations for visual representations of remote users in a multi-user communication session that includes local users. In FIG. 4I, the first user 402 and the second user 404 are collocated in a physical environment (e.g., physical environment 400 discussed above). For example, as shown in the overhead view 410 in FIG. 4I, the first electronic device 101a and the second electronic device 101b are collocated in a same physical environment while engaging in a multi-user communication session. Additionally, as shown in FIG. 4I, the first electronic device 101a and the second electronic device 101b are in the multi-user communication session with a third electronic device that is non-collocated with the first electronic device 101a and the second electronic device 101b in the physical environment. For example, as indicated in the overhead view 410 in FIG. 4I, the shared three-dimensional environment 450 includes a visual representation of a user of the third electronic device (e.g., avatar 405). In some examples, while the electronic devices are in the multi-user communication session, the electronic devices are presenting virtual object 420 which is shared among the electronic devices in the shared three-dimensional environment 450 as similarly discussed above. From FIG. 4I to FIG. 4J, the electronic devices detect an indication of a request to add an additional remote user (e.g., a fourth user of a fourth electronic device) to the multi-user communication session, such as an indication similar to that described above for adding the third user to the multi-user communication session.

In some examples, as similarly described above, in response to detecting the indication, the electronic devices 101a/101b/101c identify a placement location for a visual representation of the fourth user in the shared three-dimensional environment 450. In some examples, as indicated in the overhead view 410A/410B in FIG. 4J, the curve 440 is applied in the shared three-dimensional environment 450 based on the physical locations of the electronic devices 101a/101b in the physical environment and the location of the avatar 405 corresponding to the third user in the shared three-dimensional environment 450. For example, as shown in the overhead view 410A in FIG. 4J, the curve 440 intersects the location of the first user 402 and the location of the avatar 405 in the shared three-dimensional environment 450 and optionally without intersecting the location of the second user 404 in the shared three-dimensional environment 450. In some examples, the location of the second user 404 in the shared three-dimensional environment 450 is not selected to correspond to the curve 440 (e.g., does not intersect a portion of the curve) based on the location and/or orientation of the second electronic device 101b relative to the virtual object 420 in the shared three-dimensional environment 450. For example, as illustrated in the overhead view 410A in FIG. 4J, the second user 404 is located too close (e.g., less than 0.1, 0.2, 0.5, 0.75, 1, 1.5, 2, or 5 meters) to the virtual object 420 in the shared three-dimensional environment 450. Additionally or alternatively, as indicated by the arrow extending from the second electronic device 101b in the overhead view 410 in FIG. 4I, the second user 404 is facing away from the front surface of the virtual object 420 on which the content of the virtual object 420 is displayed. In some examples, despite the physical location of the second electronic device 101b in the physical environment changing from the overhead view 410A to the overhead view 410B in FIG. 4J, the curve 440 remains based upon the location of the first user 402 and the avatar 405 in the shared three-dimensional environment 450, without being based on the location of the second user 404, due to the second user 404 remaining too close to the virtual object 420 and/or the look direction of the second user 404 remaining away from the front surface of the virtual object 420 in the shared three-dimensional environment 450. In some examples, as illustrated in the overhead view 410B in FIG. 4J, a location of a third electronic device 101c that is associated with a third user 406 who is physically located in the physical environment of the shared three-dimensional environment 450 is also not selected to correspond to the curve 440 in the shared three-dimensional environment 450. For example, as shown in the overhead view 410B in FIG. 4J, the curve 440 does not intersect the location of the third user 406 in the shared three-dimensional environment 450. In some examples, the positioning and/or application of the curve 440 in the shared three-dimensional environment 450 is not based on the location of the third electronic device 101c because the location of the third electronic device 101c is more than a threshold distance (e.g., 1, 2, 3, 4, 5, 10, 12, 15, 20, 30, etc. meters) from the virtual object 420 in the shared three-dimensional environment 450. In some examples, the application of the curve 440 in the shared three-dimensional environment 450 is not based on the location of the third electronic device 101c because the third electronic device 101c is not in the multi-user communication session with the first electronic device 101a, the second electronic device 101b, and the remote electronic device associated with the avatar 405.

Additionally, in some examples, as illustrated in the overhead view 410A/410B in FIG. 4J, when the curve 440 is applied in the shared three-dimensional environment 450, the location of the virtual object 420 is updated in the shared three-dimensional environment 450 relative to the locations of the users within the multi-user communication session. For example, as illustrated from FIG. 4I to FIG. 4J, the virtual object 420 is shifted rightward relative to the locations of the first user 402, the second user 404, and the avatar 405 in the shared three-dimensional environment 450. In some examples, the virtual object 420 is shifted in the shared three-dimensional environment 450 to accommodate placement of visual representations (e.g., avatars) in the shared three-dimensional environment 450 based on the current spatial arrangement of the first electronic device 101a, the second electronic device 101b, and the avatar 405 (and/or the third electronic device 101c) relative to the virtual object 420.

In some examples, as similarly discussed above, following the application of the curve 440 in the shared three-dimensional environment 450, one or more placement locations at which to display a visual representation of the second remote user in the shared three-dimensional environment 450 are determined. For example, as illustrated in the overhead view 410A in FIG. 4K, avatar 411 corresponding to the second remote user in the multi-user communication session is displayed at a placement location in the shared three-dimensional environment 450 according to the curve 440, as discussed previously above. Similarly, as illustrated in the overhead view 410B in FIG. 4K, avatar 413 corresponding to a second remote user in the multi-user communication session is displayed at a placement location in the shared three-dimensional environment 450 according to the curve 440. In some examples, the particular placement location along the curve 440 at which the avatar 411 in the overhead view 410A and the avatar 413 in the overhead view 410B are displayed in the shared three-dimensional environment 450 is selected to be located along the largest opening along the curve 440. For example, in the overhead view 410A in FIG. 4K, the avatar 411 is positioned in the shared three-dimensional environment 450 at a location along the curve 440 that is the largest unoccupied portion of the curve 440. Similarly, in the overhead view 410B in FIG. 4K, the avatar 413 is positioned in the shared three-dimensional environment 450 at a location along the curve 440 that is the largest unoccupied portion of the curve 440.

FIGS. 4L-4P illustrate an alternative example of determining placement locations for visual representations of remote users in a multi-user communication session that includes local users while displaying a horizontally oriented virtual object. In FIG. 4L, the first user 402 and the second user 404 are collocated in physical environment 400 discussed above. For example, as shown in the overhead view 410 in FIG. 4L, the first electronic device 101a and the second electronic device 101b are collocated in a same physical environment while engaging in a multi-user communication session. In some examples, the physical environment 400 corresponds to physical environment 400 discussed above with reference to FIG. 4A. Additionally, in some examples, as shown in FIG. 4L, the second user 404 (e.g., and the second electronic device 101b) is positioned in a field of view of the first electronic device 101a, and the first user 402 (e.g., and the first electronic device 101a) is positioned in a field of view of the second electronic device 101b. Accordingly, in some examples, as shown in FIG. 4L, three-dimensional environment 450A presented at the first electronic device 101a includes a representation (e.g., passthrough representation or computer-generated representation) of the second user 404 (e.g., and the second electronic device 101b) and three-dimensional environment 450B presented at the second electronic device 101b includes a representation of the first user 402 (e.g., and the first electronic device 101a).

In FIG. 4L, the first user 402 and the second user 404 are optionally engaging in a shared activity while the first electronic device 101a and the second electronic device 101b are in the multi-user communication session. For example, as shown in FIG. 4L, the three-dimensional environments 450A/450B include virtual object 425 corresponding to a shared virtual game in the multi-user communication session, such as a virtual board game. In some examples, as similarly discussed above, because the virtual object 425 is shared in the multi-user communication session, the content of the virtual object 425 (e.g., virtual game pieces, virtual user interfaces, a virtual map, etc.) is viewable by and/or interactive to the first user 402 and the second user 404 via their respective electronic devices 101a/101b. Additionally, as alluded to above, the virtual object 425 is optionally a second type of virtual object that is different from the first type of virtual object discussed above. For example, the virtual object 425 is a horizontally oriented virtual object (e.g., the content of the virtual object 425 is presented on a top (e.g., flat) surface of the virtual object 425 from the viewpoints of the electronic devices 101a/101b) which is different from the vertically oriented virtual object 420 described above.

From FIG. 4L to FIG. 4M, the first electronic device 101a and the second electronic device 101b detect an indication of a request to add a remote user (e.g., a third user of a third electronic device) to the multi-user communication session between the first electronic device 101a and the second electronic device 101b. For example, the first electronic device 101a and/or the second electronic device 101b detect input provided by the first user 402 and/or the second user 404 or other indication of input for adding the remote user to the multi-user communication session, such as similar to the indication discussed above with reference to FIG. 4B.

In some examples, as shown in FIG. 4M and as similarly discussed above, in response to detecting the indication of the request to add the remote user to the multi-user communication session, the first electronic device 101a and/or the second electronic device 101b determine a placement location for a visual representation of the remote user in the shared three-dimensional environment between the first electronic device 101a and the second electronic device 101b. In some examples, as illustrated in the overhead view 410 in FIG. 4M, determining/identifying the placement location in the shared three-dimensional environment 450 includes applying a best-fit shape to the shared three-dimensional environment 450 that is based on the physical locations of the first electronic device 101a and the second electronic device 101b in the physical environment 400 relative to the virtual object 425. In some examples, because the virtual object 425 is a virtual object of the second type (e.g., a horizontally oriented virtual object) as discussed above, rather than apply a curve to the shared three-dimensional environment 450, the first electronic device 101a and/or the second electronic device 101b apply a predefined shape (e.g., a circle) 440 to the shared three-dimensional environment 450. In some examples, as shown in the overhead view 410 in FIG. 4M, the circle 440 corresponds to the physical locations of the first user 402 and the second user 404 in the shared three-dimensional environment 450, such that a portion of the circle 440 intersects the locations of the first user 402 and the second user 404. For example, a radius of the circle 440 corresponds to a distance from the virtual object 425 to the first user 402 and the second user 404 in the shared three-dimensional environment 450. Additionally, in some examples, the circle 440 is centered on (e.g., includes an origin at) a location of the virtual object 425 in the shared three-dimensional environment 450.

In some examples, following the application of the circle 440 in the shared three-dimensional environment 450 relative to the virtual object 425 based on the locations of the first user 402 and the second user 404, the first electronic device 101a and/or the second electronic device 101b determine one or more placement locations in the shared three-dimensional environment 450 at which to position a visual representation of the remote user when adding the remote user to the multi-user communication session. In some examples, as shown in the overhead view 410 in FIG. 4M, a first placement location 432a, a second placement location 432b, and a third placement location 432c are identified in the shared three-dimensional environment 450 according to the circle 440. For example, as indicated in the overhead view 410 in FIG. 4M, the first placement location 432a, the second placement location 432b, and the third placement location 432c correspond to unoccupied locations (e.g., unoccupied by the first user 402 and the second user 404) corresponding to the circle 440 in the shared three-dimensional environment 450.

In some examples, as illustrated in the overhead view 410 in FIG. 4N, a visual representation of the remote user is then presented in the shared three-dimensional environment 450 at one of the placement locations relative to the virtual object 425. For example, as shown in FIG. 4N, avatar 405 corresponding to the remote user (e.g., the third user) is displayed at the first placement location 432a of FIG. 4M in the shared three-dimensional environment 450. In some examples, as additional remote users are subsequently added to the multi-user communication session as similarly discussed above, the first electronic device 101a and/or the second electronic device 101b display visual representations of the additional remote users at the other placement locations in the shared three-dimensional environment 450. For example, as shown in the overhead view 410 in FIG. 4N, avatar 411 corresponding to a fourth user (e.g., of a fourth electronic device) is positioned at the second placement location 432b of FIG. 4M and avatar 413 corresponding to a fifth user (e.g., of a fifth electronic device) is positioned at the third placement location 432c of FIG. 4M in the shared three-dimensional environment 450. In some examples, as indicated in the overhead view 410 in FIG. 4N, when the avatar 405 (e.g., and subsequently the avatars 411/413) is displayed in the shared three-dimensional environment 450, the avatar 405 is displayed with an orientation that faces toward the virtual object 425, as indicated by the arrow extending from the avatar 405.

FIGS. 4O-4P illustrate an alternative example of determining placement locations for visual representations of remote users in a multi-user communication session that includes local users. In FIG. 4O, the first user 402 and the second user 404 are collocated with a third user 406 in a physical environment (e.g., physical environment 400 discussed above). For example, as shown in the overhead view 410 in FIG. 4O, the first electronic device 101a, the second electronic device 101b, and a third electronic device 101c are collocated in a same physical environment while engaging in a multi-user communication session. Additionally, as shown in FIG. 4O, while the electronic devices 101a/101b/101c are in the multi-user communication session, the electronic devices 101a/101b/101c are presenting virtual object 425 which is shared among the electronic devices 101a/101b/101c in the shared three-dimensional environment 450 as similarly discussed above. From FIG. 4O to FIG. 4P, the electronic devices 101a/101b/101c detect an indication of a request to add a remote user (e.g., a fourth user of a fourth electronic device) to the multi-user communication session, such as an indication similar to that described above for adding the third user to the multi-user communication session.

In some examples, as similarly described above, in response to detecting the indication, the electronic devices 101a/101b/101c identify a placement location for a visual representation of the fourth user in the shared three-dimensional environment 450. In some examples, as indicated in the overhead view 410A/410B in FIG. 4P, the electronic devices 101a/101b/101c apply the circle 440 (e.g., because the virtual object 425 is a horizontally oriented virtual object as previously discussed above) based on the physical locations of the electronic devices 101a/101b/101c in the physical environment. In some examples, the circle 440 is defined in the shared three-dimensional environment 450 based on the location of the electronic device that is closest to the virtual object 425 in the shared three-dimensional environment 450. For example, as shown in the overhead view 410A in FIG. 4P, the circle 440 is positioned relative to the virtual object 425 based on the location of the second user 404 (e.g., to intersect the location of the second user 404) in the shared three-dimensional environment 450 because the second user 404 is located closest to the virtual object 425 in the shared three-dimensional environment 450. Alternatively, in some examples, as similarly discussed above, the circle 440 is defined in the shared three-dimensional environment 450 based on the location of the second user 404 because the second user 404 was the user in the multi-user communication session that initially provided the input for sharing the virtual object 425 in the shared three-dimensional environment 450 (e.g., and detected by the second electronic device 101b). As another example, as shown in the overhead view 410B in FIG. 4P, the circle 440 is positioned relative to the virtual object 425 based on the location(s) of the electronic device(s) that is/are farthest from the virtual object 425 in the shared three-dimensional environment 450. For example, in the overhead view 410B in FIG. 4P, the first user 402 of the first electronic device 101a and the third user 406 of the third electronic device 101c are equidistant from the virtual object 425 and are farther from the virtual object 425 than the second user 404 of the second electronic device 101b; accordingly, the circle 440 is applied in the shared three-dimensional environment 450 based on the locations of the first user 402 and the third user 406, as shown.

In some examples, circle 440 is associated with a maximum (e.g., and a minimum) radius in the shared three-dimensional environment 450. For example, the radius of the circle 440 has a maximum distance and a minimum distance relative to the center of the virtual object 425 in the shared three-dimensional environment 450. In some examples, as discussed above, the radius of the circle 440 is determined based on the physical locations of the local users in the multi-user communication session relative to the virtual object 425 (e.g., the locations of the local users define points on the circle 440 in the shared three-dimensional environment 450). However, in the instance in which the locations of the local users are more than the maximum distance (e.g., 5, 10, 15, 20, 25, etc. meters) from the virtual object 425 in the shared three-dimensional environment 450, the radius of the circle 440 is set at the maximum distance from the virtual object 425. Similarly, in some examples, if the locations of the local users are less than the minimum distance (e.g., 0.1, 0.2, 0.3, 0.5, 0.75, 1, etc. meters) from the virtual object 425 in the shared three-dimensional environment 450, the radius of the circle 440 is set at the minimum distance from the virtual object 425.

In some examples, as similarly discussed above, following the application of the circle 440 in the shared three-dimensional environment 450, one or more placement locations are determined relative to the virtual object 425 according to the circle 440. For example, as indicated in the overhead view 410A/410B in FIG. 4P, a first placement location 432a and a second placement location 432b are identified in the shared three-dimensional environment 450 relative to the virtual object 425 according to the circle 440. In some examples, determining the placement locations relative to the virtual object 425 have one or more characteristics of determining the placement locations relative to the virtual object 420 discussed above. For example, though not illustrated in the example of FIG. 4P, the first electronic device 101a, the second electronic device 101b, and/or the third electronic device 101c define a plurality of vectors or lines that extends from a center of the virtual object 425 to a point on the circle 440 in the shared three-dimensional environment 450. As described above, the first placement location 432a and the second placement location 432b optionally correspond to unoccupied locations in the shared three-dimensional environment 450 (e.g., unoccupied by the first user 402, the second user 404, and the third user 406) corresponding to the circle 440, as shown in FIG. 4P. Additionally, in some examples, as similarly discussed above, the first placement location 432a and the second placement location 432b correspond to locations in the shared three-dimensional environment 450 that are not occluded by the local users. For example, as illustrated in the overhead view 410A/410B in FIG. 4P, the first placement location 432a and the second placement location 432b correspond to locations on the circle 440 in the shared three-dimensional environment 450 that do not fall behind the locations of the local users (e.g., the first user 402, the second user 404, and the third user 406) in the shared three-dimensional environment 450 relative to the virtual object 425. In some examples, as previously described herein, once the one or more placement locations are identified in the shared three-dimensional environment 450, the first electronic device 101a, the second electronic device 101b, and the third electronic device 101c position a visual representation of the remote user (e.g., an avatar corresponding to the remote user) at one of the one or more placement locations in the shared three-dimensional environment 450.

FIGS. 4Q-4S illustrate an alternative example of determining placement locations for visual representations of remote users in a multi-user communication session that includes local users while displaying a vertically oriented virtual object. In FIG. 4Q, the first user 402 and the second user 404 are collocated in a same physical environment. For example, as shown in the overhead view 410 in FIG. 4Q, the first electronic device 101a and the second electronic device 101b are collocated in a same physical space (e.g., room) while engaging in a multi-user communication session via shared three-dimensional environment 450. In some examples, the physical environment corresponds to physical environment 400 discussed above with reference to FIG. 4A.

In FIG. 4Q, the first user 402 and the second user 404 are optionally engaging in a shared activity while the first electronic device 101a and the second electronic device 101b are in the multi-user communication session. For example, as shown in FIG. 4Q, the shared three-dimensional environment includes virtual object 420 corresponding to a shared virtual application window (e.g., including one or more user interfaces). In some examples, the virtual object 420 has one or more characteristics of virtual object 420 described previously herein. For example, the content of the virtual object 420 (e.g., virtual user interfaces, selectable options, virtual controls, images and/or video, etc.) is viewable by and/or interactive to the first user 402 and the second user 404 via their respective electronic devices 101a/101b in the shared three-dimensional environment 450. Additionally, as similarly discussed herein, the virtual object 420 is optionally a first type of virtual object. For example, the virtual object 420 is a vertically oriented virtual object (e.g., the content of the virtual object 420 is presented on a front surface of the virtual object 420 from the viewpoints of the electronic devices 101a/101b).

In FIG. 4Q, the first electronic device 101a and the second electronic device 101b have detected an indication of a request to add a remote user (e.g., a third user of a third electronic device) to the multi-user communication session between the first electronic device 101a and the second electronic device 101b. For example, the first electronic device 101a and/or the second electronic device 101b have detected input provided by the first user 402 and/or the second user 404 or other indication of input for adding the remote user to the multi-user communication session, such as similar to the indication discussed above with reference to FIG. 4B.

In some examples, as shown in FIG. 4Q and as similarly discussed above, in response to detecting the indication of the request to add the remote user to the multi-user communication session, the first electronic device 101a and/or the second electronic device 101b determine a placement location for a visual representation of the remote user in the shared three-dimensional environment between the first electronic device 101a and the second electronic device 101b. In some examples, as illustrated in the overhead view 410 in FIG. 4Q, determining/identifying the placement location in the shared three-dimensional environment 450 includes applying a best-fit shape to the shared three-dimensional environment 450 that is based on the physical locations of the first electronic device 101a and the second electronic device 101b in the physical environment 400 relative to the virtual object 420, as previously described herein. In some examples, because the virtual object 420 is a virtual object of the first type (e.g., a vertically oriented virtual object) as discussed above, rather than apply a circle to the shared three-dimensional environment 450, the first electronic device 101a and/or the second electronic device 101b apply a curve or arc 440 to the shared three-dimensional environment 450. In some examples, the curve 440 has one or more characteristics of the curve 440 described previously herein. In some examples, as illustrated in the overhead view 410 in FIG. 4Q, the curve 440 corresponds to (e.g., passes through and/or intersects) the location of the second user 404 (e.g., and the second electronic device 101b), without corresponding to the location of the first user 402 (e.g., and the first electronic device 101a) in the shared three-dimensional environment 450. For example, as previously described herein, the curve 440 is applied to the location of the second user 404 in the shared three-dimensional environment 450 without being applied to the location of the first user 402 in the shared three-dimensional environment 450 because the second user 404 is the user who initially shared the virtual object 420 in the multi-user communication session, the second user 404 is closer to the virtual object 420 than the first user 402 in the shared three-dimensional environment 450, and/or the first user 402 is more than the threshold distance discussed above from the virtual object 420 in the shared three-dimensional environment 450.

In some examples, as illustrated in the overhead view 410 in FIG. 4Q, one or more placement locations are identified in the shared three-dimensional environment 450 based on the arc 440 in the shared three-dimensional environment 450. For example, as shown in FIG. 4Q, identifying the one or more placement locations includes defining a plurality of vectors or lines 441a-441d that each extends from a center of the virtual object 420 to a point along the arc 440, where each intersection of the vector or line with an unoccupied point along the arc 440 corresponds to a placement location (e.g., a particular angle on the arc or curve 440 in the shared three-dimensional environment 450), as similarly discussed above. Particularly, as shown in the overhead view 410 in FIG. 4Q, the line 441a extends between the center of the virtual object 420 and the location of the first user 402 in the shared three-dimensional environment 450, indicating that the location of the first user 402 corresponds to an occupied location in the shared three-dimensional environment, and the line 441b extends between the center of the virtual object 420 and the location of the second user 404 in the shared three-dimensional environment 450, indicating that the location of the second user 404 corresponds to an occupied location in the shared three-dimensional environment.

In some examples, as shown in the overhead view 410 in FIG. 4R, the first electronic device 101a and/or the second electronic device 101b identify a first placement location 432a and a second placement location 432b in the shared three-dimensional environment 450 at which to position visual representations of remote users when adding the remote users to the multi-user communication session. In some examples, as shown in the overhead view 410, the placement locations 432a/432b are positioned along the arc 440 relative to the virtual object 420. Additionally, as alluded to above, in some examples, as shown in FIG. 4R, the placement locations 432a/432b correspond to unoccupied locations along the arc 440 that are adjacent to the physical locations of the first user 402 and the second user 404 in the shared three-dimensional environment 450 (e.g., unoccupied by the first user 402 and the second user 404 and/or other physical objects in the physical environment).

In some examples, as similarly discussed above, after identifying the one or more placement locations in the shared three-dimensional environment 450, the first electronic device 101a and the second electronic device 101b present a visual indication of the user of the third electronic device at one of the placement locations in the shared three-dimensional environment 450. In some examples, as indicated in the overhead view 410 in FIG. 4R, presenting the visual indication of the user of the third electronic device at a placement location in the shared three-dimensional environment 450 includes determining reference point 446 relative to the virtual object 420 in the shared three-dimensional environment 450. For example, as illustrated in the overhead view 410 in FIG. 4R, the reference point 446 corresponds to a center point between the second user 404 (e.g., and the second electronic device 101b) and the virtual object 420 in the shared three-dimensional environment 450. Particularly, as shown in FIG. 4R, the reference point 446 corresponds to a location on the line 441b that extends between the center of the virtual object 420 and the location of the second user 404 in the shared three-dimensional environment 450. In some examples, as mentioned above, the reference point 446 is defined based on the location of the second user 404 (e.g., rather than based on the location of the first user 402) in the shared three-dimensional environment 450 because the second user 404 was the user who initially shared the virtual object 420 in the multi-user communication session and/or because the second user 404 is the user spatially located closest to the virtual object 420 in the shared three-dimensional environment 450. In some examples, as discussed in more detail below, the reference point 446 serves as a reference for orientations of visual representations in the shared three-dimensional environment 450.

In some examples, as shown in the overhead view 410 in FIG. 4S, the first electronic device 101a and the second electronic device 101b display a visual representation of the user of the third electronic device at one of the identified placement locations in the shared three-dimensional environment 450. For example, as shown in FIG. 4S, avatar 405 corresponding to the user of the third electronic device is displayed at a location in the shared three-dimensional environment 450 corresponding to the first placement location 432a. Additionally, in some examples, as shown in the overhead view 410 in FIG. 4S, the avatar 405 is displayed with an orientation that is angled toward the reference point 446 in the shared three-dimensional environment 450 (e.g., rather than toward the virtual object 420 in the shared three-dimensional environment 450). For example, as indicated by the arrow extending from the head of the avatar 405 in FIG. 4S, the avatar 405 faces toward the reference point 446 when the avatar 405 is presented in the shared three-dimensional environment 450. Similarly, in some examples, if an additional remote user (e.g., a fourth user of a fourth electronic device) joins and/or is added to the multi-user communication session, the first electronic device 101a and the second electronic device 101b present a visual indication of the additional remote user at the second placement location 432b in the shared three-dimensional environment 450. For example, avatar 411 corresponding to a user of the fourth electronic device is displayed at a location in the shared three-dimensional environment 450 corresponding to the second placement location 432b with an orientation that faces toward the reference point 446 in the shared three-dimensional environment 450, as similarly discussed above.

In some examples, the first electronic device 101a and/or the second electronic device 101b select the reference point 446 to serve as the reference for the orientations of visual representations (e.g., the avatars 405/411) rather than the virtual object 420 (e.g., as previously discussed herein) based on a size (e.g., width) of the virtual object 420 in the shared three-dimensional environment 450. For example, the first electronic device 101a and/or the second electronic device 101b determine the reference point 446 in the shared three-dimensional environment 450 in accordance with a determination that the width of the virtual object 420 (e.g., the width of the front-facing surface of the virtual object 420) is within a width threshold (e.g., 0.5, 0.75, 1, 1.5, 2, 3, 5, etc. meters) in the shared three-dimensional environment 450. In some examples, the width of the virtual object 420 being within the width threshold indicates that the first user 402 and the second user 404 are arranged/positioned in a spatial arrangement akin to a conversational or circular spatial template in the shared three-dimensional environment 450, as similarly described herein with reference to spatial templates, and therefore defining the reference point 446 in the shared three-dimensional environment 450 enables the avatars 405/411 to be oriented to more naturally align with and/or correspond to the spatial arrangement of the first user 402 and the second user 404 in the shared three-dimensional environment 450.

FIGS. 4T-4W illustrate examples of determining placement locations for visual representations of remote users in a multi-user communication session that includes local users based on one or more physical properties of a physical environment in which the local users are collocated. In FIG. 4T, the first user 402, the second user 404 and the third user 406 are collocated in a physical environment (e.g., such as physical environment 400 discussed previously above with reference to FIG. 4A). For example, as shown in the overhead view 410 in FIG. 4T, the first electronic device 101a, the second electronic device 101b, and the third electronic device 101c are collocated in a same physical environment (e.g., a same room or space) while engaging in a multi-user communication session.

In FIG. 4T, the first user 402, the second user 404 and the third user 406 are optionally engaging in a shared activity while the first electronic device 101a, the second electronic device 101b and the third electronic device 101c are in the multi-user communication session. For example, as shown in the overhead view 410 in FIG. 4T, shared three-dimensional environment 450 (e.g., a three-dimensional environment that is shared among the electronic devices 101a/101b/101c and is presented from the unique viewpoints of the electronic devices 101a/101b/101c in the physical environment) includes virtual object 420 corresponding to a shared virtual application window (e.g., including one or more user interfaces). In some examples, the virtual object 420 has one or more characteristics of virtual object 420 described previously herein. For example, the content of the virtual object 420 (e.g., virtual user interfaces, selectable options, virtual controls, images and/or video, etc.) is viewable by and/or interactive to the first user 402, the second user 404, and the third user 406 via their respective electronic devices 101a/101b/101c in the shared three-dimensional environment 450. Additionally, as similarly discussed herein, the virtual object 420 is optionally a vertically oriented virtual object (e.g., the content of the virtual object 420 is presented on a front surface of the virtual object 420 from the viewpoints of the electronic devices 101a/101b/101c), as indicated in the overhead view 410.

In FIG. 4T, the first electronic device 101a, the second electronic device 101b and/or the third electronic device 101c have detected an indication of a request to add a remote user (e.g., a fourth user of a fourth electronic device (not shown)) to the multi-user communication session that includes the first electronic device 101a, the second electronic device 101b and the third electronic device 101c. For example, the first electronic device 101a, the second electronic device 101b, and/or the third electronic device 101c have detected input provided by the first user 402, the second user 404, and/or the third user 406 or other indication of input for adding the remote user to the multi-user communication session, such as similar to the indication discussed above with reference to FIG. 4B.

In some examples, as shown in the overhead view 410 in FIG. 4T and as similarly discussed above, in response to detecting the indication of the request to add the remote user to the multi-user communication session, the first electronic device 101a, the second electronic device 101b, and/or the third electronic device 101c determine a placement location for a visual representation of the remote user in the shared three-dimensional environment 450 that includes the first user 402, the second user 404, and the third user 406. In some examples, determining/identifying the placement location in the shared three-dimensional environment 450 includes applying a best-fit shape to the shared three-dimensional environment 450 that is based on the physical locations of the first electronic device 101a, the second electronic device 101b and the third electronic device 101c in the physical environment relative to the virtual object 420, as previously described herein. In some examples, because the virtual object 420 is a vertically oriented virtual object, as discussed above, rather than apply a circle to the shared three-dimensional environment 450, the first electronic device 101a, the second electronic device 101b, and/or the third electronic device 101c apply a curve or arc (not shown) to the shared three-dimensional environment 450. In some examples, the curve has one or more characteristics of the curve 440 described previously herein. In some examples, as similarly discussed above, the curve corresponds to (e.g., passes through and/or intersects) the locations of the collocated users in the physical environment, namely the locations of the first user 402 (e.g., and the first electronic device 101a), the second user 404 (e.g., and the second electronic device 101b), and the third user 404 (e.g., and the third electronic device 101c) in the shared three-dimensional environment 450.

In some examples, as illustrated in the overhead view 410 in FIG. 4T, one or more placement locations are identified in the shared three-dimensional environment 450 based on the arc or curve in the shared three-dimensional environment 450. For example, as shown in the overhead view 410 in FIG. 4T and as similarly discussed above, identifying the one or more placement locations includes identifying unoccupied points along the arc (e.g., points that are not occupied by users in the multi-user communication session). In some examples, as shown in the overhead view 410 in FIG. 4T, the first electronic device 101a, the second electronic device 101b, and/or the third electronic device 101c identify a first placement location 432a and a second placement location 432b in the shared three-dimensional environment 450 at which to position visual representations of remote users when adding the remote users to the multi-user communication session. In some examples, the placement locations 432a/432b are positioned along the arc relative to the virtual object 420, as similarly discussed above. Additionally, as alluded to above, in some examples, as shown in FIG. 4T, the placement locations 432a/432b correspond to unoccupied locations (e.g., unoccupied by users in the multi-user communication session) along the arc that are adjacent to the physical locations of the first user 402, the second user 404, and the third user 406 in the shared three-dimensional environment 450 (e.g., unoccupied by the first user 402, the second user 404, and the third user 406).

In some examples, when evaluating whether a respective placement location is a valid placement location for the display of the visual representation of the remote user in the shared three-dimensional environment 450, the first electronic device 101a, the second electronic device 101b, and/or the third electronic device 101c evaluate one or more physical properties or characteristics of the physical environment in which the electronic devices 101a/101b/101c are collocated. For example, based on image data captured via one or more sensors (e.g., cameras) of the first electronic device 101a, the second electronic device 101b, and/or the third electronic device 101c, the first electronic device 101a, the second electronic device 101b, and/or the third electronic device 101c identify physical objects and/or physical obstacles or surfaces that are present in the physical environment, including walls, ceiling, and/or floor/ground of the physical environment. As illustrated in the overhead view 410 in FIG. 4T, the physical environment (e.g., room) in which the first user 402, the second user 404, and the third user 406 are collocated includes physical object 455 (e.g., a table, chair, sofa, etc.).

In some examples, an identified placement location in the shared three-dimensional environment 450 is determined to be an invalid location for the display of the visual representation of the remote user in accordance with a determination that the identified placement location at least partially overlaps and/or intersects with a physical object or obstacle or other surface in the physical environment that would cause or create a visual spatial conflict in the shared three-dimensional environment 450 (e.g., a visual spatial conflict between the visual representation of the remote user and the physical object, obstacle, or other surface). In the example of FIG. 4T, the first electronic device 101a, the second electronic device 101b, and/or the third electronic device 101c determine that the first placement location 432a at least partially overlaps and/or intersects with the physical object 455 in the shared three-dimensional environment 450. For example, the first electronic device 101a, the second electronic device 101b, and/or the third electronic device 101c determine that the location of the physical object 455 in the shared three-dimensional environment 450 corresponds to and/or at least partially overlaps the first placement location 432a in the shared three-dimensional environment 450. Accordingly, in some examples, as indicated in the overhead view 410 in FIG. 4T (e.g., by the illustrated “x”), the first electronic device 101a, the second electronic device 101b, and/or the third electronic device 101c determine that the first placement location 432a is an invalid location for the display of the visual representation of the remote user in the shared three-dimensional environment 450. In such an instance, because the first placement location 432a is invalidated in the shared three-dimensional environment 450, the first electronic device 101a, the second electronic device 101b, and/or the third electronic device 101c select the second placement location 432b as the display location for the visual representation of the remote user in the shared three-dimensional environment 450. Particularly, as indicated in the overhead view 410 in FIG. 4T (e.g., indicated by the illustrated checkmark), the first electronic device 101a, the second electronic device 101b, and/or the third electronic device 101c determine that the second placement location 432b is a valid location for the display of the visual representation of the remote user in the shared three-dimensional environment 450 (e.g., because the second placement location 432b is not at least partially overlapping and/or intersecting with a physical object, obstacle, or other surface in the physical environment of the shared three-dimensional environment 450). Accordingly, when adding the remote user to the multi-user communication session, the first electronic device 101a, the second electronic device 101b, and the third electronic device 101c optionally display the visual representation of the remote user (e.g., an avatar) at a location in the shared three-dimensional environment 450 corresponding to the second placement location 432b, as previously discussed herein.

FIG. 4U illustrates an alternative example of determining placement locations for visual representations of remote users in a multi-user communication session that includes local users based on one or more physical properties of a physical environment in which the local users are collocated. In FIG. 4U, the first user 402, the second user 404 and the third user 406 are collocated in a physical environment (e.g., such as physical environment 400 discussed previously above with reference to FIG. 4A). For example, as shown in the overhead view 410 in FIG. 4U, the first electronic device 101a, the second electronic device 101b, and the third electronic device 101c are collocated in a same physical environment (e.g., a same room or space) while engaging in a multi-user communication session.

In FIG. 4U, the first user 402, the second user 404 and the third user 406 are physically located around physical object 456 (e.g., a table) in the physical environment while participating in the multi-user communication session. Additionally, the first user 402, the second user 404, and the third user 406 are optionally engaging in a shared activity while the first electronic device 101a, the second electronic device 101b and the third electronic device 101c are in the multi-user communication session. For example, the first electronic device 101a, the second electronic device 101b, and/or the third electronic device 101c are displaying a virtual object (e.g., a game application) on (e.g., a top surface of) the physical object 456 in the shared three-dimensional environment 450. In some examples, the virtual object (not shown) has one or more characteristics of virtual object 425 described previously herein. For example, as similarly discussed herein, the virtual object is optionally a horizontally oriented virtual object (e.g., the content of the virtual object is presented on a top surface of the virtual object from the viewpoints of the electronic devices 101a/101b/101c).

In FIG. 4U, the first electronic device 101a, the second electronic device 101b and/or the third electronic device 101c have detected an indication of a request to add a remote user (e.g., a fourth user of a fourth electronic device (not shown)) to the multi-user communication session that includes the first electronic device 101a, the second electronic device 101b and the third electronic device 101c. For example, the first electronic device 101a, the second electronic device 101b, and/or the third electronic device 101c have detected input provided by the first user 402, the second user 404, and/or the third user 406 or other indication of input for adding the remote user to the multi-user communication session, such as similar to the indication discussed above with reference to FIG. 4B.

In some examples, as shown in the overhead view 410 in FIG. 4U and as similarly discussed above, in response to detecting the indication of the request to add the remote user to the multi-user communication session, the first electronic device 101a, the second electronic device 101b, and/or the third electronic device 101c determine a placement location for a visual representation of the remote user in the shared three-dimensional environment 450 that includes the first user 402, the second user 404, and the third user 406. In some examples, determining/identifying the placement location in the shared three-dimensional environment 450 includes applying a best-fit shape to the shared three-dimensional environment 450 that is based on the physical locations of the first electronic device 101a, the second electronic device 101b and the third electronic device 101c in the physical environment (optionally relative to the virtual object that is displayed in the shared three-dimensional environment 450), as previously described herein. In FIG. 4U, the first electronic device 101a, the second electronic device 101b, and/or the third electronic device 101c apply a circle (not shown) to the shared three-dimensional environment 450 (optionally because the virtual object that is displayed on the physical object 456 is a horizontally oriented virtual object, as previously discussed herein). In some examples, the circle has one or more characteristics of the circle 440 described previously herein. In some examples, as similarly discussed above, the circle corresponds to (e.g., passes through and/or intersects) the locations of the collocated users in the physical environment, namely the locations of the first user 402 (e.g., and the first electronic device 101a), the second user 404 (e.g., and the second electronic device 101b), and the third user 404 (e.g., and the third electronic device 101c) in the shared three-dimensional environment 450.

In some examples, as illustrated in the overhead view 410 in FIG. 4U, one or more placement locations are identified in the shared three-dimensional environment 450 based on the circle in the shared three-dimensional environment 450. For example, as shown in the overhead view 410 in FIG. 4U and as similarly discussed above, identifying the one or more placement locations includes identifying unoccupied points along the circle (e.g., points that are not occupied by users in the multi-user communication session). In some examples, as shown in the overhead view 410 in FIG. 4U, the first electronic device 101a, the second electronic device 101b, and/or the third electronic device 101c identify a first placement location 432a and a second placement location 432b in the shared three-dimensional environment 450 at which to position visual representations of remote users when adding the remote users to the multi-user communication session. In some examples, the placement locations 432a/432b are positioned along the circle relative to the physical object 456 and/or relative to (e.g., centered on) the virtual object (not shown) that is displayed on the top surface of the physical object 456 in the shared three-dimensional environment 450, as similarly discussed above. Additionally, as alluded to above, in some examples, as shown in FIG. 4U, the placement locations 432a/432b correspond to unoccupied locations (e.g., unoccupied by users in the multi-user communication session) along the circle that are adjacent to the physical locations of the first user 402, the second user 404, and the third user 406 in the shared three-dimensional environment 450 (e.g., unoccupied by the first user 402, the second user 404, and the third user 406). In some examples, in which a virtual object is not being displayed in the shared three-dimensional environment 450 when identifying the placement locations 432a/432b, the placement locations 432a/432b are determined based on the spatial arrangement of (e.g., including distances between) the first user 402, the second user 404, and the third user 406 in the physical environment of the shared three-dimensional environment 450.

In some examples, as similarly discussed above, after identifying the placement locations 432a/432b in the shared three-dimensional environment 450, the first electronic device 101a, the second electronic device 101b, and/or the third electronic device 101c evaluate the identified placement locations 432a/432b to determine whether the placement locations 432a/432b correspond to valid display locations for the visual representation of the remote user in the shared three-dimensional environment 450. For example, as similarly discussed above, the first electronic device 101a, the second electronic device 101b, and/or the third electronic device 101c compare the placement locations 432a/432b to locations of detected physical objects and/or obstacles in the physical environment of the shared three-dimensional environment 450 to determine whether the display of the visual representation of the remote user at either of the placement locations 432a/432b would cause or create a visual spatial conflict in the shared three-dimensional environment 450 (e.g., between the visual representation of the remote user and the physical object or obstacle). In some examples, as illustrated in the overhead view 410 in FIG. 4U, the first electronic device 101a, the second electronic device 101b, and/or the third electronic device 101c determine that the first placement location 432a is an invalid placement location for the visual representation of the remote user in the shared three-dimensional environment 450 (e.g., as indicated by the “x”) because the first placement location 432a is at least partially overlapping with and/or intersecting a location of the physical object 456 in the shared three-dimensional environment 450. Additionally, in FIG. 4U, the first electronic device 101a, the second electronic device 101b, and/or the third electronic device 101c determine that the second placement location 432b is a valid placement location at which to display the visual representation of the remote user in the shared three-dimensional environment 450 (e.g., as indicated by the checkmark) because the second placement location 432b is not at least partially overlapping with and/or intersecting a location of a physical object or other obstacle in the shared three-dimensional environment 450. Accordingly, when adding the remote user to the multi-user communication session, the first electronic device 101a, the second electronic device 101b, and the third electronic device 101c optionally display the visual representation of the remote user (e.g., an avatar) at a location in the shared three-dimensional environment 450 corresponding to the second placement location 432b, as previously discussed herein.

In some examples, in accordance with a determination that a spatial template has been applied to the shared three-dimensional environment 450, the identified placement locations 432a/432b are evaluated based on or according to a (e.g., predefined) ranking weight or factor associated with the placement locations 432a/432b relative to the particular spatial template that has been applied to the shared three-dimensional environment 450. For example, the ranking weight applied to each of the placement locations 432a/432b indicates or corresponds to an ideal order in which visual representations of remote users are populated into the placement locations 432a/432b according to the particular spatial template that has been applied to the shared three-dimensional environment 450. As an example, in FIG. 4U, in accordance with a determination that a surround spatial template has been applied to the shared three-dimensional environment 450 (e.g., automatically based on the spatial arrangement of the users 402/404/406 or based on the particular application that is operating (e.g., a game application) or in response to user input designating the surround spatial template), the first placement location 432a has a higher rank than the second placement location 432b. Accordingly, in FIG. 4U, the first placement location 432a is evaluated first (e.g., prior to the second placement location 432b). In some examples, the ranking weight is determined according to the particular application that is operating in the shared three-dimensional environment 450. For example, if a virtual game is displayed in the shared three-dimensional environment 450 (e.g., on the surface of the physical object 456), the first placement location 432a may be associated with a seat for participating in the virtual game in the shared three-dimensional environment 450, whereas the second placement location 432b may be associated with a seat for acting as a spectator of the virtual game in the shared three-dimensional environment 450, rendering the ranking weight of the first placement location 432a higher than that of the second placement location 432b.

In some examples, in which an alternative valid placement location (e.g., such as the second placement location 432b in FIGS. 4T and 4U) is not able to be identified, the first electronic device 101a, the second electronic device 101b, and/or the third electronic device 101c update a location of the placement location within the shared three-dimensional environment 450 to cause the invalid placement location (e.g., such as the first placement location 432a in FIGS. 4T and 4U) to become a valid placement location. For example, as discussed below, the first electronic device 101a, the second electronic device 101b, and/or the third electronic device 101c apply or implement a nudging behavior to the (e.g., currently) invalid placement location. As an example, in FIG. 4V, which is optionally an alternative to the example of FIG. 4U, the placement location 432a (e.g., corresponding to the first placement location 432a in FIG. 4U) is optionally the only available identified placement location within the shared three-dimensional environment 450 (e.g., based on the current spatial arrangement of the users 402/404/406 in the physical environment of the shared three-dimensional environment 450, based on the current type of virtual object displayed in the shared three-dimensional environment, based on whether a spatial template is being applied to the shared three-dimensional environment). Accordingly, in FIG. 4V, to accommodate the display of the visual representation of the remote user in the shared three-dimensional environment 450 when adding the remote user to the multi-user communication session, the first electronic device 101a, the second electronic device 101b, and the third electronic device 101c nudge (e.g., move and/or update) the placement location 432a, such that the placement location 432a no longer at least partially overlaps with and/or intersects the location of the physical object 456 in the shared three-dimensional environment 450. For example, as illustrated in the overhead view 410 in FIG. 4V, the first electronic device 101a, the second electronic device 101b, and/or the third electronic device 101c shift the placement location 432a away from its prior location 432a-1 intersecting the physical object 456, until the placement location 432a is no longer overlapping and/or intersecting the location of the physical object 456 in the shared three-dimensional environment 450, rendering the placement location 432a a valid location for the display of the visual representation of the remote user in the shared three-dimensional environment 450.

In some examples, a direction and/or magnitude (e.g., of distance) in which the placement location 432a is nudged (e.g., shifted) in the shared three-dimensional environment 450 is based on the location of the physical object 456 in the shared three-dimensional environment 450. For example, in FIG. 4V, the first electronic device 101a, the second electronic device 101b, and the third electronic device 101c move the placement location 432a in a direction that is away from the physical object 456 (e.g., along a line through the placement location 432a) and a distance that causes the placement location 432a to no longer at least partially intersect with the location of the physical object 456 in the shared three-dimensional environment 450. In some examples, a direction and/or magnitude (e.g., of distance) in which the placement location 432a is nudged in the shared three-dimensional environment 450 is based on the specific best-fit shape or spatial template that has been applied to the shared three-dimensional environment 450. For example, in FIG. 4V, the users 402/404/406 are optionally (e.g., physically) spatially arranged in and/or according to a surround spatial template in the shared three-dimensional environment 450, and/or a circle has been applied to the shared three-dimensional environment 450 based on the current spatial arrangement of the users 402/404/406 and/or based on the type of virtual object being displayed in the shared three-dimensional environment 450 (e.g., a horizontal virtual object is being displayed on the surface of the physical object 456 as similarly discussed above). In such an instance, the first electronic device 101a, the second electronic device 101b, and the third electronic device 101c may shift/move the placement location 432a angularly in the shared three-dimensional environment 450 along the circle that corresponds to the locations of the first user 402, the second user 404, and the third user 406 in the shared three-dimensional environment 450 to a location along the circle that is not occupied in the shared three-dimensional environment 450, such that the placement location 432a no longer overlaps with the location of the physical object 456 in the shared three-dimensional environment 450. For example, the first electronic device 101a, the second electronic device 101b, and the third electronic device 101c may angularly move the placement location 432a along the circle in FIG. 4V to the location in the shared three-dimensional environment 450 corresponding to the second placement location 432b in FIG. 4U.

In some examples, a direction and/or magnitude (e.g., of distance) in which the placement location 432a is nudged (e.g., shifted) in the shared three-dimensional environment 450 is based on the location of the virtual object that is being displayed in the shared three-dimensional environment 450. For example, in FIG. 4W, the second electronic device 101b and the third electronic device 101c are displaying virtual object 420 (e.g., a vertically oriented virtual object) in shared three-dimensional environment 450. Additionally, as indicated in the overhead view 410 in FIG. 4W, when a placement location (e.g., at location 432a-1) is identified in the shared three-dimensional environment 450, the second electronic device 101b and/or the third electronic device 101c determine that the placement location (e.g., at the location 432a-1) overlaps with and/or intersects a location of physical object 457 in the physical environment of the shared three-dimensional environment 450, rendering the placement location an invalid location for the display of a visual representation of a remote user in the shared three-dimensional environment 450 when adding the remote user to the multi-user communication session, as similarly discussed above. Accordingly, as discussed above, the second electronic device 101b and the third electronic device 101c apply the nudging approach to the placement location (e.g., at the location 432a-1) in FIG. 4W to attempt to identify an updated placement location that satisfies the display criteria for the visual representation of the remote user (e.g., such that the placement location does not intersect with any physical objects or other obstacles in the physical environment of the shared three-dimensional environment 450). For example, as illustrated in the overhead view 410 in FIG. 4W, the second electronic device 101b and/or the third electronic device 101c nudge the placement location to candidate location 431a in the shared three-dimensional environment 450 (e.g., by moving/shifting the placement location at the location 432a-1 along a line through the placement location and the virtual object 420 in direction 433a). However, as discussed below, the second electronic device 101b and/or the third electronic device 101c determine that the candidate location 431a does not correspond to a valid location for the display of a visual representation of a remote user in the shared three-dimensional environment 450.

Particularly, in FIG. 4W, though the candidate location 431a is not at least partially overlapping with the location of the physical object 457 in the shared three-dimensional environment 450, the candidate location 431a is determined to be an invalid location (e.g., as indicated by the “x”) for the display of the visual representation of the remote user in the shared three-dimensional environment 450 because the candidate location is too close to a location of the virtual object 420 in the shared three-dimensional environment 450. For example, in FIG. 4W, the candidate location 431a is within a threshold distance (e.g., 0.75, 1, 1.5, 2, 3, 5, etc. meters) of the location of the virtual object 420 in the shared three-dimensional environment 450, which would or can cause the resulting display of the visual representation of the remote user at the candidate location 431a to block, obscure, or otherwise interfere with a viewing experience of the second user 404 and/or the third user 406 within the multi-user communication session. Particularly, in the example of FIG. 4W, the display of the visual representation of the remote user at the candidate location 431a in the shared three-dimensional environment 450 may cause the content of the virtual object 420 to be at least partially blocked or obscured from the viewpoints of the second electronic device 101b and/or the third electronic device 101c in the shared three-dimensional environment 450. Accordingly, as illustrated in the overhead view 410 in FIG. 4W, the second electronic device 101b and/or the third electronic device 101c (e.g., alternatively) nudge the placement location at the location 432a-1 to candidate location 431b in the shared three-dimensional environment 450. For example, as illustrated in the overhead view 410 in FIG. 4W, the second electronic device 101b and/or the third electronic device 101c shift/move the placement location along a line through the location 432a-1 and the virtual object 420 in direction 433b that is away from the virtual object 420 in the shared three-dimensional environment 450. However, as discussed below, the second electronic device 101b and/or the third electronic device 101c determine that the candidate location 431b does not correspond to a valid location for the display of the visual representation of the remote user in the shared three-dimensional environment 450.

Particularly, in FIG. 4W, though the candidate location 431b is not at least partially overlapping with the location of the physical object 457 in the shared three-dimensional environment 450, the candidate location 431b is determined to be an invalid location (e.g., as indicated by the “x”) for the display of the visual representation of the remote user in the shared three-dimensional environment 450 because the candidate location would or may cause the visual representation of the remote user to be displayed behind the physical object 457 relative to the virtual object 420 in the shared three-dimensional environment 450. For example, displaying the visual representation of the remote user at the candidate location 431b in the shared three-dimensional environment 450, which is behind the physical object 457 relative to the virtual object 420, may cause a view of the content of the virtual object 420 to be partially blocked or obscured or otherwise distracted from by the physical object 457 from a viewpoint of the remote user that corresponds to the location of the visual representation of the remote user in the shared three-dimensional environment 450. Additionally or alternatively, in some examples, the candidate location 431b is more than a threshold distance (e.g., 5, 6, 8, 10, 12, 15, etc. meters) from the virtual object 420 in the shared three-dimensional environment 450, which renders the candidate location 431b an invalid location for the display of the visual representation of the remote user in the shared three-dimensional environment 450. For example, displaying the visual representation of the remote user at the candidate location 431b that is more than the threshold distance from the virtual object 420 in the shared three-dimensional environment 450 may limit or hinder the viewing experience of the content for the remote user (e.g., due to the size of the content being relatively small, and thus difficult to see, from the viewpoint of the remote user that corresponds to the location of the visual representation of the remote user in the shared three-dimensional environment 450).

In some examples, in accordance with the determination that neither of the candidate locations 431a/431b correspond to valid locations for the display of the visual representation of the remote user in the shared three-dimensional environment 450 as discussed above, the second electronic device 101b and/or the third electronic device 101c update the placement location to placement location 432a illustrated in the overhead view 410 in FIG. 4W. For example, as similarly discussed above, the second electronic device 101b and/or the third electronic device 101c shift/move the placement location along the curve or arc corresponding to the locations of the second electronic device 101b and the third electronic device 101c in the physical environment of the shared three-dimensional environment 450 relative to the virtual object 420. Particularly, as previously described herein, the second electronic device 101b and/or the third electronic device 101c apply an arc or curve (e.g., similar to the curve 440 described above) to the shared three-dimensional environment 450 (optionally in accordance with the type of virtual object that is displayed in the shared three-dimensional environment 450 (e.g., virtual object 420 is a vertically oriented virtual object as discussed above)) when adding the remote user to the multi-user communication session, where the arc is based on (e.g., is aligned to) the physical locations of the second user 404 and the third user 406. Thus, as illustrated in the overhead view 410 in FIG. 4W, the placement location 432a corresponds to a location along the curve in the shared three-dimensional environment 450. Additionally, in some examples, as shown in FIG. 4W, the placement location 432a is a valid location (e.g., as indicated by the checkmark) for the display of the visual representation of the remote user in the shared three-dimensional environment 450 because the placement location 432a satisfies the display criteria outlined above (e.g., the placement location 432a does not overlap with locations of physical objects or other obstacles in the shared three-dimensional environment 450, the placement location 432a is more than a threshold distance (e.g., a maximum distance) from the virtual object 420 and is not in a line of sight of the third user 406 or the second user 404, and/or the placement location 432a is not behind any physical objects or other obstacles relative to the virtual object 420 in the shared three-dimensional environment 450). Accordingly, when adding the remote user to the multi-user communication session, the second electronic device 101b and the third electronic device 101c optionally display the visual representation of the remote user (e.g., an avatar) at a location in the shared three-dimensional environment 450 corresponding to the placement location 432a, as previously discussed herein.

It is noted that, in the example described above with reference to FIG. 4W, the placement location 432a illustrated in the overhead view 410 is optionally not identified as a placement location for the visual representation of the remote user when the placement location at the location 432a-1 is identified. Rather, the placement location 432a illustrated in the overhead view 410 in FIG. 4W is optionally identified/created after the placement location at the location 432a-1 is determined to be an invalid location for the display of the visual representation of the remote user and after the candidate locations 431a/431b are determined to also be invalid locations for the display of the visual representation of the remote user in the shared three-dimensional environment 450 (e.g., after the nudging of the placement location at the location 432a-1) as discussed above.

Accordingly, as outlined above, providing systems and methods for displaying virtual objects (e.g., avatars and/or virtual content) in a shared three-dimensional environment while in a multi-user communication session advantageously enables collocated and non-collocated users to participate in the multi-user communication session and experience synchronized interaction with content and other users, thereby improving user-device interaction. Additionally, automatically determining location(s) at which to display the virtual objects (e.g., avatars and/or virtual content) in the shared three-dimensional environment reduces and/or helps avoid user input for manually selecting the location(s) in the shared three-dimensional environment, which helps conserve computing resources that would otherwise be consumed to respond to such user input, as another benefit. Further, automatically identifying and/or modifying locations at which to display avatars corresponding to non-collocated users in the shared three-dimensional environment based on a current spatial arrangement of the collocated users and physical properties of (e.g., locations of physical objects in) the physical environment of the collocated users helps preserve and/or maintain visibility of and/or interaction with content that is shared in the multi-user communication session, thereby optimizing and maintaining the user experience within the multi-user communication session. Attention is now directed toward additional examples of determining placement locations for avatars within a multi-user communication session that includes collocated and non-collocated users and electronic devices.

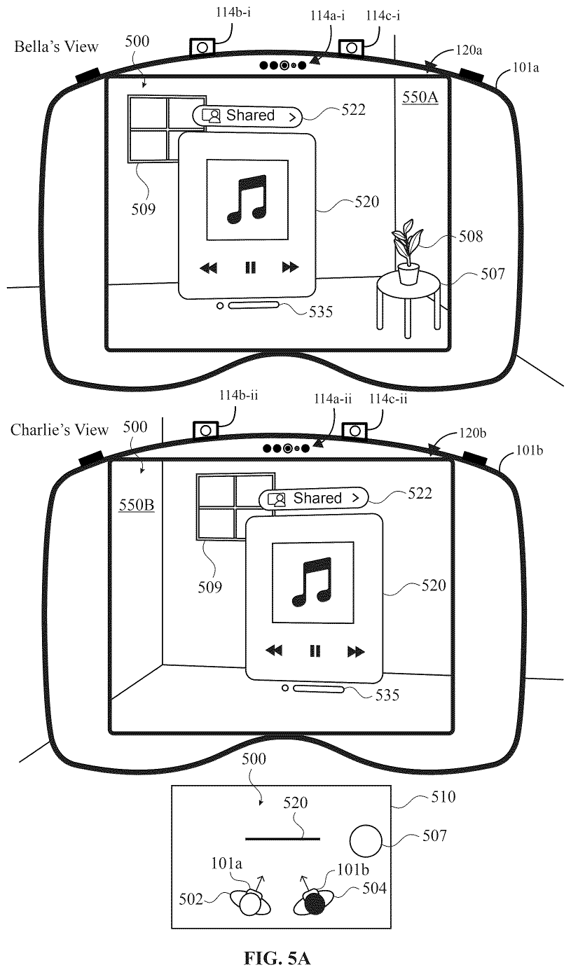

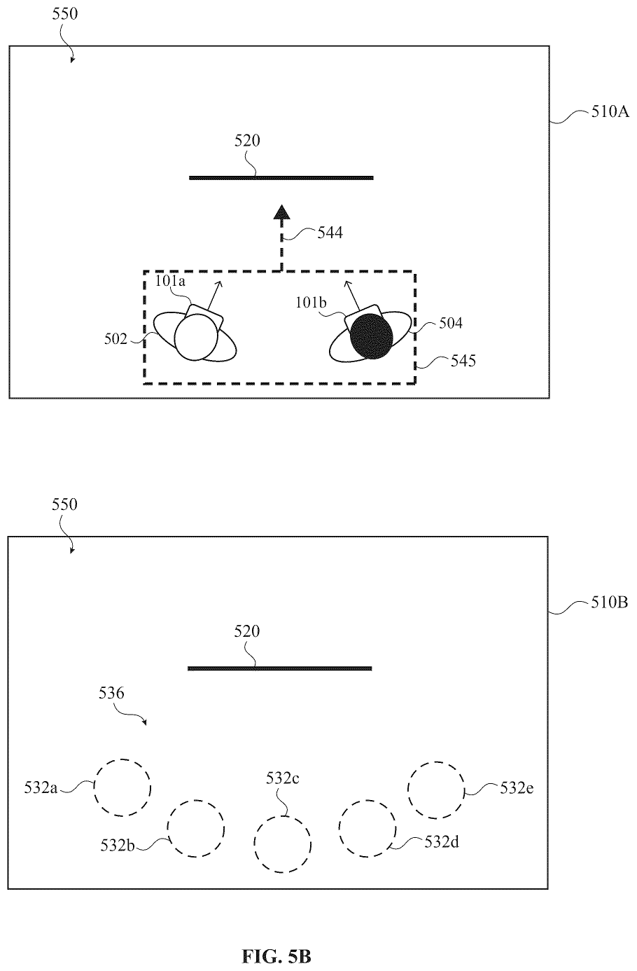

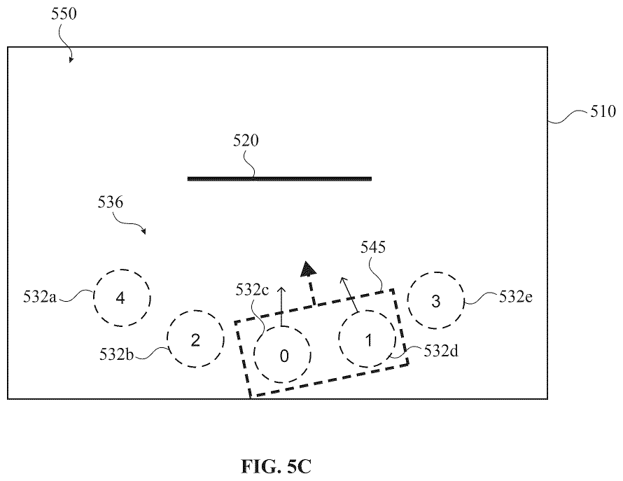

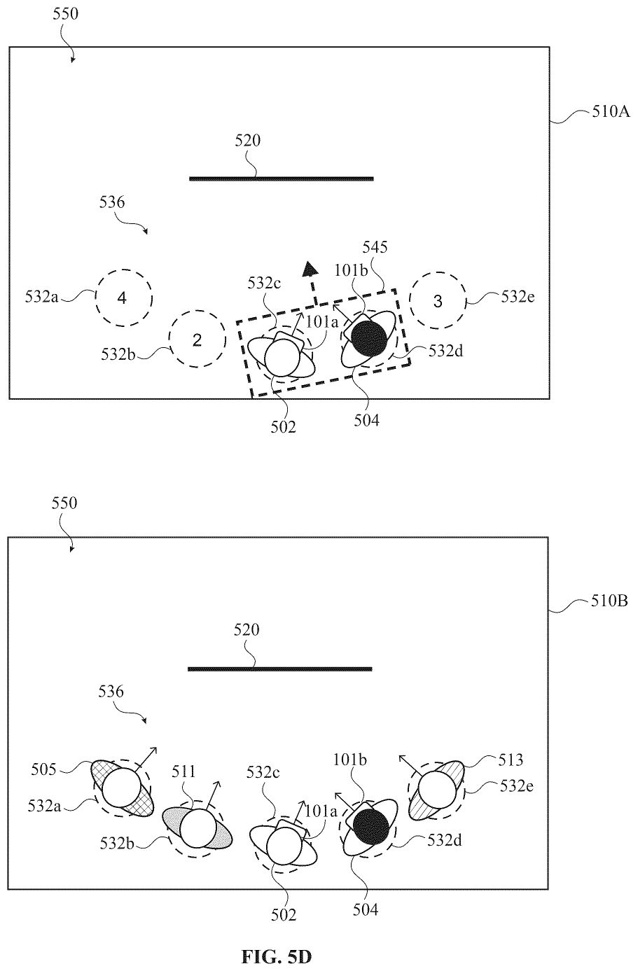

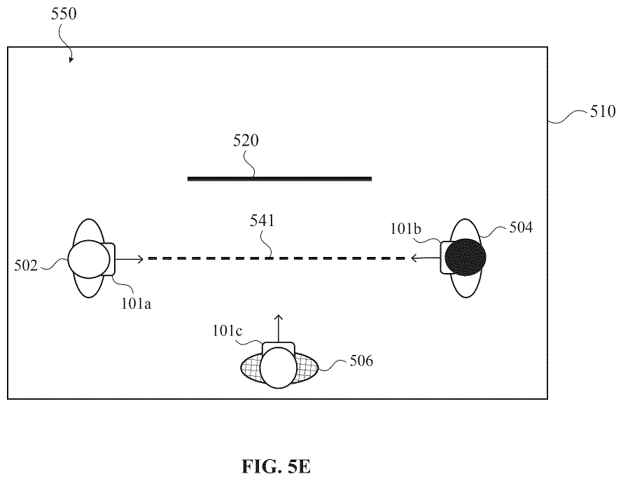

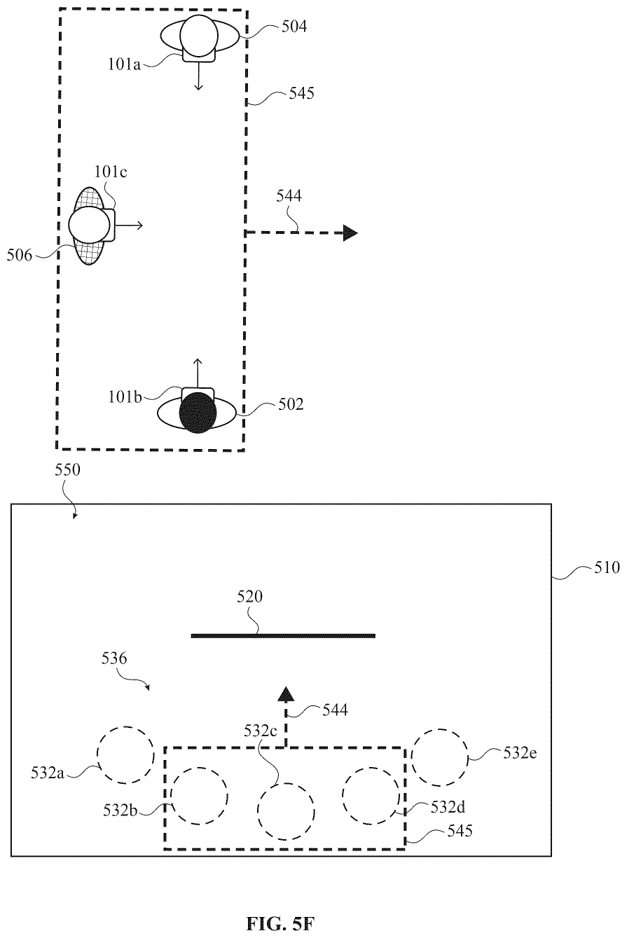

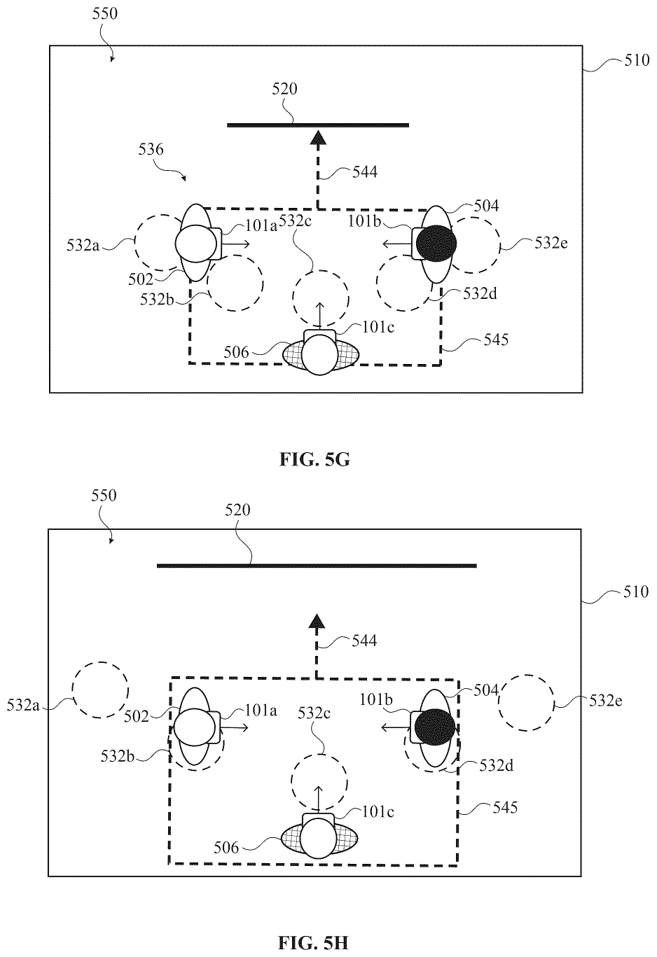

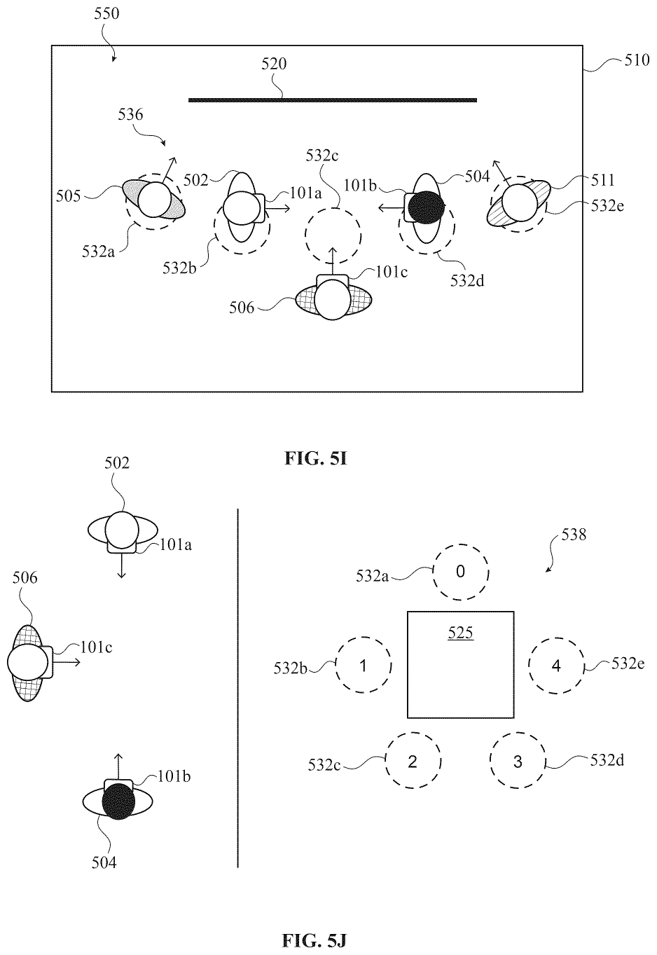

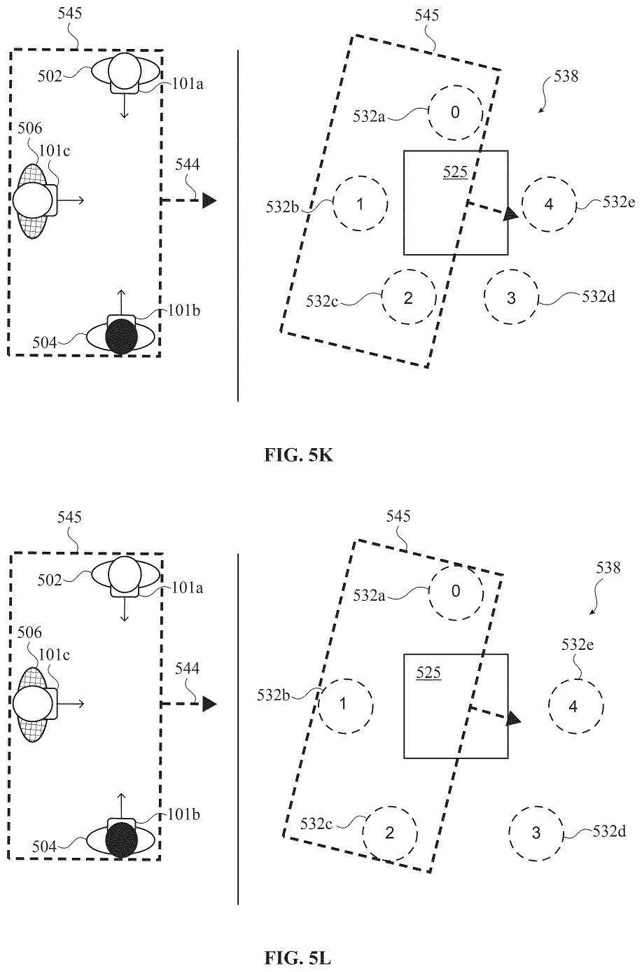

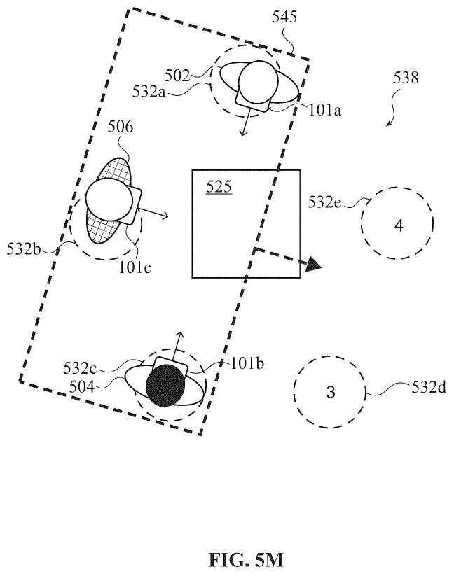

FIGS. 5A-5M illustrate examples of displaying one or more visual representations of non-collocated users in a three-dimensional environment within a multi-user communication session that includes collocated and non-collocated users according to some examples of the disclosure. In FIG. 5A, first electronic device 101a (e.g., associated with first user 502) and second electronic device 101b (e.g., associated with second user 504) are collocated in physical environment 500, as similarly discussed above, while engaging in a multi-user communication session. In some examples, the first user 502 and the second user 504 correspond to first user 402 and second user 404, respectively, of FIGS. 4A-4W. In some examples, the physical environment 500 has one or more characteristics of physical environment 400 discussed above.

As shown in FIG. 5A, the first electronic device 101a is presenting (e.g., via display 120a) three-dimensional environment 550A. In FIG. 5A, as similarly discussed above, the three-dimensional environment 550A includes representations (e.g., passthrough representations or computer-generated representations) of the physical environment 500 of the first electronic device 101a from the viewpoint of the first electronic device 101a. For example, as shown in overhead view 510 in FIG. 5A, the physical environment 500 corresponds to a room that includes window 509, stand 507 and a houseplant 508. Accordingly, as shown in FIG. 5A, the three-dimensional environment 550A presented using the first electronic device 101a includes representations of the window 509, the stand 507 and the houseplant 508 (e.g., the window 509, the stand 507, and the houseplant 508 are visible in a field of view of the first electronic device 101a). Additionally, as shown in FIG. 5A, the second electronic device 101b is presenting (e.g., via display 120b) three-dimensional environment 550B. In FIG. 5A, as similarly discussed above, the three-dimensional environment 550B includes representations (e.g., passthrough representations or computer-generated representations) of the physical environment 500 of the second electronic device 101b from the viewpoint of the second electronic device 101b. For example, as shown in FIG. 5A, the three-dimensional environment 550B presented using the second electronic device 101b includes a representation of the window 509 (e.g., the window 509 is visible in a field of view of the second electronic device 101b). In some examples, the three-dimensional environment 550A/550B has one or more characteristics of three-dimensional environment 450A/450B discussed above.

Additionally, in some examples, as shown in FIG. 5A, the three-dimensional environment 550A/550B includes virtual object 520. In some examples, as similarly discussed herein, the virtual object 520 corresponds to a shared virtual object in the multi-user communication session that includes the first electronic device 101a and the second electronic device 101b. In some examples, the virtual object 520 corresponds to virtual object 420 described above. For example, as previously discussed above, the virtual object 520 corresponds to and/or includes a music or other media player user interface. Additionally, as shown in FIG. 5A, the virtual object 520 is optionally displayed with pill 522 (e.g., indicating that the virtual object 520 is shared in the multi-user communication session) and grabber bar 535 (e.g., which is selectable to initiate movement of the virtual object 520 in the three-dimensional environment 550A/550B).

In the example of FIG. 5A, the first electronic device 101a and/or the second electronic device 101b have received an indication/input corresponding to a request to enter a multi-user communication session with a remote user (e.g., a third user of a third electronic device that is non-collocated with the first electronic device 101a and the second electronic device 101b in the physical environment 500). In some examples, the indication/input has one or more characteristics of the indications/inputs discussed above with reference to FIGS. 4A-4W.

In some examples, as previously discussed herein, when the first electronic device 101a and/or the second electronic device 101b receive the indication of the request to enter the multi-user communication session with the third electronic device (e.g., the remote user), the first electronic device 101a and the second electronic device 101b communicate and/or coordinate to identify a placement location for a visual representation of the remote user in the shared three-dimensional environment between the first electronic device 101a and the second electronic device 101b. In some examples, as illustrated in overhead view 510A in FIG. 5B, identifying the placement location for the visual representation of the remote user in the shared three-dimensional environment 550 includes grouping the local users (e.g., the first user 502 and the second user 504) into a first spatial group within the multi-user communication session, which includes defining a bounding box 545 (e.g., an axis aligned bounding box) in the shared three-dimensional environment 550 that is based on the physical locations of the first electronic device 101a and the second electronic device 101b in the physical environment 500. For example, as illustrated in the overhead view 510A in FIG. 5B, the bounding box 545 surrounds and/or encapsulates the location of the first user 502 and the location of the second user 504 in the shared three-dimensional environment 550. Additionally, in some examples, when the bounding box 545 is defined in the shared three-dimensional environment 550, the first electronic device 101a and the second electronic device 101b analyze/identify orientations of the first electronic device 101a and the second electronic device 101b in the physical environment 500. For example, the orientation of the first electronic device 101a defines a forward direction of the first electronic device 101a (e.g., a forward head direction of the first user 502) and the orientation of the second electronic device 101b defines a forward direction of the second electronic device 101b (e.g., a forward head direction of the second user 504). In FIG. 5B, as an example, the forward direction of the first electronic device 101a and the forward direction of the second electronic device 101b are indicated by the arrows extending from the first electronic device 101a and the second electronic device 101b, respectively, in the overhead view 510A. In some examples, the first electronic device 101a and the second electronic device 101b utilize the forward directions of the electronic devices 101a and 101b to determine an average forward direction of the electronic devices 101a and 101b in the physical environment 500 (e.g., an average forward head direction of the users 502 and 504). For example, as indicated in the overhead view 510A in FIG. 5B, the first electronic device 101a and the second electronic device 101b determine average forward direction 544 in the physical environment 500 based on averaging the individual forward directions of the first electronic device 101a and the second electronic device 101b. In some examples, as illustrated in the overhead view 510A in FIG. 5B, the axis to which the bounding box 545 is aligned corresponds to the average forward direction 544.

In some examples, as illustrated in the overhead view 510B in FIG. 5B, identifying a placement location for the visual representation of the remote user (e.g., the third user of the third electronic device) in the shared three-dimensional environment 550 further includes associating a spatial template with the multi-user communication session. As defined herein, a spatial template includes a plurality or number of seats (e.g., predefined seats) which participants in the multi-user communication session can occupy and/or are assigned to within the shared three-dimensional environment 550. In some examples, a spatial template is determined and/or selected based on the virtual content that is shared and displayed in the shared three-dimensional environment 550. For example, the first electronic device 101a (e.g., and the second electronic device 101b) define the spatial template for the spatial group based on the orientation of the virtual object 520 in the shared three-dimensional environment 550, such as the virtual object 520 being a vertically oriented virtual object (e.g., a virtual object of the first type). In some examples, as shown in the overhead view 510B in FIG. 5B, spatial template 536 includes a plurality of seats 532a-532e defined relative to the location of the virtual object 520 in the shared three-dimensional environment 550. For example, as shown in FIG. 5B, the plurality of seats 532a-532e form and/or are arranged along an arc/curve that is centered on (e.g., oriented towards) the location of the virtual object 520 in the shared three-dimensional environment 550.

In some examples, following the association of the spatial template 536 with the multi-user communication session, the first electronic device 101a and/or the second electronic device 101b align the bounding box 545 in the overhead view 510A with a subset of the plurality of seats 532a-532e of the spatial template 536 in the overhead view 510B. For example, as illustrated in the overhead view 510 in FIG. 5C, the bounding box 545 is aligned with seat 532c and seat 532d within the spatial template 536 in the shared three-dimensional environment 550. In some examples, as mentioned previously above, the bounding box 545 is defined based on the physical locations of the first user 502 and the second user 504 in the physical environment 500; accordingly, when the bounding box 545 is aligned with the subset of the plurality of seats 532a-532e of the spatial template 536, the bounding box 545 includes and/or encapsulates two seats of the plurality of seats 532a-532e (e.g., corresponding to the two local users associated with the bounding box 545). In some examples, the specific seats (e.g., seats 532c/532d) within the spatial template 536 that are selected for alignment with the bounding box 545 are selected automatically (e.g., and/or arbitrarily) by the first electronic device 101a and/or the second electronic device 101b. In some examples, the specific seats within the spatial template 536 that are selected for alignment with the bounding box 545 are selected based on the current locations of the first user 502 and the second user 504 relative to the virtual object 520 in the shared three-dimensional environment 550. For example, as previously illustrated in the overhead view 510A in FIG. 5B, the first user 502 and the second user 504 are positioned adjacent to each other in the physical environment and are oriented to face toward a front-facing surface of the virtual object 520 in the shared three-dimensional environment 550. With reference to the plurality of seats 532a-532e in the spatial template 536 in the shared three-dimensional environment 550 in the overhead view 510B in FIG. 5B, the seats 532c/532d are positioned adjacent to one another and are (e.g., substantially) oriented to face toward the front-facing surface of the virtual object 520 in the shared three-dimensional environment 550 (e.g., based on the average forward direction 544 discussed above). Accordingly, as mentioned above and as illustrated in the overhead view 510 in FIG. 5C, the bounding box 545 is aligned with the seats 532c/532d of the spatial template 536 in the shared three-dimensional environment 550, such that the number of seats within the spatial template 536 that is aligned with the bounding box 545 corresponds to the number of users associated with the bounding box 545.

In some examples, aligning the bounding box 545 with the subset of the plurality of seats 532a-532e in the shared three-dimensional environment 550 is performed according to a physics-based alignment model. For example, the first electronic device 101a and the second electronic device 101b simulate the alignment of the location of the first user 502 with the seat 532c and the location of the second user 504 with the seat 532d in the shared three-dimensional environment 550 via a physics simulation, such as a magnet-based physics model, a spring-based physics model, or other physics model that simulates an “attraction” of (e.g., movement of) the first user 502 and the second user 504 to the seat 532c and the seat 532d, respectively.

In some examples, as illustrated in the overhead view 510A in FIG. 5D, when the bounding box 545 is aligned with the seats 532c/532d of the spatial template 536 in the shared three-dimensional environment 550, the first user 502 (e.g., and the first electronic device 101a) becomes associated with the seat 532c and the second user 504 (e.g., and the second electronic device 101b) becomes associated with the seat 532d in the spatial template 536. For example, as shown in the overhead view 510A in FIG. 5D, the first user 502 occupies the seat 532c within the spatial template 536 and the second user 504 occupies the adjacent seat 532d within the spatial template 536 following the alignment of the bounding box 545 with the subset of the plurality of seats 532a-532e of the spatial template 536. As illustrated in the overhead view 510A in FIG. 5D, the physical locations and/or orientations of the first user 502 and the second user 504 are not updated and/or changed relative to each other (e.g., because the first user 502 and the second user 504 have not physically moved within the physical environment 500) when the first user 502 and the second user 504 are associated with the seats 532c/532d, respectively. In some examples, however, the association of the first user 502 with the seat 532c and the second user 504 with the second seat 532d does cause the display of the virtual object 520 to be updated in the shared three-dimensional environment 550 relative to the viewpoints of the first electronic device 101a and the second electronic device 101b. For example, compared to the location of the virtual object 520 in the overhead view 510A in FIG. 5B, the association of the first user 502 with the seat 532c and the second user 504 with the seat 532d causes the virtual object 520 to be shifted leftward and slightly reoriented relative to the viewpoints of the first electronic device 101a and the second electronic device 101b in the shared three-dimensional environment 550 (e.g., due to the spatial arrangement of the plurality of seats 532a-532e relative to the virtual object 520).

In some examples, as indicated in the overhead view 510A in FIG. 5D, one or more placement locations for the display of the visual representation of the remote user discussed above are determined based on the available seats within the spatial template 536. For example, as discussed above, in the overhead view 510A in FIG. 5D, the seat 532c is occupied by the first user 502 and the seat 532d is occupied by the second user 504 following the alignment of the bounding box 545 with the spatial template 536; accordingly, the unoccupied/available seats within the spatial template 536 include seat 532a, seat 532b and seat 532e, which correspond to locations in the shared three-dimensional environment 550 that are available for display of the visual representation of the remote user. In some examples, as illustrated in the overhead view 510B in FIG. 5D, once the one or more placement locations are identified in the shared three-dimensional environment 550 according to the spatial template 536, the first electronic device 101a and the second electronic device 101b display a visual representation of the remote user (e.g., the third user of the third electronic device) at one of the placement locations in the shared three-dimensional environment 550. For example, as shown in the overhead view 510B in FIG. 5D, avatar 505 corresponding to the third user of the third electronic device is displayed at a location in the shared three-dimensional environment 550 corresponding to the seat 532a within the spatial template 536. Additionally, in some examples, as and/or if additional remote users join and/or are added to the multi-user communication session, visual representations of the additional remote users are displayed and/or positioned at the other placement locations identified/determined in the shared three-dimensional environment 550. For example, as shown in the overhead view 510B in FIG. 5D, avatar 511 corresponding to a fourth user of a fourth electronic device (e.g., which is non-collocated with the first electronic device 101a and the second electronic device 101b in the physical environment 500 discussed above) is displayed at a location corresponding to the seat 532b and avatar 513 corresponding to a fifth user of a fifth electronic device (e.g., which is non-collocated with the first electronic device 101a and the second electronic device 101b in the physical environment 500) is displayed at a location corresponding to the seat 532e in the shared three-dimensional environment 550. Additionally, in some examples, as indicated in the overhead view 510B in FIG. 5D, when the avatar 505 (e.g., and subsequently the avatars 511/513) is displayed in the shared three-dimensional environment 550, the avatar 505 is displayed with an orientation that faces toward the virtual object 520, as indicated by the arrow extending from the avatar 505.

It should be understood that, during the above-described process of identifying the placement location for the remote user when adding the remote user to the multi-user communication session, the spatial template 536 and the bounding box 545 are not virtual elements that are actively displayed and viewable in the shared three-dimensional environment 550.

In some examples, when a bounding box that is defined based on the locations of the local users in a multi-user communication session is aligned with a plurality of seats within a spatial template associated with the multi-user communication session, an alignment between the bounding box and the plurality of seats exceeds an alignment threshold in the shared three-dimensional environment. In some such examples, the spatial template may be modified to enable the bounding box to align with the plurality of seats within the alignment threshold, as described in more detail below.

FIG. 5E illustrates an example of a multi-user communication session that includes three local users. For example, as illustrated in the overhead view 510 in FIG. 5E, a first electronic device 101a (e.g., associated with first user 502), a second electronic device 101b (e.g., associated with second user 504), and a third electronic device 101c (e.g., associated with third user 506) are collocated in a same physical environment (e.g., physical environment 500 discussed above with reference to FIG. 5A). In some examples, while the first user 502, the second user 504, and the third user 506 are in the multi-user communication session, a shared three-dimensional environment 550 among the first electronic device 101a, the second electronic device 101b, and the third electronic device 101c includes virtual object 520 (e.g., corresponding to the virtual object 520 discussed above).

In some examples, as illustrated in the overhead view 510 in FIG. 5E, the first user 502, the second user 504, and the third user 506 share a respective spatial arrangement relative to the virtual object 520 in the shared three-dimensional environment 550. For example, the first user 502 (e.g., and the first electronic device 101a) is located a first distance 541 from the second user 504 (e.g., and the second electronic device 101b), and the third user 506 (e.g., and the third electronic device 101c) is equidistant from the first user 502 and the second user 504, as shown in the overhead view 510 in FIG. 5E. In FIG. 5E, the electronic devices 101a/101b/101c detect an indication of a request to add a remote user (e.g., a fourth user of a fourth electronic device) to the multi-user communication session, such as similar to the indications discussed previously herein.

In some examples, as shown in FIG. 5F and as similarly discussed above, in response to detecting the indication, the electronic devices 101a/101b/101c initiate a process to identify a placement location for a visual representation of the remote user in the shared three-dimensional environment 550. Particularly, in some examples, as previously discussed above, a bounding box 545 is defined based on the physical locations of the local users in the physical environment. For example, as indicated in FIG. 5F, the bounding box 545 surrounds/encapsulates the locations of the first user 502, the second user 504, and the third user 506. Additionally, as similarly discussed above, in some examples, the electronic devices 101a/101b/101c determine an average forward direction 544 of the electronic devices 101a/101b/101c. For example, in FIG. 5F, the average forward direction 544 is determined by averaging the individual forward directions of the electronic devices 101a/101b/101c, which correspond to the orientations of the users 502/504/506, as indicated by the arrows extending from each of the users 502/504/506.

Additionally, in some examples, as similarly described above, a spatial template 536 is associated with the multi-user communication session relative to the virtual object 520 in the shared three-dimensional environment 550. In some examples, as illustrated in the overhead view 510 in FIG. 5F, because the virtual object 520 is a vertically oriented virtual object, the spatial template 536 includes a plurality of seats 532a-532e that are arranged in an arc relative to the virtual object 520 in the shared three-dimensional environment 550, as similarly discussed above. In some examples, as illustrated in the overhead view 510 in FIG. 5G, the bounding box 545 is aligned to a subset of the plurality of seats 532a-532e in the spatial template 536 to identify available (e.g., unoccupied) seats within the spatial template 536 at which to display a visual representation of the remote user that is joining the multi-user communication session. However, as illustrated in the overhead view 510 in FIG. 5G, when the bounding box 545 is aligned with three seats of the plurality of seats 532a-532e (e.g., corresponding to the three local users associated with the bounding box 545), the alignment between the bounding box 545 and the seats in the spatial template 536 exceeds a threshold alignment. In some examples, the threshold alignment is based on a distance between a respective local user and their corresponding assigned seat (e.g., closest seat) within the spatial template 536. For example, in the overhead view 510 in FIG. 5G, the location of the first user 502 in the shared three-dimensional environment 550 is more than a threshold distance (e.g., 0.5, 1, 2, 3, 5, 10, 15, 20, etc. meters) from seat 532b, the location of the second user 504 is more than the threshold distance from seat 532d, and/or the location of the third user 506 is more than the threshold distance from seat 532c in the spatial template 536 when the bounding box 545 is aligned to the seats within the spatial template 536.

Accordingly, in some examples, in accordance with the determination that the alignment between the bounding box 545 and the seats in the spatial template 536 exceeds the threshold alignment, the electronic devices 101a/101b/101c modify the existing spatial template 536 to accommodate the current spatial arrangement of the first user 502, the second user 504, and the third user 506 relative to the virtual object 520 in the shared three-dimensional environment 550. For example, as shown in the overhead view 510 in FIG. 5H, the spatial template 536 is rescaled (e.g., increased in size) to enable the first user 502 to be within the threshold distance of the seat 532b, the second user 504 to be within the threshold distance of the seat 532d, and/or the third user 506 to be within the threshold distance of the seat 532c in the shared three-dimensional environment 550. In some examples, as illustrated in the overhead view 510 in FIG. 5H, modifying the spatial template 536 includes changing a distance (e.g., increasing the distance) between adjacent seats within the spatial template 536, optionally by a same amount. Additionally, in some examples, modifying the spatial template 536 includes changing a size of the virtual object 520 in the shared three-dimensional environment 550. For example, as illustrated in the overhead view 510 in FIG. 5H, the size (e.g., width) of the virtual object 520 is increased in the shared three-dimensional environment 550, optionally by an amount corresponding to and/or proportional to the increase in distance between adjacent seats of the spatial template 536.

In some examples, as illustrated in the overhead view 510 in FIG. 5H, once the spatial template 536 is modified to enable the alignment between the bounding box 545 that includes the first user 502, the second user 504, and the third user 506 to be within the threshold alignment of the seats 532b-532d, the electronic devices 101a/101b/101c identify one or more placement locations for the visual representation of the remote user in the shared three-dimensional environment 550. For example, as previously discussed herein, the one or more placement locations in the shared three-dimensional environment correspond to unoccupied seats within the spatial template 536, namely seat 532a and seat 532e in the overhead view 510 in FIG. 5H. Then, as similarly discussed herein, the electronic devices 101a/101b/101c optionally display the visual representation of the remote user at one of the identified placement locations in the shared three-dimensional environment 550. For example, as shown in the overhead view 510 in FIG. 5I, avatar 505 corresponding to the fourth user of the fourth electronic device is displayed at a location in the shared three-dimensional environment 550 corresponding to the seat 532a in the spatial template 536. Similarly, if an additional remote user (e.g., a fifth user of a fifth electronic device) joins the multi-user communication session, a visual representation of the additional remote user is positioned at the next unoccupied seat within the spatial template 536. For example, as shown in the overhead view 510 in FIG. 5I, avatar 511 is presented at a location in the shared three-dimensional environment 550 that corresponds to the seat 532e in the spatial template 536. As shown in the overhead view 510 in FIG. 5I, the avatars 505/511 are positioned in the shared three-dimensional environment 550 to face toward the virtual object 520, without changing the orientation of the first user 502, the second user 504, or the third user 506 relative to the virtual object 520 (e.g., because the orientations of the first user 502, the second user 504, and the third user 506 are determined based on physical movement of the users in the physical environment).

FIGS. 5J-5M illustrate an alternative example of identifying a placement location for a visual representation of a remote user in a multi-user communication session that includes local users while a horizontally oriented virtual object is shared in the multi-user communication session. In FIG. 5J, a first electronic device 101a (e.g., associated with first user 502), a second electronic device 101b (e.g., associated with second user 504), and a third electronic device 101c (e.g., associated with third user 506) are collocated in a same physical environment (e.g., physical environment 500 discussed above with reference to FIG. 5A). In some examples, while the first user 502, the second user 504, and the third user 506 are in the multi-user communication session, a shared three-dimensional environment among the first electronic device 101a, the second electronic device 101b, and the third electronic device 101c includes virtual object 525 (e.g., corresponding to the virtual object 425 discussed above). For example, the virtual object 525 corresponds to a virtual board game, a virtual model, or other virtual object having a top (e.g., flat) surface.

In some examples, as illustrated in the overhead view 510 in FIG. 5J, the first user 502, the second user 504, and the third user 506 share a respective spatial arrangement relative to the virtual object 525 in the shared three-dimensional environment 550. For example, the first user 502 (e.g., and the first electronic device 101a) is located a respective distance from the second user 504 (e.g., and the second electronic device 101b), and the third user 506 (e.g., and the third electronic device 101c) is equidistant from the first user 502 and the second user 504, as shown in FIG. 5J. In FIG. 5J, the electronic devices 101a/101b/101c detect an indication of a request to add a remote user (e.g., a fourth user of a fourth electronic device) to the multi-user communication session, such as similar to the indications discussed previously herein.

In some examples, as similarly described above, in response to detecting the indication, the electronic devices 101a/101b/101c initiate a process to identify a placement location for a visual representation of the remote user in the shared three-dimensional environment 550. Particularly, in some examples, the electronic devices 101a/101b/101c associate a spatial template 538 with the multi-user communication session relative to the virtual object 525 in the shared three-dimensional environment. In some examples, as previously described herein, the spatial template 538 is determined and/or selected based on a virtual object type of the virtual object 525. For example, in FIG. 5J, the virtual object 525 is a virtual object of the second type as previously discussed herein (e.g., a horizontally oriented virtual object). In some examples, as illustrated in FIG. 5J, because the virtual object 525 is a horizontally oriented virtual object, the spatial template 538 includes a plurality of seats 532a-532e that is arranged in and/or form a circle relative to (e.g., centered on) the virtual object 525 in the shared three-dimensional environment. In some examples, the spatial template 538 is different from the spatial template 536 discussed above.

Additionally, in some examples, as shown in FIG. 5K and as similarly discussed above, in response to detecting the indication, the electronic devices 101a/101b/101c define a bounding box 545 based on the physical locations of the local users in the physical environment. For example, as indicated in FIG. 5K, the bounding box 545 surrounds/encapsulates the locations of the first user 502, the second user 504, and the third user 506. Additionally, as similarly discussed above, in some examples, the electronic devices 101a/101b/101c determine an average forward direction 544 of the electronic devices 101a/101b/101c. For example, in FIG. 5K, the average forward direction 544 is determined by averaging the individual forward directions of the electronic devices 101a/101b/101c, which correspond to the orientations of the users 502/504/506, as indicated by the arrows extending from each of the users 502/504/506.

In some examples, as illustrated in FIG. 5K, the bounding box 545 is aligned to a subset of the plurality of seats 532a-532e in the spatial template 538 to identify available (e.g., unoccupied) seats within the spatial template 538 at which to display a visual representation of the remote user that is joining the multi-user communication session. However, as illustrated in FIG. 5K, when the bounding box 545 is aligned with three seats of the plurality of seats 532a-532e (e.g., corresponding to the three local users associated with the bounding box 545), the alignment between the bounding box 545 and the seats in the spatial template 538 exceeds a threshold alignment (e.g., the distance-based threshold described previously above). For example, in FIG. 5K, the alignment of the bounding box 545 with seat 532a, seat 532b and seat 532c of the spatial template 538 causes the location of the first user 502 to be more than a threshold distance (e.g., 0.5, 1, 2, 3, 5, 10, 15, 20, etc. meters) from the seat 532a, the location of the second user 504 to be more than the threshold distance from the seat 532c, and/or the location of the third user 506 to be more than the threshold distance from the seat 532b in the spatial template 538.

Accordingly, in some examples, as similarly described above, in accordance with the determination that the alignment between the bounding box 545 and the seats in the spatial template 538 exceeds the threshold alignment, the electronic devices 101a/101b/101c modify the existing spatial template 538 to accommodate the current spatial arrangement of the first user 502, the second user 504, and the third user 506 relative to the virtual object 525 in the shared three-dimensional environment. For example, as shown in FIG. 5L, the spatial template 538 is rescaled (e.g., increased in size) to enable the first user 502 to be within the threshold distance of the seat 532a, the second user 504 to be within the threshold distance of the seat 532c, and/or the third user 506 to be within the threshold distance of the seat 532b in the shared three-dimensional environment, as illustrated in FIG. 5M. In some examples, as illustrated in FIG. 5L and as similarly described above, modifying the spatial template 538 includes changing a distance (e.g., increasing the distance) between adjacent seats within the spatial template 538, optionally by a same amount. Additionally, in some examples, modifying the spatial template 538 includes changing a distance (e.g., increasing the distance) between each of the plurality of seats 532a-532e in the spatial template 538 and the virtual object 525 in the shared three-dimensional environment, as shown in FIG. 5L. For example, as illustrated in FIG. 5L, the distance between each of the plurality of seats 532a-532e and a portion (e.g., side, edge or corner) of the virtual object 525 is increased in the shared three-dimensional environment, optionally by an amount corresponding to and/or proportional to the increase in distance between adjacent seats of the spatial template 538.

In some examples, as illustrated in FIG. 5M, once the spatial template 538 is modified to enable the alignment between the bounding box 545 that includes the first user 502, the second user 504, and the third user 506 to be within the threshold alignment of the seats 532a-532c, the electronic devices 101a/101b/101c identify one or more placement locations for the visual representation of the remote user in the shared three-dimensional environment 550. For example, as previously discussed herein, the one or more placement locations in the shared three-dimensional environment correspond to unoccupied seats within the spatial template 538, namely seat 532d and seat 532e in FIG. 5M. Then, as similarly discussed herein, the electronic devices 101a/101b/101c optionally display the visual representation of the remote user at one of the identified placement locations in the shared three-dimensional environment 550. For example, in FIG. 5M, an avatar (not shown) corresponding to the fourth user of the fourth electronic device may be displayed at a location in the shared three-dimensional environment corresponding to the seat 532d in the spatial template 538 or at a location in the shared three-dimensional environment corresponding to the seat 532e in the spatial template 538. Further, if an additional remote user (e.g., a fifth user of a fifth electronic device) joins the multi-user communication session, as similarly discussed herein, a visual representation of the additional remote user is positioned at the next unoccupied seat within the spatial template 538. As shown in FIG. 5M, alignment of the bounding box 545 with the modified spatial template 538 enables the existing orientations of the first user 502, the second user 504, and the third user 506 to be directed toward a portion of the virtual object 525 in the shared three-dimensional environment (e.g., based on the average forward direction 544 discussed previously above), and optionally without requiring the first user 502, the second user 504, and/or the third user 506 to reorient and/or reposition themselves in the physical environment, as one benefit. Additionally, automatically determining location(s) at which to display the virtual objects (e.g., avatars and/or virtual content) in the shared three-dimensional environment reduces and/or helps avoid user input for manually selecting the location(s) in the shared three-dimensional environment, which helps conserve computing resources that would otherwise be consumed to respond to such user input, as another benefit.

Attention is now directed toward examples of determining placement locations for avatars within a multi-user communication session that includes collocated and non-collocated users and electronic devices and in which virtual content has not been shared between the collocated users in the multi-user communication session.

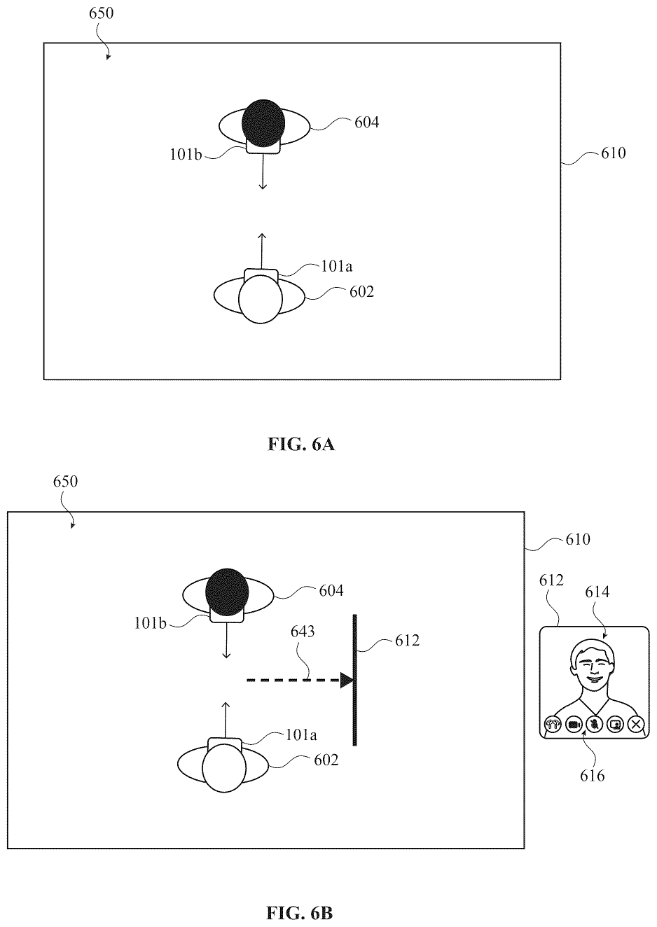

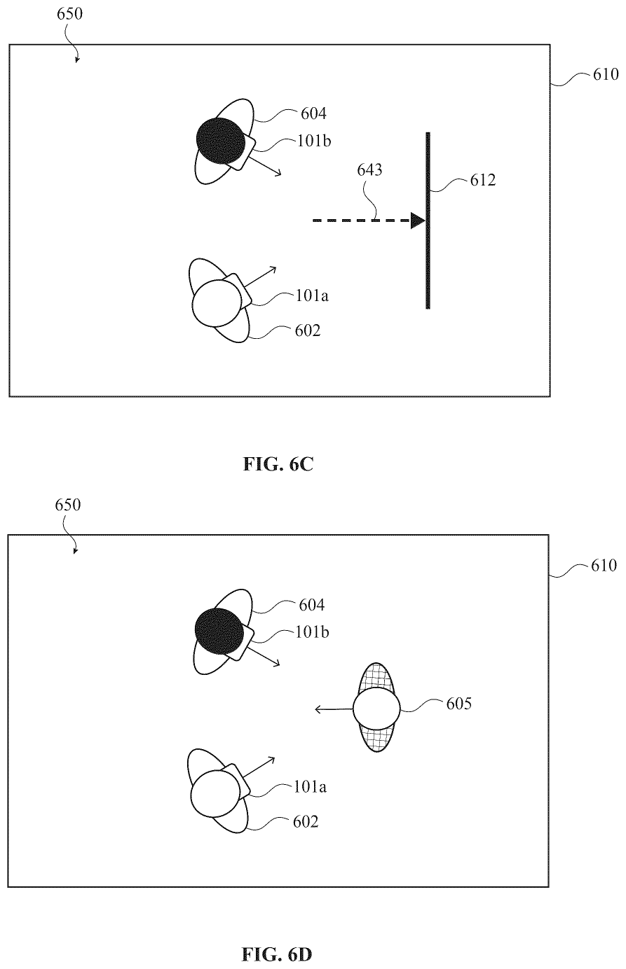

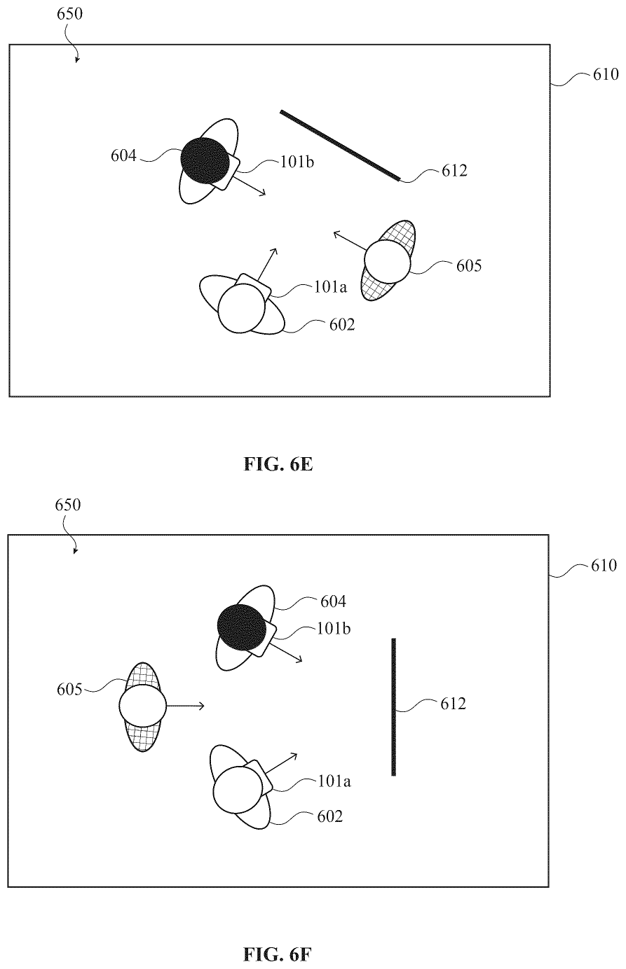

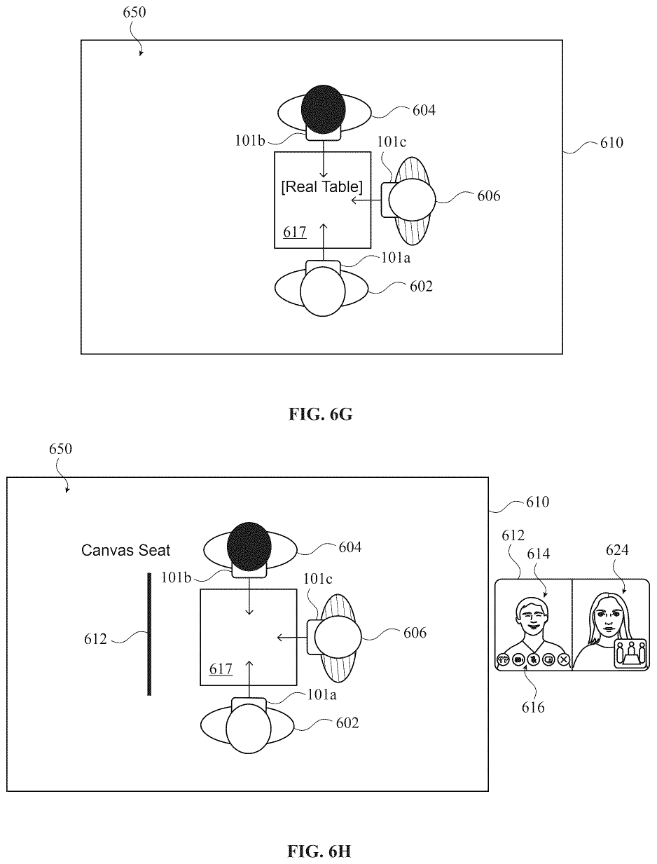

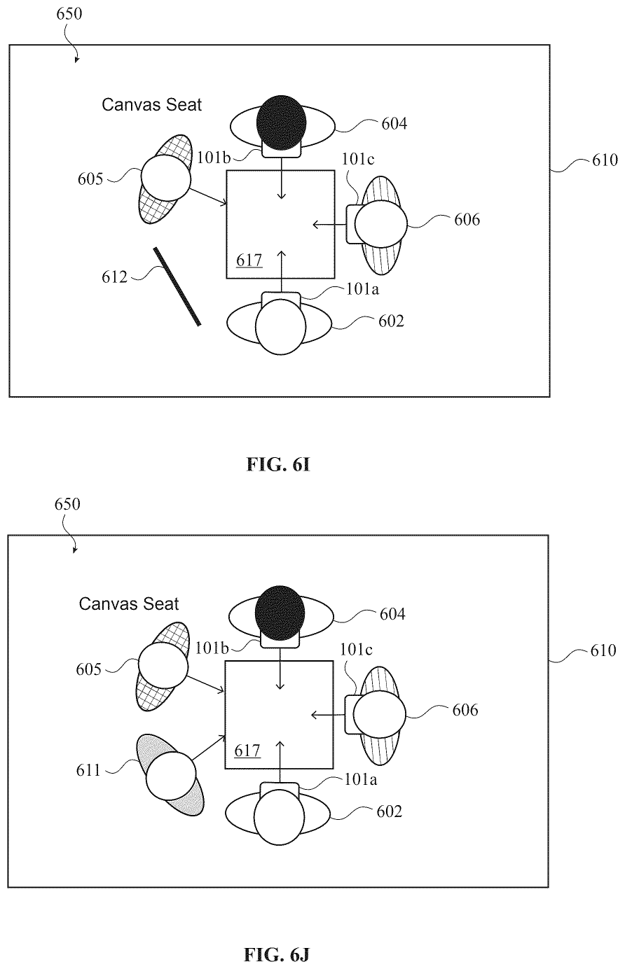

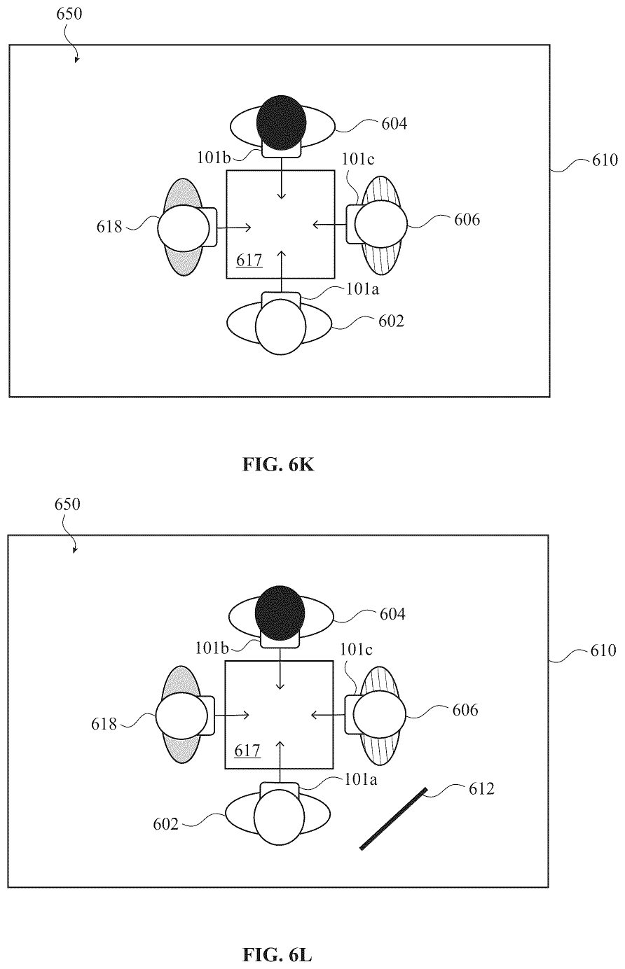

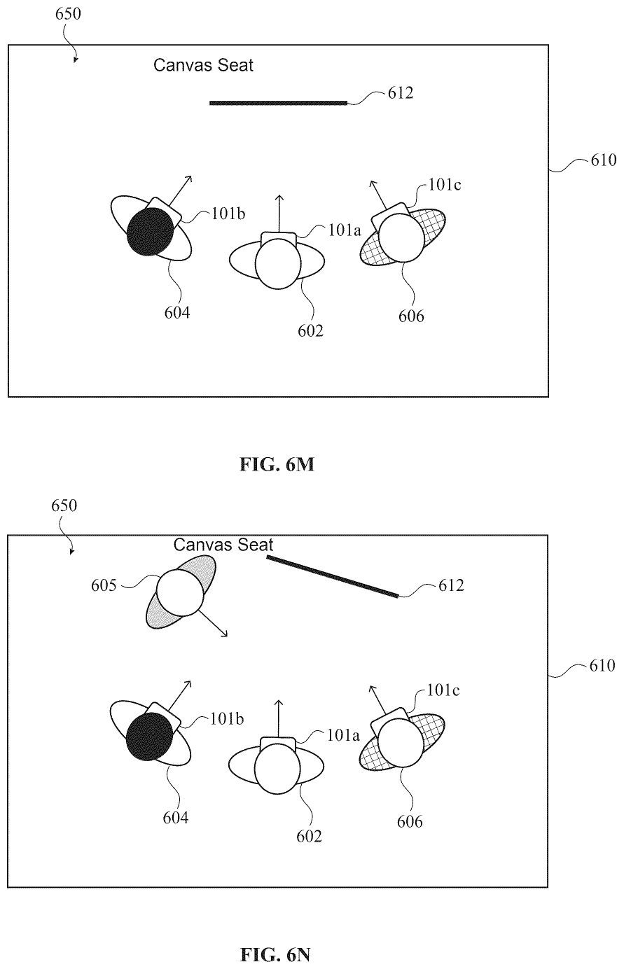

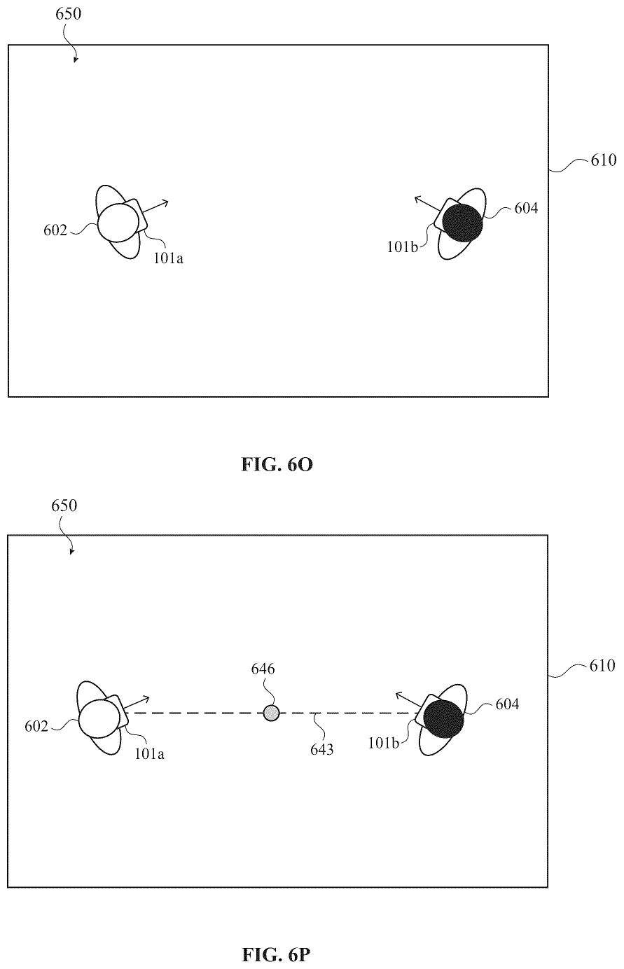

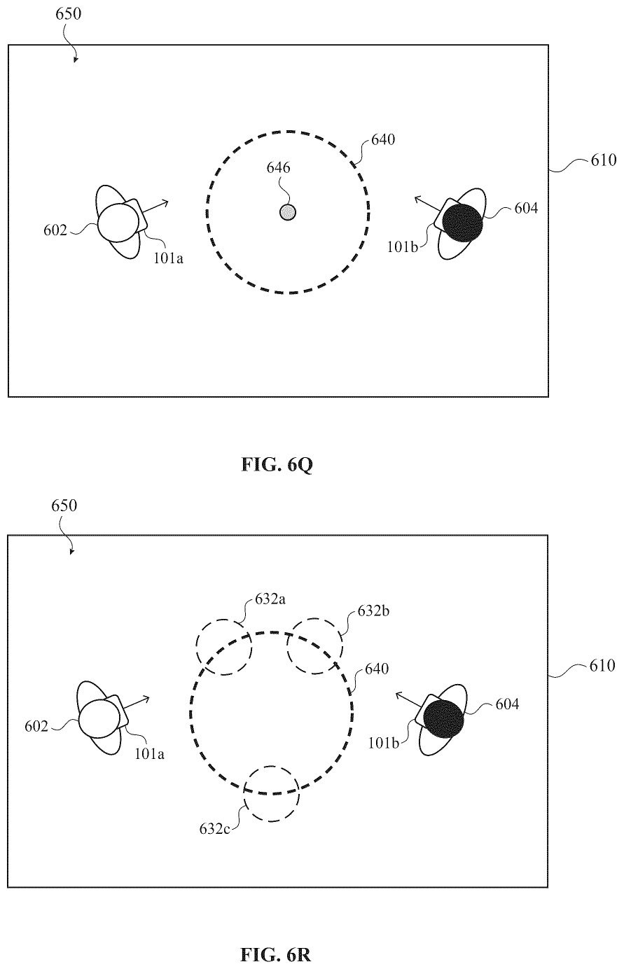

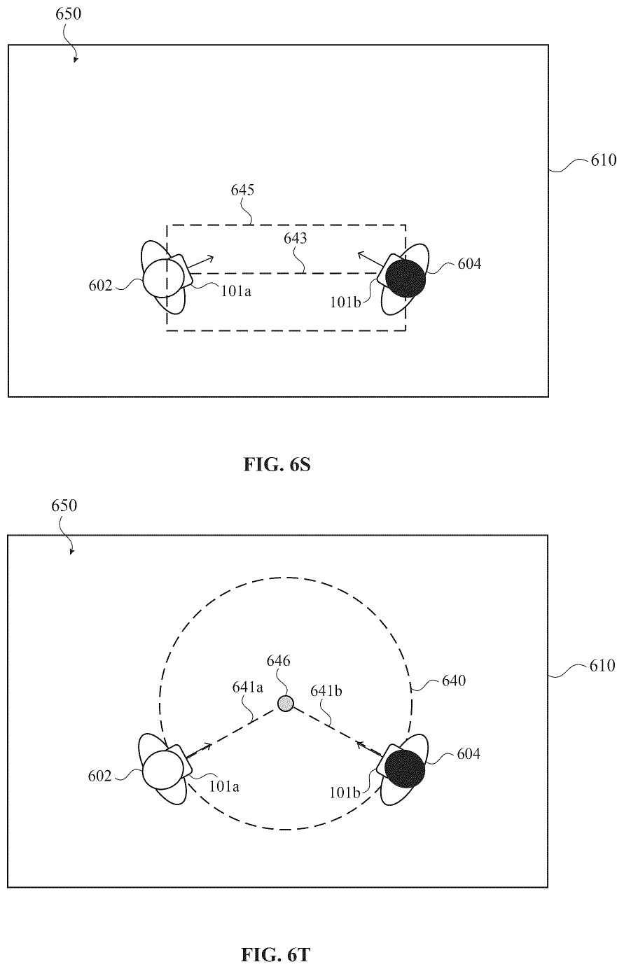

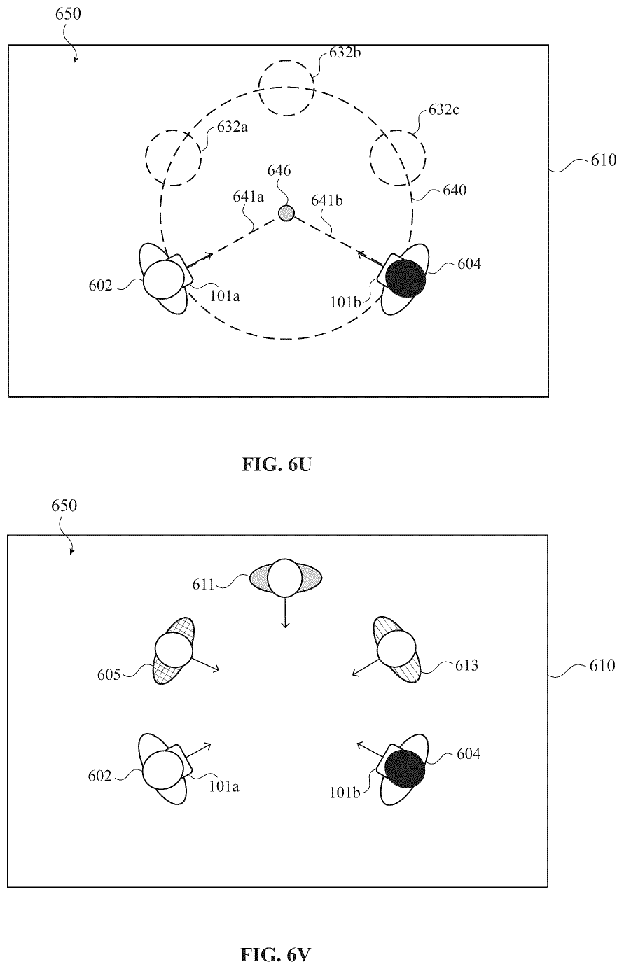

FIGS. 6A-6V illustrate examples of displaying one or more visual representations of non-collocated users in a three-dimensional environment within a multi-user communication session that includes collocated and non-collocated users according to some examples of the disclosure. In FIG. 6A, first electronic device 101a (e.g., associated with first user 602) and second electronic device 101b (e.g., associated with second user 604) are collocated in a physical environment, as similarly discussed above, while engaging in a multi-user communication session. In some examples, the first user 602 and the second user 604 correspond to first user 402/502 and second user 404/504, respectively, of FIGS. 4A-4W and FIGS. 5A-5M. In some examples, the physical environment has one or more characteristics of physical environment 400/500 discussed above. Additionally, in FIG. 6A, the first electronic device 101a and the second electronic device 101b are presenting a shared three-dimensional environment 650 (e.g., from the unique viewpoints of the first electronic device 101a and the second electronic device 101b). In some examples, the shared three-dimensional environment 650 has one or more characteristics of the three-dimensional environments discussed above.

As shown in the overhead view 610 in FIG. 6A, the first electronic device 101a and the second electronic device 101b are not currently displaying a shared virtual object in the shared three-dimensional environment 650. For example, the first electronic device 101a and the second electronic device 101b are engaging in a multi-user communication session without currently displaying virtual content, such as a virtual user interface, a virtual model, a virtual game, etc., that is visible to and/or interactive to both the first user 602 and the second user 604 in the shared three-dimensional environment 650. In FIG. 6A, while there is no shared virtual object displayed in the shared three-dimensional environment 650, the first electronic device 101a and/or the second electronic device 101b detect an indication of a request to add a remote user to the multi-user communication session. For example, the first electronic device 101a and/or the second electronic device 101b detect an incoming indication or other user input corresponding to a request to add a third user of a third electronic device that is non-collocated with the first electronic device 101a and the second electronic device 101b in the same physical environment. In some examples, the indication has one or more characteristics of the indications and/or inputs described previously herein.

In some examples, in response to detecting the indication and while there is no shared virtual content displayed in the shared three-dimensional environment 650, the first electronic device 101a and the second electronic device 101b display a visual representation of the remote user in the shared three-dimensional environment 650 based on the poses of the first electronic device 101a and the second electronic device 101b in the physical environment. For example, in the overhead view 610 in FIG. 6A, the first electronic device 101a has a first location and a first orientation in the physical environment (e.g., based on the location and the orientation of the head of the first user 602) and the second electronic device 101b has a second location and a second orientation in the physical environment (e.g., based on the location and the orientation of the head of the second user 604). In some examples, as previously discussed herein, the first pose of the first electronic device 101a and the second pose of the second electronic device 101b are determined via one or more sensors, cameras, and/or other input devices in communication with the electronic devices 101a/101b.

In some examples, as illustrated in the overhead view 610 in FIG. 6B, the first electronic device 101a and the second electronic device 101b display virtual canvas 612 at a respective location in the shared three-dimensional environment 650. In some examples, as shown in the overhead view 610 in FIG. 6B, the virtual canvas 612 is displayed at a distance 643 relative to the locations of the first user 602 and the second user 604 in the shared three-dimensional environment 650. In some examples, as alluded to above, the location of the virtual canvas 612 and the distance 643 in the shared three-dimensional environment 650 are determined based on the poses of the first electronic device 101a and the second electronic device 101b in the physical environment. For example, as indicated in the overhead view 610 in FIG. 6B, the virtual canvas 612 is displayed adjacent to the first user 602 and the second user 604 in the shared three-dimensional environment 650 and at a distance that enables the first user 602 and the second user 604 to view (e.g., in the users'periphery) and/or be able to view the virtual canvas 612 from their respective viewpoints in the shared three-dimensional environment 650. In some examples, as described in more detail below, the display of the virtual canvas 612 in the shared three-dimensional environment 650 signifies the adding or joining of the remote user (e.g., the third user of the third electronic device) to the multi-user communication session that includes the first user 602 and the second user 604.

In some examples, as shown in FIG. 6B, the virtual canvas 612 is and/or includes a two-dimensional representation 614 of the remote user (e.g., the third user of the third electronic device). For example, as shown in FIG. 6B, the virtual canvas 612 includes a two-dimensional image of the remote user, such as a contact photo or similar image representing the remote user, a two-dimensional avatar or cartoon of the remote user, or a live camera feed that includes a video stream of the remote user (e.g., as captured by one or more cameras of the third electronic device and transmitted to the first electronic device 101a and the second electronic device 101b). In some examples, the display of the virtual canvas 612 is accompanied by the presentation of audio corresponding to a voice of the remote user, such as via one or more speakers in communication with the first electronic device 101a and the second electronic device 101b. In some examples, the audio corresponding to the voice of the remote user is captured via one or more microphones of the third electronic device and transferred to the first electronic device 101a and the second electronic device 101b for presentation with the virtual canvas 612 in the shared three-dimensional environment 650. In some examples, as shown in FIG. 6B, the virtual canvas 612 includes a plurality of controls 616 that is selectable to perform corresponding operations directed to and/or involving the two-dimensional representation 614, such as audio and/or volume control, camera control, communication control, and/or sharing of virtual content.

FIG. 6C illustrates an alternative example of the display of the virtual canvas 612 in the shared three-dimensional environment 650 for alternative poses of the first electronic device 101a and the second electronic device 101b in the physical environment. For example, as illustrated in the overhead view 610 in FIG. 6C, the first electronic device 101a has a different orientation than that in FIG. 6B, and the second electronic device 101b has a different orientation than that in FIG. 6B. Accordingly, as shown in the overhead view 610 in FIG. 6C, the first electronic device 101a and the second electronic device 101b display the virtual canvas 612 an updated distance 643 relative to the locations of the first user 602 and the second user 604 in the shared three-dimensional environment 650 in a direction that corresponds to an average forward direction of the first electronic device 101a and the second electronic device 101b. For example, as shown in the overhead view 610 in FIG. 6C, the virtual canvas 612 is displayed at a farther distance from the viewpoints of the first electronic device 101a and the second electronic device 101b in the shared three-dimensional environment 650 than the distance 643 in FIG. 6B, and at a location that aligns with (e.g., is in a direction of) the average forward direction of the first electronic device 101a and the second electronic device 101b. Additionally, in some examples, as shown in the overhead view 610 in FIG. 6C, the virtual canvas 612 is displayed with a size that is different from the size of the virtual canvas 612 in FIG. 6B. For example, in the overhead view 610 in FIG. 6C, because the virtual canvas 612 is displayed at a farther distance 643 from the locations of the first user 602 and the second user 604 in the shared three-dimensional environment 650 than in FIG. 6B, the virtual canvas 612 is displayed at a larger size relative to the viewpoints of the first electronic device 101a and the second electronic device 101b in the shared three-dimensional environment 650.

In some examples, the visual representation of the remote user is defaulted to being the two-dimensional virtual canvas 612 when the remote user joins the multi-user communication session while there is no shared virtual content being displayed in the shared three-dimensional environment 650. For example, in FIGS. 6B and 6C, the first electronic device 101a and the second electronic device 101b display the virtual canvas 612, which includes the two-dimensional representation 614 of the remote user, rather than a three-dimensional avatar (e.g., such as avatar 405/505 discussed above) because the shared three-dimensional environment 650 does not include a shared virtual object (e.g., such as virtual object 420/520 or 425/525 discussed above) when the remote user is added to the multi-user communication session. In some examples, after the remote user joins the multi-user communication session (e.g., after the first electronic device 101a and the second electronic device 101b display the virtual canvas 612 in the shared three-dimensional environment 650), the remote user is able to provide input (e.g., to the third electronic device associated with the remote user) that causes the first electronic device 101a and the second electronic device 101b to display a three-dimensional visual representation of the remote user in the shared three-dimensional environment 650, as discussed below.

From FIG. 6C to FIG. 6D, the third electronic device 101c associated with the third user (e.g., the remote user) detects an input provided by the third user corresponding to a request to participate in the multi-user communication session spatially at the third electronic device. For example, the third electronic device detects input provided by the third user directed to one or more selectable options or user interface objects displayed at the third electronic device for activating representation of the third user spatially (e.g., three-dimensionally) at each of the first electronic device 101a and the second electronic device 101b. In some examples, in response to detecting the input provided by the third user, the third electronic device transmits data to the first electronic device 101a and the second electronic device 101b that provides the first electronic device 101a and the second electronic device 101b an indication that the third user has requested to be represented spatially in the shared three-dimensional environment 650. In some examples, as indicated in the overhead view 610 in FIG. 6D, in response to detecting the data provided by the third electronic device, the first electronic device 101a and the second electronic device 101b replace display of the virtual canvas 612 with avatar 605 (e.g., a three-dimensional representation) corresponding to the remote user in the shared three-dimensional environment 650. In some examples, as illustrated in the overhead view 610 in FIG. 6D, the avatar 605 is displayed at the same location as the virtual canvas 612 in the shared three-dimensional environment 650.

From FIG. 6D to FIG. 6E, an additional remote user (e.g., a fourth user of a fourth electronic device that is non-collocated in the physical environment with the first electronic device 101a and the second electronic device 101b) joins the multi-user communication session. For example, the first electronic device 101a, the second electronic device 101b, and the third electronic device 101c detect an indication of a request to add the fourth user of the fourth electronic device to the multi-user communication session, as similarly discussed above. In some examples, in response to detecting the indication of the request to add the fourth user to the multi-user communication session, as illustrated in the overhead view 610 in FIG. 6E, the first electronic device 101a and the second electronic device 101b display virtual canvas 612 in the shared three-dimensional environment 650 (e.g., a two-dimensional representation of the fourth user of the fourth electronic device). In some examples, the virtual canvas 612 has one or more characteristics of the virtual canvas 612 discussed above, but specific to the fourth user of the fourth electronic device. In some examples, as shown in the overhead view 610 in FIG. 6E, when the virtual canvas 612 is displayed in the shared three-dimensional environment 650 (e.g., indicative of adding the fourth user to the multi-user communication session), the first electronic device 101a and the second electronic device 101b update display of the avatar 605 corresponding to the third user in the shared three-dimensional environment 650. For example, as shown in FIG. 6E, the first electronic device 101a and the second electronic device 101b reposition the avatar 605 in the shared three-dimensional environment 650. In some examples, as illustrated in the overhead view 610 in FIG. 6E, the avatar 605 is repositioned to be to the right of the first user 602 from the viewpoint of the first electronic device 101a and across from the second user 604 from the viewpoint of the second electronic device 101b in the shared three-dimensional environment 650, to accommodate and/or enable display of the virtual canvas 612 within a circular (e.g., conversational) arrangement of users in the shared three-dimensional environment 650. Alternatively, in some examples, as illustrated in the overhead view 610 in FIG. 6F, the avatar 605 is repositioned in the shared three-dimensional environment 650 to be faced toward the front surface of the virtual canvas 612, which is displayed in the shared three-dimensional environment 650 based on the average forward direction of the first electronic device 101a and the second electronic device 101b, as similarly described above.

FIGS. 6G-6L illustrate additional examples of displaying visual representations of remote users when joining a multi-user communication session that includes local users while no virtual content is shared within the multi-user communication session. In FIG. 6G, first electronic device 101a (e.g., associated with first user 602), second electronic device 101b (e.g., associated with second user 604), and third electronic device 101c (e.g., associated with third user 606) are collocated in a physical environment, as similarly discussed above, that includes table 617 (e.g., a real-world table), while engaging in a multi-user communication session. In some examples, the physical environment has one or more characteristics of the physical environments discussed above. Additionally, in FIG. 6G, the first electronic device 101a, the second electronic device 101b, and the third electronic device 101c are presenting a shared three-dimensional environment 650 (e.g., from the unique viewpoints of the first electronic device 101a, the second electronic device 101b, and the third electronic device 101c) that includes a representation (e.g., a passthrough representation or computer-generated representation) of the table 617. In some examples, the shared three-dimensional environment 650 has one or more characteristics of the three-dimensional environments discussed above. As shown in the overhead view 610 in FIG. 6G, as similarly discussed above, the first electronic device 101a, the second electronic device 101b, and the third electronic device 101c are not currently displaying a shared virtual object in the shared three-dimensional environment 650.

In some examples, while the first electronic device 101a, the second electronic device 101b, and the third electronic device 101c are engaging in the multi-user communication session, the multi-user communication session is associated with a spatial template. In some examples, the spatial template is determined based on physical characteristics of the physical environment in which the electronic devices 101a/101b/101c are located. For example, as shown in the overhead view 610 in FIG. 6G, a circular or surround (e.g., conversational) spatial template is defined relative to (e.g., centered on) the table 617 based on the physical locations of the first user 602, the second user 604, and the third user 606 in the physical environment. In some examples, in FIG. 6G, the locations occupied by the first user 602, the second user 604, and the third user 606 in the shared three-dimensional environment 650 relative to the table 617 correspond to occupied seats within the spatial template associated with the multi-user communication session.

In some examples, as indicated in the overhead view 610 in FIG. 6H, the spatial template described above includes a canvas seat that is reserved for the display of two-dimensional representations of remote users in the shared three-dimensional environment 650. For example, as illustrated in the overhead view 610 in FIG. 6H, the first electronic device 101a, the second electronic device 101b, and/or the third electronic device 101c define and/or identify a particular seat within the spatial template at which to display the virtual canvas 612 (e.g., the virtual canvas 612 described above). In the example of FIG. 6H, two remote users (e.g., a fourth user of a fourth electronic device and a fifth user of a fifth electronic device) have joined the multi-user communication session while no virtual content is shared in the multi-user communication session, which causes the first electronic device 101a, the second electronic device 101b, and the third electronic device 101c to display the virtual canvas 612 at the canvas seat within the spatial template as indicated in the overhead view 610. In some examples, as similarly described above, the virtual canvas 612 includes a two-dimensional representation 614 of the first remote user (e.g., the fourth user) and a two-dimensional representation 624 of the second remote user (e.g., the fifth user), as shown in FIG. 6H. In some examples, as illustrated in the overhead view 610 in FIG. 6H, the canvas seat is selected to correspond to an unoccupied location/region within the shared three-dimensional environment 650 (e.g., unoccupied by the first user 602, the second user 604, or the third user 606) along an edge/side of the table 617.

In some examples, as similarly described above, the remote users are able to provide input (e.g., to the fourth electronic device associated with the fourth user and/or the fifth electronic device associated with the fifth user) that causes the first electronic device 101a, the second electronic device 101b, and the third electronic device 101c to display a three-dimensional visual representation of the remote user in the shared three-dimensional environment 650. From FIG. 6H to FIG. 6I, the fourth electronic device associated with the first remote user receives an input provided by the first remote user corresponding to a request to participate in the multi-user communication session spatially at the fourth electronic device, as similarly described above. In some examples, in response to receiving the input, the fourth electronic device transmits an indication of the request to the first electronic device 101a, the second electronic device 101b, and the third electronic device 101c, which causes the first electronic device 101a, the second electronic device 101b, and the third electronic device 101c to display a three-dimensional representation of the first remote user in the shared three-dimensional environment 650. For example, as shown in the overhead view 610 in FIG. 6I, avatar 605 corresponding to the first remote user is displayed in the shared three-dimensional environment 650. In some examples, as illustrated in the overhead view 610 in FIG. 6I, the avatar 605 is displayed adjacent to the virtual canvas 612 within the specified canvas seat in the shared three-dimensional environment 650. In some examples, when the avatar 605 is displayed in the shared three-dimensional environment 650, the two-dimensional representation 614 of the first remote user is removed from the virtual canvas 612 in the shared three-dimensional environment 650. Accordingly, as illustrated from FIG. 6H to FIG. 6I, a size of the virtual canvas 612 is optionally decreased in the shared three-dimensional environment 650 (e.g., because the virtual canvas 612 no longer includes the two-dimensional representation 614).

From FIG. 6I to FIG. 6J, the fifth electronic device associated with the second remote user receives an input provided by the second remote user corresponding to a request to participate in the multi-user communication session spatially at the fifth electronic device, as similarly described above. In some examples, in response to receiving the input, the fifth electronic device transmits an indication of the request to the first electronic device 101a, the second electronic device 101b, and the third electronic device 101c, which causes the first electronic device 101a, the second electronic device 101b, and the third electronic device 101c to display a three-dimensional representation of the second remote user in the shared three-dimensional environment 650. For example, as shown in the overhead view 610 in FIG. 6J, avatar 611 corresponding to the second remote user is displayed in the shared three-dimensional environment 650. In some examples, as illustrated in the overhead view 610 in FIG. 6J, the avatar 611 replaces display of the virtual canvas 612 (e.g., is displayed at the location of the virtual canvas 612) and is thus displayed adjacent to the avatar 605 within the specified canvas seat in the shared three-dimensional environment 650. In some examples, as illustrated in the overhead view 610 in FIG. 6J, when the avatar 611 is displayed in the shared three-dimensional environment 650, the virtual canvas 612 ceases to be displayed in the shared three-dimensional environment 650.

In FIG. 6K, the first electronic device 101a (e.g., associated with the first user 602), the second electronic device 101b (e.g., associated with the second user 604), the third electronic device 101c (e.g., associated with the third user 606), and a fourth electronic device 101d (e.g., associated with fourth user 618) are collocated in a physical environment, as similarly discussed above, that includes the table 617, while engaging in a multi-user communication session. Additionally, in FIG. 6K, the first electronic device 101a, the second electronic device 101b, the third electronic device 101c, and the fourth electronic device 101d are presenting a shared three-dimensional environment 650 (e.g., from the unique viewpoints of the first electronic device 101a, the second electronic device 101b, the third electronic device 101c, and the fourth electronic device 101d) that includes a representation (e.g., a passthrough representation or computer-generated representation) of the table 617. As shown in the overhead view 610 in FIG. 6K, as similarly discussed above, the first electronic device 101a, the second electronic device 101b, the third electronic device 101c, and the fourth electronic device 101d are not currently displaying a shared virtual object in the shared three-dimensional environment 650.

In some examples, while the first electronic device 101a, the second electronic device 101b, the third electronic device 101c, and the fourth electronic device 101d are engaging in the multi-user communication session, the multi-user communication session is associated with a spatial template, as similarly discussed above. In some examples, the spatial template is determined based on physical characteristics of the physical environment in which the electronic devices 101a/101b/101c/101d are located. For example, as shown in the overhead view 610 in FIG. 6K, a circular or surround (e.g., conversational) spatial template is defined relative to (e.g., centered on) the table 617 based on the physical locations of the first user 602, the second user 604, the third user 606, and the fourth user 618 in the physical environment. In some examples, in FIG. 6K, the locations occupied by the first user 602, the second user 604, the third user 606, and the fourth user 618 in the shared three-dimensional environment 650 relative to the table 617 correspond to occupied seats within the spatial template associated with the multi-user communication session.

In some examples, as indicated in the overhead view 610 in FIG. 6L, the spatial template described above includes a canvas seat that is reserved for the display of two-dimensional representations of remote users in the shared three-dimensional environment 650. For example, as illustrated in the overhead view 610 in FIG. 6L, the first electronic device 101a, the second electronic device 101b, the third electronic device 101c, and/or the fourth electronic device 101d define and/or identify a particular seat within the spatial template at which to display the virtual canvas 612 (e.g., the virtual canvas 612 described above). In some examples, as illustrated in the overhead view 610 in FIG. 6L, the location at which the virtual canvas 612 is displayed in the shared three-dimensional environment 650 falls outside of the circular arrangement of the users 602/604/606/618 relative to the table 617, because, contrary to the example in FIG. 6H, an open/unoccupied region along an edge/side of the table 617 is not currently available when the virtual canvas 612 is displayed in the shared three-dimensional environment 650 (e.g., when a remote user joins the multi-user communication session in FIG. 6L).

FIGS. 6M-6N illustrate additional examples of displaying visual representations of remote users when joining a multi-user communication session that includes local users while no virtual content is shared within the multi-user communication session. In FIG. 6M, first electronic device 101a (e.g., associated with first user 602), second electronic device 101b (e.g., associated with second user 604), and third electronic device 101c (e.g., associated with third user 606) are collocated in a physical environment, as similarly discussed above, while engaging in a multi-user communication session. In some examples, the physical environment has one or more characteristics of the physical environments discussed above. Additionally, in FIG. 6M, the first electronic device 101a, the second electronic device 101b, and the third electronic device 101c are presenting a shared three-dimensional environment 650 (e.g., from the unique viewpoints of the first electronic device 101a, the second electronic device 101b, and the third electronic device 101c). In some examples, the shared three-dimensional environment 650 has one or more characteristics of the three-dimensional environments discussed above.

In the example of FIG. 6M, as similarly discussed above, the first electronic device 101a, the second electronic device 101b, and the third electronic device 101c have detected an indication of a request to add one or more remote users to the multi-user communication session while the first electronic device 101a, the second electronic device 101b, and the third electronic device 101c are not currently displaying a shared virtual object in the shared three-dimensional environment 650. In some examples, as similarly discussed above, in response to detecting the indication of the request to add the one or more remote users to the multi-user communication session, the first electronic device 101a, the second electronic device 101b, and the third electronic device 101c display virtual canvas 612 in the shared three-dimensional environment 650, as illustrated in the overhead view 610 in FIG. 6M.

In some examples, as similarly described above, while the first electronic device 101a, the second electronic device 101b, and the third electronic device 101c are engaging in the multi-user communication session, the multi-user communication session is associated with a spatial template. In some examples, the spatial template is determined based on a spatial arrangement of the first user 602, the second user 604, and the third user 606 in the shared three-dimensional environment 650. For example, in FIG. 6M, the physical locations of the first electronic device 101a, the second electronic device 101b, and the third electronic device 101c in the physical environment correspond to and/or form an arc within the physical environment. Accordingly, the electronic devices 101a/101b/101c optionally associate a side-by-side spatial template with the multi-user communication session. In some examples, as similarly described above, the spatial template includes a canvas seat that is reserved for the display of two-dimensional representations of remote users in the shared three-dimensional environment 650. For example, as illustrated in the overhead view 610 in FIG. 6M, the first electronic device 101a, the second electronic device 101b, and/or the third electronic device 101c define and/or identify a particular seat within the spatial template at which to display the virtual canvas 612. In some examples, the canvas seat is selected based on the orientations of the electronic devices 101a/101b/101c in the shared three-dimensional environment 650. For example, in the overhead view 610 in FIG. 6M, the location at which the virtual canvas 612 is displayed in the shared three-dimensional environment 650 is in a direction of the average forward direction of the first electronic device 101a, the second electronic device 101b, and the third electronic device 101c, as similarly discussed above. In some examples, as illustrated in the overhead view 610 in FIG. 6M, the canvas seat is selected to correspond to an unoccupied location/region within the shared three-dimensional environment 650 (e.g., unoccupied by the first user 602, the second user 604, or the third user 606).

In the example of FIG. 6M, two remote users (e.g., a fourth user of a fourth electronic device and a fifth user of a fifth electronic device) have joined the multi-user communication session while no virtual content is shared in the multi-user communication session and are thus virtually represented within the virtual canvas 612 at the canvas seat within the spatial template as indicated in the overhead view 610. For example, as similarly described above, the virtual canvas 612 includes a two-dimensional representation of the first remote user (e.g., the fourth user), similar to two-dimensional representation 614 discussed above, and a two-dimensional representation of the second remote user (e.g., the fifth user), similar to two-dimensional representation 624 discussed above.

In some examples, as similarly described above, the remote users are able to provide input (e.g., to the fourth electronic device associated with the fourth user and/or the fifth electronic device associated with the fifth user) that causes the first electronic device 101a, the second electronic device 101b, and the third electronic device 101c to display a three-dimensional visual representation of the remote user in the shared three-dimensional environment 650. From FIG. 6M to FIG. 6N, the fourth electronic device associated with the first remote user receives an input provided by the first remote user corresponding to a request to participate in the multi-user communication session spatially at the fourth electronic device, as similarly described above. In some examples, in response to receiving the input, the fourth electronic device transmits an indication of the request to the first electronic device 101a, the second electronic device 101b, and the third electronic device 101c, which causes the first electronic device 101a, the second electronic device 101b, and the third electronic device 101c to display a three-dimensional representation of the first remote user in the shared three-dimensional environment 650. For example, as shown in the overhead view 610 in FIG. 6N, avatar 605 corresponding to the first remote user is displayed in the shared three-dimensional environment 650. In some examples, as illustrated in the overhead view 610 in FIG. 6N, the avatar 605 is displayed adjacent to the virtual canvas 612 within the specified canvas seat in the shared three-dimensional environment 650. In some examples, when the avatar 605 is displayed in the shared three-dimensional environment 650, the two-dimensional representation of the first remote user is removed from the virtual canvas 612 in the shared three-dimensional environment 650, as similarly described above.

It should be understood that, in the above examples illustrated in FIGS. 6G-6N, while a visual representation of a remote user (e.g., two-dimensional representation within the virtual canvas 612) is displayed at the canvas seat within a respective spatial template associated with the multi-user communication session, the sharing of virtual content in the multi-user communication session optionally does not cause the canvas seat to be altered and/or removed in the spatial template. For example, a shared virtual object may be displayed in the shared three-dimensional environment 650 while maintaining display of the virtual canvas 612 at the canvas seat within the spatial template in the shared three-dimensional environment 650.

FIGS. 6O-6V illustrate alternative approaches to identifying a placement location at which to present a visual representation of a remote user in a shared three-dimensional environment that does not currently include shared content within a multi-user communication session that includes local users. In FIG. 6O, as illustrated in overhead view 610, a first user 602 of a first electronic device 101a is in a multi-user communication session with a second user 604 of a second electronic device 101b while the first user 602 and the second user 604 are collocated in the same physical environment, as similarly discussed above. Additionally, in some examples, as similarly discussed above, the first user 602 of the first electronic device 101a and the second user 604 of the second electronic device 101b are communicating via a shared three-dimensional environment 650 that is presented via their respective electronic devices 101a/101b. In the example of FIG. 6O, the shared three-dimensional environment 650 does not currently include shared content (e.g., a shared virtual object, such as a shared user interface, as similarly discussed herein).

In FIG. 6O, the first electronic device 101a and the second electronic device 101b detect an indication of a request to add a third electronic device to the multi-user communication session that includes the first electronic device 101a and the second electronic device 101b. For example, as similarly described above, the first electronic device 101a and/or the second electronic device 101b detect an incoming notification event from the third electronic device corresponding to a request to join the multi-user communication session or the first electronic device 101a and/or the second electronic device 101b initiate communication with the third electronic device for adding the third electronic device to the multi-user communication session. In some examples, the third electronic device is non-collocated with the first electronic device and the second electronic device in the physical environment discussed above. For example, a user of the third electronic device corresponds to a remote user relative to the first user 602 and the second user 604.

In some examples, as described herein, adding the third electronic device to the multi-user communication session includes identifying a placement location in the shared three-dimensional environment 650 at which to present a visual representation (e.g., avatar) of the user of the third electronic device. In some examples, as illustrated in the overhead view 610 in FIG. 6P, identifying a placement location for the visual representation of the user of the third electronic device in the shared three-dimensional environment 650 includes determining a distance between the first electronic device 101a (e.g., and the first user 602) and the second electronic device 101b (e.g., and the second user 604) in the physical environment. For example, as shown in the overhead view 610 in FIG. 6P, the first electronic device 101a and the second electronic device 101b are separated by distance 643 in the physical environment. In some examples, the distance 643 is determined by the first electronic device 101a and/or the second electronic device 101b based on any one or combination of the approaches described herein, such as based on computer vision, image recognition, object detection, GPS data, Bluetooth or Wi-Fi signal exchange, etc. Additionally, in some examples, after determining the distance 643 between the first electronic device 101a and the second electronic device 101b in the physical environment, the first electronic device 101a and/or the second electronic device 101b determine and/or select reference point 646 in the shared three-dimensional environment 650, as illustrated in the overhead view 610 in FIG. 6P. In some examples, as illustrated in FIG. 6P, the reference point 646 is selected to be equidistant between the first electronic device 101a and the second electronic device 101b in the shared three-dimensional environment 650 (e.g., as a center point between the first user 602 and the second user 604). In some examples, as discussed in more detail below, the reference point 646 serves as a reference location in the shared three-dimensional environment 650 according to which one or more placement locations for the visual representation of the user of the third electronic device are defined in the shared three-dimensional environment 650.

In some examples, the location in the shared three-dimensional environment 650 to which the reference point 646 corresponds is selected based on the distance between the first electronic device 101a and the second electronic device 101b. Particularly, in some examples, if the distance 643 between the first electronic device 101a and the second electronic device 101b is more than a threshold distance, such as 1, 2, 3, 5, 10, 15, 20, etc. meters, the reference point 646 is selected to be between (e.g., along a line between) the locations of the first electronic device 101a and the second electronic device 101b in the shared three-dimensional environment 650. In the example of FIG. 6P, the first electronic device 101a and the second electronic device 101b determine that the distance 643 is less than the threshold distance discussed above. Accordingly, as illustrated in the overhead view 610, the reference point 646 optionally falls equidistantly between the locations of the first electronic device 101a and the second electronic device 101b in the shared three-dimensional environment 650.

In some examples, after determining the reference point 646 in the shared three-dimensional environment 650, the first electronic device 101a and/or the second electronic device 101b apply predefined shape (e.g., circle) 640 relative to the reference point 646 in the shared three-dimensional environment 650. For example, as illustrated in FIG. 6Q, the circle 640 is centered on the reference point 646 in the shared three-dimensional environment 650. In some examples, as similarly discussed above, the circle 640 has a predefined radius in the shared three-dimensional environment 650. In some examples, after applying the circle 640 relative to the reference point 646 in the shared three-dimensional environment 650, the first electronic device 101a and/or the second electronic device 101b determine one or more placement locations at which to display the visual representation of the user of the third electronic device in the shared three-dimensional environment 650. For example, as similarly discussed herein, a first placement location 632a, a second placement location 632b, and/or a third placement location 632c in the shared three-dimensional environment 650, as shown in the overhead view 610 in FIG. 6R. In some examples, as shown in the overhead view 610 in FIG. 6R, the placement locations 632a-632c are defined according to the circle 640 in the shared three-dimensional environment 650, as similarly discussed herein. In some examples, as similarly discussed herein, the visual representation of the user of the third electronic device is displayed at one of the placement locations 632a-632c in the shared three-dimensional environment 650.

As mentioned above with reference to FIG. 6P, in some examples, the location in the shared three-dimensional environment 650 to which the reference point 646 corresponds is selected based on the distance between the first electronic device 101a and the second electronic device 101b, particularly whether the distance 643 is less than or greater than the threshold distance discussed above. In FIG. 6S, the first electronic device 101a and the second electronic device 101b are separated by distance 643 that is smaller than the distance 643 illustrated in FIG. 6P. Particularly, in FIG. 6S, when the indication of the request to add the third electronic device to the multi-user communication session that includes the first electronic device 101a and the second electronic device 101b, the distance 643 between the first electronic device 101a and the second electronic device 101b is less than the threshold distance described above. Accordingly, in some examples, as illustrated in the overhead view 610 in FIG. 6T, because the distance 643 is smaller than the threshold distance above, the reference point 646 is not selected to be between (e.g., along a line between) the locations of the first electronic device 101a and the second electronic device 101b. Rather, as illustrated in the overhead view 610 in FIG. 6T, the reference point 646 is projected outward relative to the locations of the first electronic device 101a and the second electronic device 101b in the shared three-dimensional environment 650, as discussed below (e.g., offset from to the vector between the first electronic device 101a and the second electronic device 101b).

In some examples, as illustrated in the overhead view 610 in FIG. 6T, the location in the shared three-dimensional environment 650 at which the reference point 646 is positioned is based on an average look direction of the first user 602 and the second user 604 in the physical environment. For example, as similarly discussed above, the location of the reference point 646 in the shared three-dimensional environment 650 is based on the orientations of the first electronic device 101a, as indicated by the arrow extending from the first electronic device 101a, and the second electronic device 101b, as indicated by the arrow extending from the second electronic device 101b, which are determined by the forward head direction of the first user 602 and the second user 604, respectively. As discussed in more detail below, determining the reference point 646 to be based on the average look direction of the local users in the multi-user communication session enables the placement locations of remote users who join the multi-user communication session to be positioned in a field of view of the remote users in the shared three-dimensional environment, which advantageously reduces or negates the need for manual repositioning of the local users to view and/or interact with the visual representations of the remote users in the shared three-dimensional environment.

Additionally, in some examples, the location in the shared three-dimensional environment 650 at which the reference point 646 is positioned is based on the locations of the first electronic device 101a and the second electronic device 101b. For example, with reference to the overhead view 610 in FIG. 6S, the first electronic device 101a and/or the second electronic device 101b define a bounding box 645 (e.g., similar to bounding box 545 discussed above) that includes first user 602 and second user 604 and that is defined based on physical locations of first electronic device 101a and second electronic device 101b in the physical environment. For example, in FIG. 6S, a width of the bounding box 645 corresponds to the distance 643 between the first electronic device 101a and the second electronic device 101b in the shared three-dimensional environment 650. Further, a length of the bounding box 645 optionally corresponds to a spatial offset (e.g., vertical offset) between the first user 602 and the second user 604 in the physical environment. For example, in the overhead view 610 in FIG. 6S, the length of the bounding box 645 allows the bounding box 645 to encompass the first user 602 and the second user 604 in the shared three-dimensional environment 650, as similarly described above. Accordingly, as shown in the overhead view 610 between FIG. 6S and FIG. 6T, the location of the reference point 646 is outside of and/or corresponds to an edge or boundary of the bounding box 645 defined according to the locations of the first user 602 and the second user 604 in the shared three-dimensional environment 650.

As shown in the overhead view 610 in FIG. 6T, as similarly discussed above, the first electronic device 101a and the second electronic device 101b apply the predefined shape (e.g., circle) 640 to the shared three-dimensional environment 650 relative to the reference point 646. For example, as similarly discussed above, the circle 640 is centered on the reference point 646 in the shared three-dimensional environment 650. Additionally, in some examples, as shown in the overhead view 610 in FIG. 6T, a radius of the circle 640 corresponds to the locations of the first electronic device 101a and the second electronic device 101b relative to the reference point 646. For example, the first electronic device 101a and/or the second electronic device 101b adapt the radius of the circle 640 to correspond to (or optionally to correspond to an average of or one of) distance 641a between the first user 602 and the reference point 646 and distance 641b between the second user 604 and the reference point 646 in the shared three-dimensional environment 650. Accordingly, in some examples, the first user 602 and the second user 604 occupy locations on the circle 640 relative to the reference point 646 in the shared three-dimensional environment 650.

In some examples, after applying the circle 640 relative to the reference point 646 in the shared three-dimensional environment 650, the first electronic device 101a and/or the second electronic device 101b determine one or more placement locations at which to display the visual representation of the user of the third electronic device in the shared three-dimensional environment 650, as illustrated in the overhead view 610 in FIG. 6U. For example, as similarly discussed herein, a first placement location 632a, a second placement location 632b, and/or a third placement location 632c in the shared three-dimensional environment 650, as shown in the overhead view 610 in FIG. 6U. In some examples, as shown in the overhead view 610 in FIG. 6U, the placement locations 632a-632c are defined according to the circle 640 in the shared three-dimensional environment 650 and correspond to locations on the circle 640 that are unoccupied by the first user 602 and the second user 604, as similarly discussed herein. In some examples, as similarly discussed herein, the visual representation of the user of the third electronic device is displayed at one of the placement locations 632a-632c in the shared three-dimensional environment 650. For example, as illustrated in the overhead view 610 in FIG. 6V, the first electronic device 101a and the second electronic device 101b display avatar 605 corresponding to the user of the third electronic device at the first placement location 632a in the shared three-dimensional environment 650. Additionally, as similarly described above, as additional remote users join and/or are added to the multi-user communication session, additional visual representations of the additional remote users are displayed at the remaining placement locations in the shared three-dimensional environment 650. For example, as shown in the overhead view 610 in FIG. 6V, avatar 611 corresponding to a user of a fourth electronic device is displayed at the second placement location 632b and avatar 613 corresponding to a user of a fifth electronic device is displayed at the third placement location 632c in the shared three-dimensional environment 650. Additionally, in some examples, as shown in the overhead view 610 in FIG. 6V, when the avatars 605/611/613 are displayed in the shared three-dimensional environment 650, the avatars 605/611/613 are oriented to face toward the reference point 646 discussed above. For example, as illustrated by the arrows extending from the avatars 605/611/613 in the overhead view 610, the avatars 605/611/613 have orientations that face toward the center of the circle 640 discussed above in the shared three-dimensional environment 650.

Accordingly, as outlined above, providing systems and methods for displaying visual representations of remote users in a shared three-dimensional environment while in a multi-user communication session that does not include shared virtual content advantageously enables collocated and non-collocated users to participate in the multi-user communication session and experience synchronized interaction with one another, thereby improving user-device interaction. Additionally, automatically determining location(s) at which to display the visual representations of the remote users in the shared three-dimensional environment (e.g., based on a pose of the local users and/or one or more properties of a physical environment of the local users) reduces and/or helps avoid user input for manually selecting the location(s) in the shared three-dimensional environment, which helps conserve computing resources that would otherwise be consumed to respond to such user input, as another benefit.

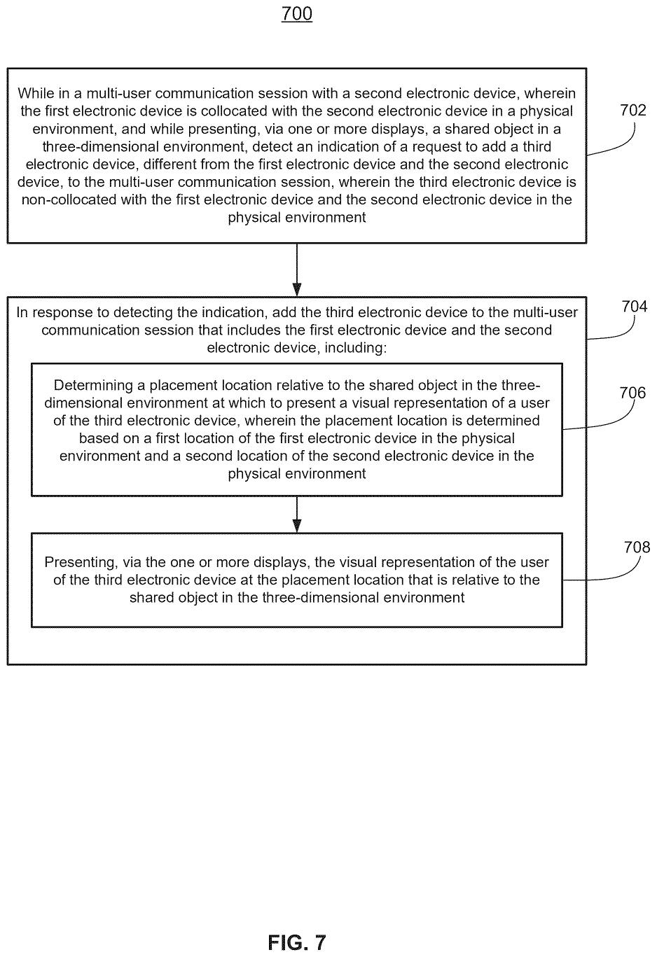

FIG. 7 illustrates a flow diagram illustrating an example process for establishing a multi-user communication session among a plurality of electronic devices in which at least a subset of the plurality of electronic device are non-collocated according to some examples of the disclosure. In some examples, process 700 begins at a first electronic device in communication with one or more displays and one or more input devices, wherein the first electronic device is collocated with a second electronic device in a physical environment. In some examples, the first electronic device and the second electronic device are optionally a head-mounted display, respectively, similar or corresponding to device 200 of FIG. 2. As shown in FIG. 7, in some examples, at 702, while in a multi-user communication session with the second electronic device and while presenting, via the one or more displays, a shared object in a three-dimensional environment, the first electronic device detects an indication of a request to add a third electronic device, different from the first electronic device and the second electronic device, to the multi-user communication session, wherein the third electronic device is non-collocated with the first electronic device and the second electronic device in the physical environment. For example, as shown in FIG. 4B, while displaying virtual object 420 in three-dimensional environment 450A, first electronic device 101a detects a selection of representation 431f in user interface 430 provided by hand 403 of first user 402, which corresponds to a request to add user “Debbie” to the multi-user communication session between the first electronic device 101a and second electronic device 101b.

In some examples, at 704, in response to detecting the indication, the first electronic device adds the third electronic device to the multi-user communication session that includes the first electronic device and the second electronic device, including: determining a placement location relative to the shared object in the three-dimensional environment at which to present a visual representation of a user of the third electronic device, wherein the placement location is determined based on a first location of the first electronic device in the physical environment and a second location of the second electronic device in the physical environment (706); and presenting, via the one or more displays, the visual representation of the user of the third electronic device at the placement location that is relative to the shared object in the three-dimensional environment (708). For example, as shown in overhead view 410 in FIG. 4D, a first placement location 432a is determined along curve 440 that is defined according to the locations of the first user 402 (e.g., and the first electronic device 101a) and the second user 404 (e.g., and the second electronic device 101b) in the physical environment. Additionally, as illustrated in the overhead view 410 in FIG. 4E, avatar 405 corresponding to a third user of a third electronic device (e.g., Debbie) is presented at a location in shared three-dimensional environment 450 that corresponds to the first placement location 432a of FIG. 4D.

It is understood that process 700 is an example and that more, fewer, or different operations can be performed in the same or in a different order. Additionally, the operations in process 700 described above are, optionally, implemented by running one or more functional modules in an information processing apparatus such as general-purpose processors (e.g., as described with respect to FIG. 2) or application specific chips, and/or by other components of FIG. 2.

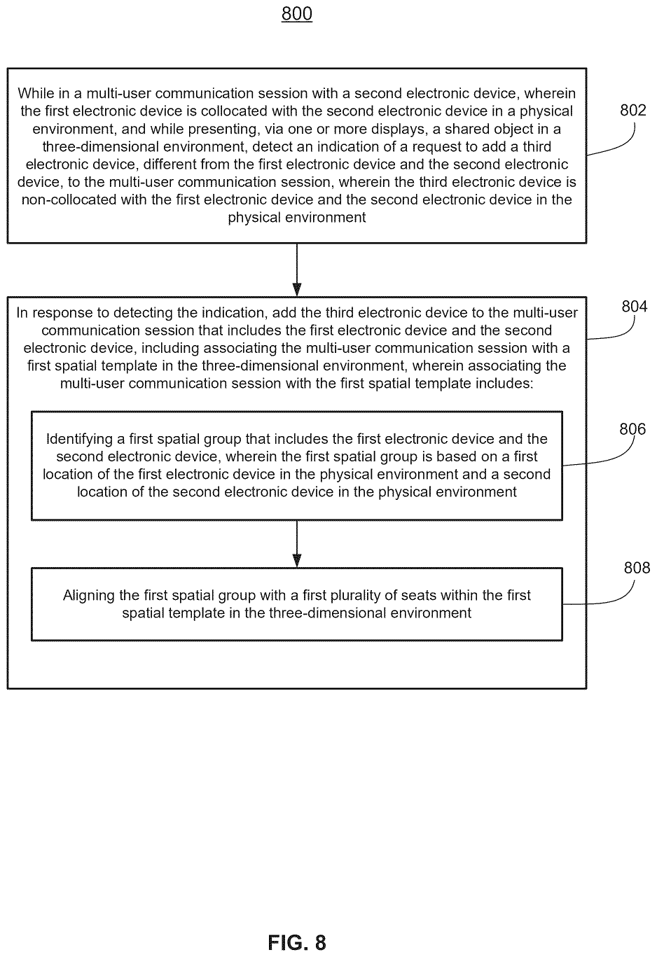

FIG. 8 illustrates a flow diagram illustrating an example process for establishing a multi-user communication session among a plurality of electronic devices in which at least a subset of the plurality of electronic device are non-collocated according to some examples of the disclosure. In some examples, process 800 begins at a first electronic device in communication with one or more displays and one or more input devices, wherein the first electronic device is collocated with a second electronic device in a physical environment. In some examples, the first electronic device and the second electronic device are optionally a head-mounted display, respectively, similar or corresponding to device 200 of FIG. 2. As shown in FIG. 8, in some examples, at 802, while in a multi-user communication session with the second electronic device and while presenting, via the one or more displays, a shared object in a three-dimensional environment, the first electronic device detects an indication of a request to add a third electronic device, different from the first electronic device and the second electronic device, to the multi-user communication session, wherein the third electronic device is non-collocated with the first electronic device and the second electronic device in the physical environment. For example, as shown in FIG. 4B, while displaying virtual object 420 in three-dimensional environment 450A, first electronic device 101a detects a selection of representation 431f in user interface 430 provided by hand 403 of first user 402, which corresponds to a request to add user “Debbie” to the multi-user communication session between the first electronic device 101a and second electronic device 101b.

In some examples, at 804, in response to detecting the indication, the first electronic device adds the third electronic device to the multi-user communication session that includes the first electronic device and the second electronic device, including associating the multi-user communication session with a first spatial template in the three-dimensional environment. For example, as illustrated in overhead view 510B in FIG. 5B, spatial template 536 that includes plurality of seats 532a-532e is associated with the multi-user communication session in shared three-dimensional environment 550 relative to virtual object 520.

In some examples, associating the multi-user communication session with the first spatial template includes: identifying a first spatial group that includes the first electronic device and the second electronic device, wherein the first spatial group is based on a first location of the first electronic device in the physical environment and a second location of the second electronic device in the physical environment (806); and aligning the first spatial group with a first plurality of seats within the first spatial template in the three-dimensional environment (808). For example, as shown in overhead view 510A in FIG. 5B, bounding box 545 that includes first user 502 and second user 504 is defined based on physical locations of first electronic device 101a and second electronic device 101b in the physical environment. Additionally, in some examples, as shown in overhead view 510 in FIG. 5C, the bounding box 545 is aligned to seats 532c and 532d of the spatial template 536 in the shared three-dimensional environment 550.

It is understood that process 800 is an example and that more, fewer, or different operations can be performed in the same or in a different order. Additionally, the operations in process 800 described above are, optionally, implemented by running one or more functional modules in an information processing apparatus such as general-purpose processors (e.g., as described with respect to FIG. 2) or application specific chips, and/or by other components of FIG. 2.

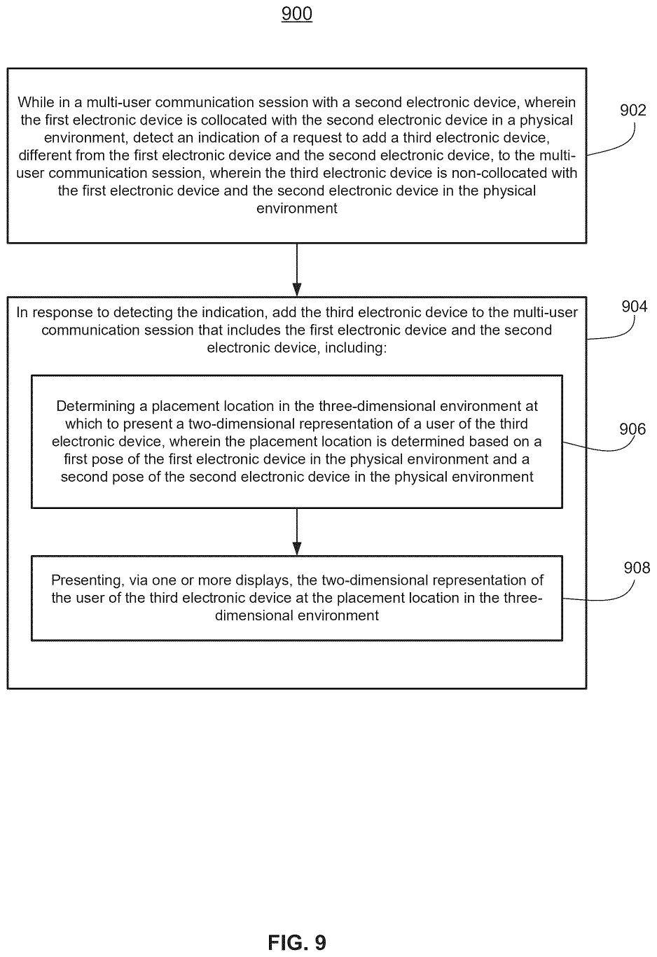

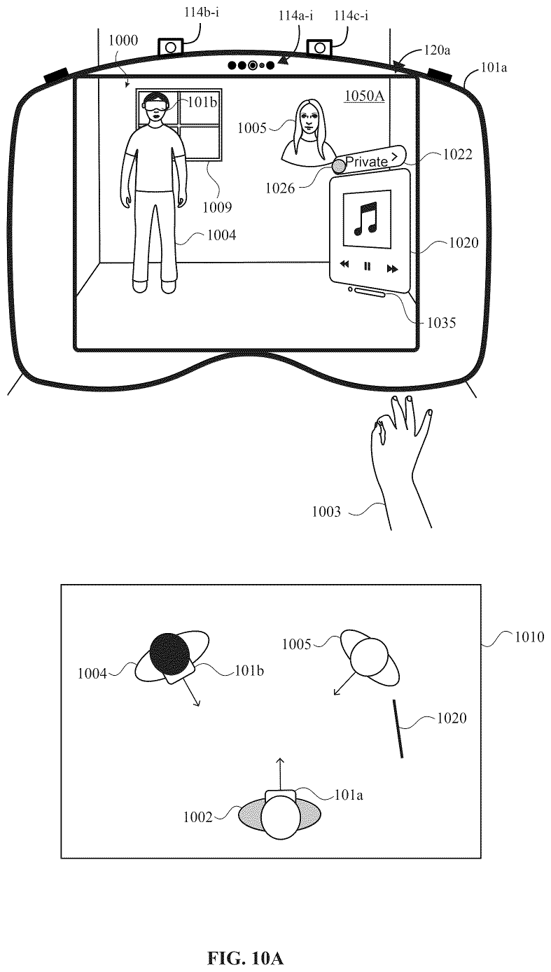

FIG. 9 illustrates a flow diagram illustrating an example process for establishing a multi-user communication session among a plurality of electronic devices in which at least a subset of the plurality of electronic device are non-collocated according to some examples of the disclosure. In some examples, process 900 begins at a first electronic device in communication with one or more displays and one or more input devices, wherein the first electronic device is collocated with a second electronic device in a physical environment. In some examples, the first electronic device and the second electronic device are optionally a head-mounted display, respectively, similar or corresponding to device 200 of FIG. 2. As shown in FIG. 9, in some examples, at 902, while in a multi-user communication session with the second electronic device, the first electronic device detects an indication of a request to add a third electronic device, different from the first electronic device and the second electronic device, to the multi-user communication session, wherein the third electronic device is non-collocated with the first electronic device and the second electronic device in the physical environment. For example, as shown in FIG. 4B, first electronic device 101a detects a selection of representation 431f in user interface 430 provided by hand 403 of first user 402, which corresponds to a request to add user “Debbie” to the multi-user communication session between the first electronic device 101a and second electronic device 101b.

In some examples, at 904, in response to detecting the indication, the first electronic device adds the third electronic device to the multi-user communication session that includes the first electronic device and the second electronic device, including: determining a placement location in the three-dimensional environment at which to present a two-dimensional representation of a user of the third electronic device, wherein the placement location is determined based on a first pose of the first electronic device in the physical environment and a second pose of the second electronic device in the physical environment (906); and presenting, via the one or more displays, the two-dimensional representation of the user of the third electronic device at the placement location in the three-dimensional environment (908). For example, as shown in overhead view 610 in FIG. 6B, a placement location (e.g., at distance 643) for virtual canvas 612, which includes a two-dimensional representation 614 of the third user of the third electronic device, is determined in shared three-dimensional environment 650 based on the locations and orientations of first user 602 and second user 604 in their physical environment.

It is understood that process 900 is an example and that more, fewer, or different operations can be performed in the same or in a different order. Additionally, the operations in process 900 described above are, optionally, implemented by running one or more functional modules in an information processing apparatus such as general-purpose processors (e.g., as described with respect to FIG. 2) or application specific chips, and/or by other components of FIG. 2.

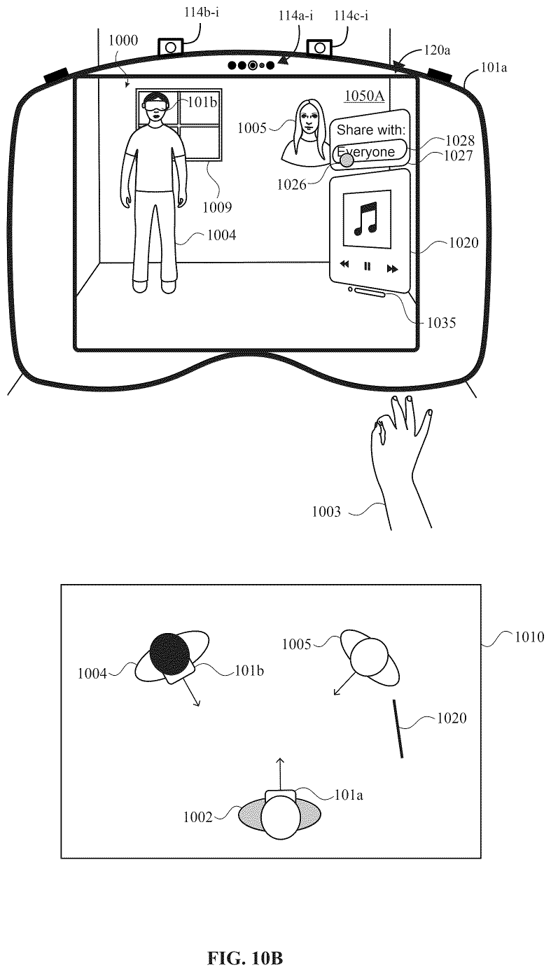

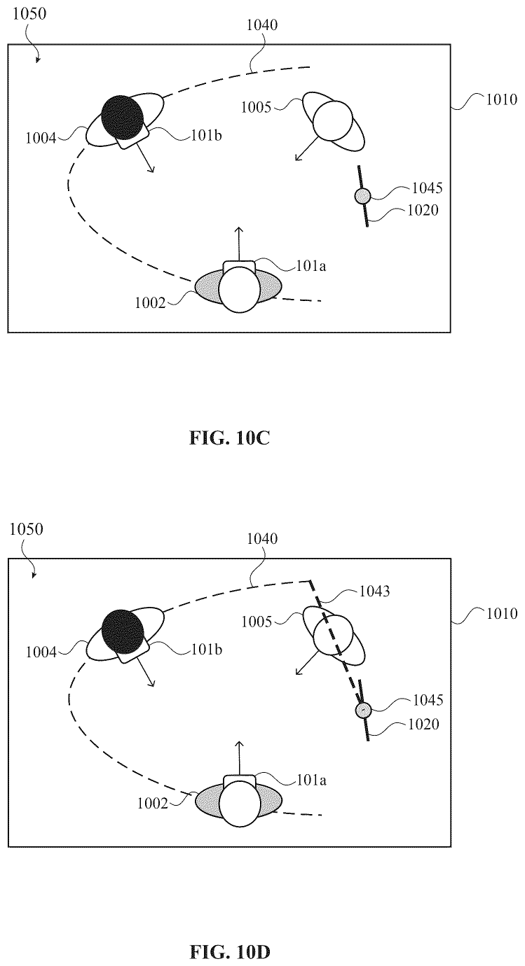

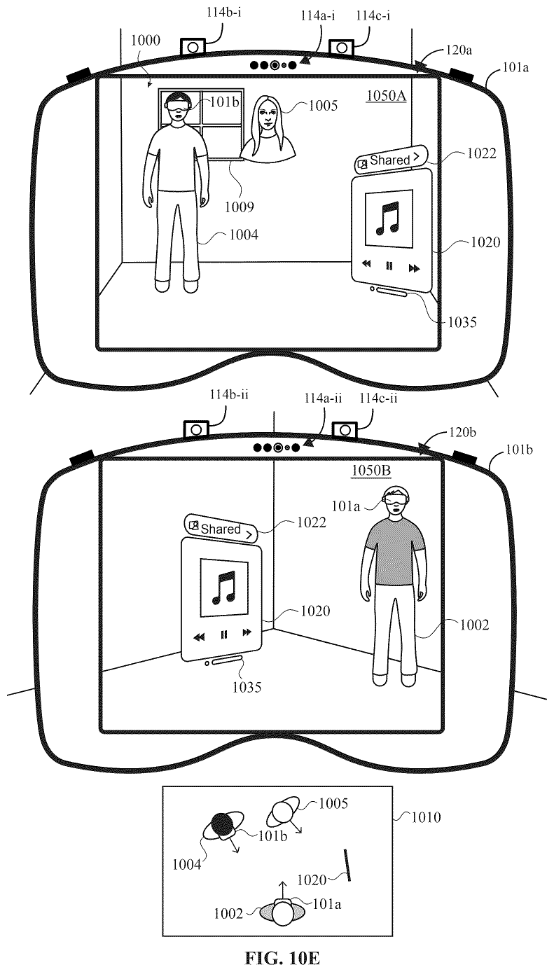

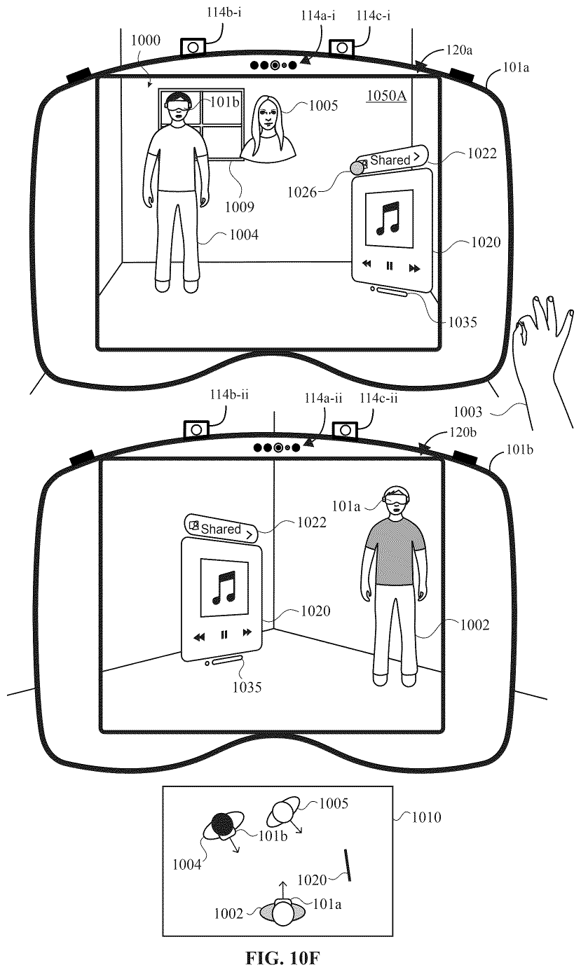

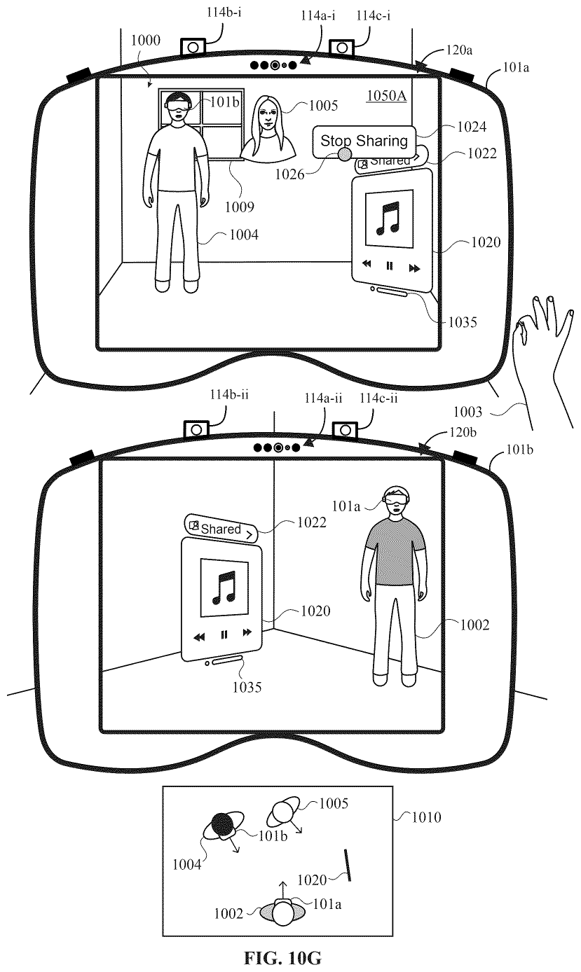

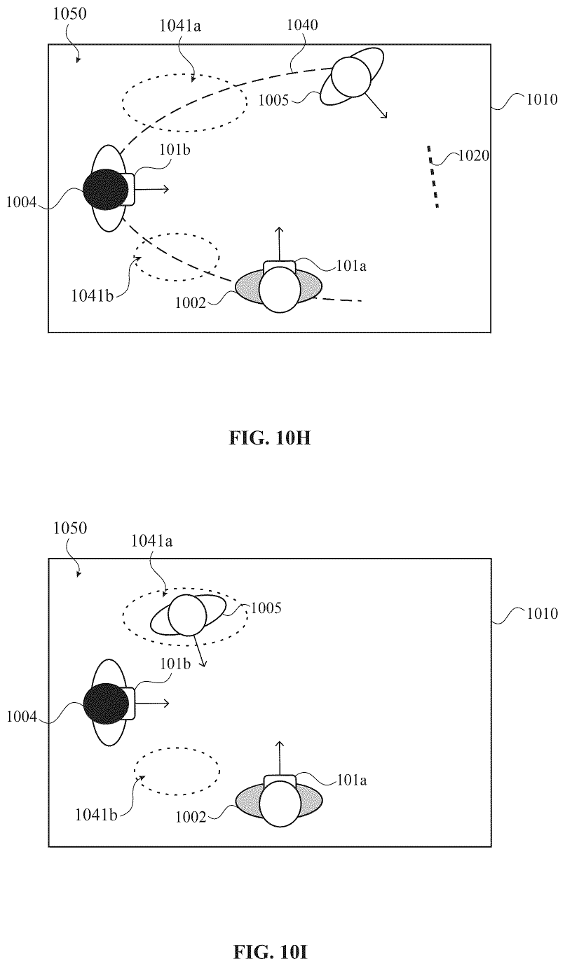

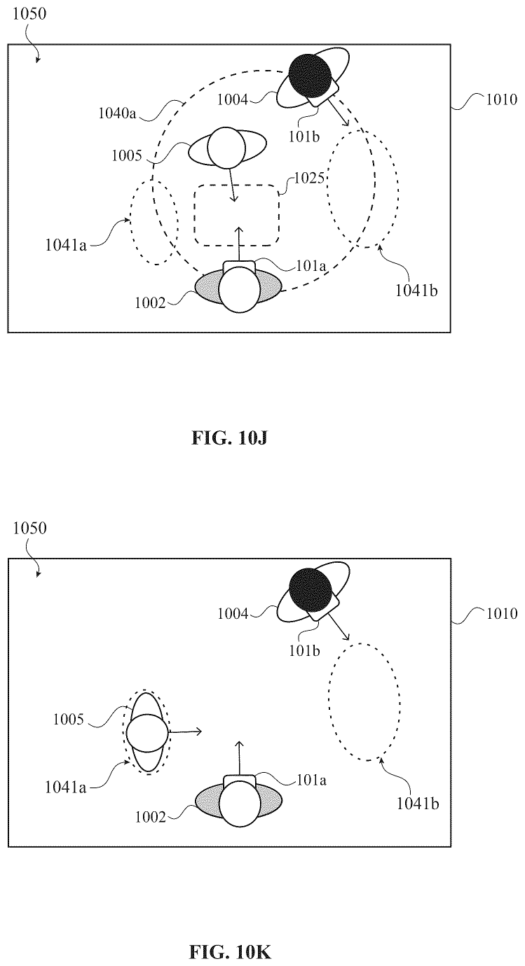

FIGS. 10A-10K illustrate examples of displaying one or more visual representations of non-collocated users in a three-dimensional environment within a multi-user communication session that includes collocated and non-collocated users according to some examples of the disclosure. In FIG. 10A, first electronic device 101a (e.g., associated with first user 1002) and second electronic device 101b (e.g., associated with second user 1004) are collocated in physical environment 1000, as similarly discussed above, while engaging in a multi-user communication session that includes a third electronic device (not shown) associated with a remote user in the multi-user communication session. In some examples, the first user 1002 and the second user 1004 correspond to one or more of the local users described previously above. In some examples, the physical environment 1000 has one or more characteristics of the physical environments discussed previously above.

As shown in FIG. 10A, the first electronic device 101a is presenting (e.g., via display 120a) three-dimensional environment 1050A. In FIG. 10A, as similarly discussed above, the three-dimensional environment 1050A includes representations (e.g., passthrough representations or computer-generated representations) of the physical environment 1000 of the first electronic device 101a from the viewpoint of the first electronic device 101a. For example, as shown in overhead view 1010 in FIG. 10A, the physical environment 1000 corresponds to a room that includes window 1009. Accordingly, as shown in FIG. 10A, the three-dimensional environment 1050A presented using the first electronic device 101a includes a representation of the window 1009 (e.g., the window 1009 is visible in a field of view of the first electronic device 101a). Additionally, in the example of FIG. 10A, because the second user 1004 (e.g., and the second electronic device 101b) is in the field of view of the first electronic device 101a from the viewpoint of the first electronic device 101a, the three-dimensional environment 1050A includes a representation of the second user 1004 (e.g., and the second electronic device 101b). It should be understood that, as similarly described above, the second electronic device 101b is similarly presenting (e.g., via a display) a three-dimensional environment that includes representations (e.g., passthrough representations or computer-generated representations) of the physical environment 1000 from the unique viewpoint of the second electronic device 101b. In some examples, the three-dimensional environment 1050A has one or more characteristics of the three-dimensional environments discussed above.

Additionally, in some examples, as shown in FIG. 10A, the three-dimensional environment 1050A includes virtual object 1020. In some examples, as similarly discussed herein, the virtual object 1020 corresponds to a private virtual object in the multi-user communication session that includes the first electronic device 101a, the second electronic device 101b, and the third electronic device. For example, the content (e.g., user interfaces) of the virtual object 1020 are currently only visible and/or interactive to the first user 1002 in the three-dimensional environment 1050A because the virtual object 1020 is private to the first user 1002 within the multi-user communication session. In some examples, the virtual object 1020 corresponds to or is similar to virtual object 420/520 described above. For example, as previously discussed above, the virtual object 1020 corresponds to and/or includes a music or other media player user interface. Additionally, as shown in FIG. 10A, the virtual object 1020 is optionally displayed with pill 1022 (e.g., indicating that the virtual object 1020 is private to the first user 1002 in the multi-user communication session) and grabber bar 1035 (e.g., which is selectable to initiate movement of the virtual object 1020 in the three-dimensional environment 1050A). In some examples, as discussed in more detail below, the pill 1022 is selectable to initiate a process to share the content of the virtual object 1020 with other users in the multi-user communication session. In some examples, as shown in FIG. 10A, because the third electronic device (e.g., associated with a remote user) is also in the multi-user communication session, the three-dimensional environment 1050A includes a visual representation of a user of the third electronic device. For example, as shown in FIG. 10A, the three-dimensional environment 1050A includes avatar 1005 corresponding to the user of the third electronic device. The avatar 1005 optionally has one or more characteristics of the avatars described previously herein. Additionally, in some examples, the avatar 1005 is initially displayed in the three-dimensional environment 1050A according to any one of the approaches previously described above for determining placement locations of visual representations of remote users in shared three-dimensional environments within multi-user communication sessions.

In FIG. 10A, while displaying the virtual object 1020 in the three-dimensional environment 1050A, the first electronic device 101a detects an input corresponding to selection of the pill 1022 displayed with the virtual object 1020 in the three-dimensional environment 1050A. For example, as shown in FIG. 10A, the first electronic device 101a detects an air pinch gesture performed by hand 1003 of the first user 1002, while gaze 1026 of the first user 1002 is directed to the pill 1022 in the three-dimensional environment 1050A.

In some examples, as shown in FIG. 10B, in response to detecting the selection of the pill 1022 associated with the virtual object 1020, the first electronic device 101a initiates a process to share the content of the virtual object 1020 with one or more users in the multi-user communication session. For example, as shown in FIG. 10B, the first electronic device 101a displays menu element 1027 overlaid on (e.g., and/or in place of) the pill 1022 in the three-dimensional environment 1050A. In some examples, as shown in FIG. 10B, the menu element 1027 includes one or more selectable options for selecting/designating one or more users with whom to share the content of the virtual object 1020 within the multi-user communication session. For example, as shown in FIG. 5B, the menu element 1027 includes selectable option 1028 that is selectable to share the content of the virtual object 1020 with all users in the multi-user communication session, including the second user 1004 of the second electronic device 101b and the user of the third electronic device.

In FIG. 10B, while displaying the menu element 1027 in the three-dimensional environment 1050A, the first electronic device 101a detects a selection input directed to the selectable option 1028. For example, as shown in FIG. 10B, the first electronic device 101a detects an air pinch gesture provided by the hand 1003 of the first user 1002 while the gaze 1026 is directed to the selectable option 1028 in the three-dimensional environment 1050A.

In some examples, in response to detecting the selection of the selectable option 1028, the first electronic device 101a shares the content of the virtual object 1020 with the second electronic device 101b and the third electronic device. For example, the virtual object 1020 becomes a shared object within the multi-user communication session. In some examples, when the first electronic device 101a shares the content of the virtual object 1020 with the second electronic device 101b and the third electronic device in the multi-user communication session, the first electronic device 101a updates display of the avatar 1005 corresponding to the user of the third electronic device in the three-dimensional environment 1050A. Particularly, in some examples, as described below, updating display of the avatar 1005 in the three-dimensional environment 1050A includes moving the avatar 1005 and/or reorienting the avatar 1005 relative to the virtual object 1020 from the viewpoint of the first electronic device 101a in the three-dimensional environment 1050A.

In some examples, as illustrated in the overhead view 1010 in FIG. 10C, the process for updating display of the avatar 1005 in shared three-dimensional environment 1050 (e.g., shared between the first electronic device 101a and the second electronic device 101b associated with the local users in the multi-user communication session) includes applying a predefined shape (e.g., curve or arc, such as a Bezier curve) 1040 to the first electronic device 101a and the second electronic device 101b based on the physical locations of the first electronic device 101a and the second electronic device 101b in the physical environment 1000 discussed above. In some examples, the best-fit or predefined shape is selected based on the type of virtual object that is being shared and presented in the shared three-dimensional environment 1050 when the input for sharing the content of the virtual object is detected. For example, in FIG. 10B, the virtual object 1020 is a vertically oriented virtual object (e.g., the content of the virtual object 1020 is displayed on a front-facing surface of the virtual object 1020), as shown in the overhead view 1010. Accordingly, as shown in the overhead view 1010 in FIG. 10C, the best-fit shape is the curve 1040 (e.g., as opposed to other shapes, such as a circle, as discussed previously herein). In some examples, the curve 1040 has one or more characteristics of curve 440 described previously above. Additionally, in some examples, as indicated in the overhead view 1010 in FIG. 10C, the first electronic device 101a and/or the second electronic device 101b identify a center point 1045 of the virtual object 1020. For example, the center point 1045 corresponds to a geometric center of the front-facing surface of the virtual object 1020 in the shared three-dimensional environment 1050.

In some examples, following the application of the curve 1040 to the locations of the first electronic device 101a and the second electronic device 101b in the shared three-dimensional environment 1050 relative to the virtual object 1020, a current position of the avatar 1005 corresponding to the user of the third electronic device is determined relative to the virtual object 1020. For example, as shown in the overhead view 1010 in FIG. 10D, a line 1043 is established from the center point 1045 of the virtual object 1020 that extends through the current position of the avatar 1005 in the shared three-dimensional environment 1050. Further, in some examples, following the determination of the current position of the avatar 1005 relative to the virtual object 1020 in the shared three-dimensional environment 1050, an updated placement location for the avatar 1005 is determined in the shared three-dimensional environment 1050 based on the curve 1040. For example, as illustrated in the overhead view 1010 in FIG. 10D, the line 1043 that passes through the current location of the avatar 1005 in the shared three-dimensional environment 1050 is extended toward a point on the curve 1040 in the shared three-dimensional environment 1050. Accordingly, the updated placement location for the avatar 1005 optionally corresponds to a location of an intersection between the line 1043 and the curve 1040 in the shared three-dimensional environment 1050, as indicated in the overhead view 1010 in FIG. 10D. In this way, the updated placement location for the avatar 1005 corresponds to a location along the curve 1040 that is spatially closest to the avatar 1005 relative to the virtual object 1020, rather than an arbitrary unoccupied location on the curve 1040.

In some examples, once the updated placement location for the avatar 1005 is determined in the shared three-dimensional environment 1050, the first electronic device 101a and the second electronic device 101b update display of the avatar 1005 to be repositioned at the updated placement location in the shared three-dimensional environment 1050. For example, as illustrated in the overhead view 1010 in FIG. 10E, the avatar 1005 corresponding to the user of the third electronic device is moved to a location in the shared three-dimensional environment corresponding to the updated placement location of FIG. 10D. Accordingly, as shown in FIG. 10E, in some examples, the display of the avatar 1005 is updated in the three-dimensional environment 1050A from the viewpoint of the first electronic device 101a. Additionally, in some examples, as shown in FIG. 10E, when the position of the avatar 1005 is updated in the three-dimensional environment 1050A, the avatar 1005 is rotated/reoriented to face toward the virtual object 1020 in the three-dimensional environment 1050A from the viewpoint of the first electronic device 101a. It should be understood that, as similarly described with reference to the first electronic device 101a, the second electronic device 101b also updates display of the avatar 1005 in the three-dimensional environment 1050B, though in the example of FIG. 10E, the updated placement location of the avatar 1005 is currently outside of the field of view of the second electronic device 101b from the viewpoint of the second electronic device 101b.

Additionally, in some examples, as shown in FIG. 10E, because the content of the virtual object 1020 has been shared in the multi-user communication session, the first electronic device 101a updates display of the pill 1022 associated with the virtual object 1020 to visually indicate that the virtual object 1020 is now a shared virtual object in the three-dimensional environment 1050A. In some examples, as similarly described herein, because the virtual object 1020 is now a shared virtual object, the content of the virtual object 1020 is visible to and/or interactive to the other users in the multi-user communication session, including the second user 1004 of the second electronic device 101b and the user of the third electronic device. Accordingly, as shown in FIG. 10E, the second electronic device 101b updates display of the three-dimensional environment 1050B to include the virtual object 1020. In some examples, as illustrated in the overhead view 1010 in FIG. 10E, the second electronic device 101b displays the virtual object 1020 in the three-dimensional environment 1050B relative to the viewpoint of the second electronic device 101b in a manner that is consistent (e.g., in position and/or orientation) with the display of the virtual object 1020 in the three-dimensional environment 1050A relative to the viewpoint of the first electronic device 101a.

In some examples, if the multi-user communication session included a second remote user (e.g., a user of a fourth electronic device), such that the shared three-dimensional environment included a second avatar (e.g., in addition to the avatar 1005), the first electronic device 101a and/or the second electronic device 101b would follow the above approach for the updating display of the second avatar in the shared three-dimensional environment relative to the virtual object being shared in the multi-user communication session. For example, returning to the overhead view 1010 in FIG. 10D, a second line would be defined in the shared three-dimensional environment 1050 that extends from the center point 1045 of the virtual object 1020, through the position of the second avatar in the shared three-dimensional environment 1050, and to a point on the curve 1040. As discussed above, in some examples, the intersection between the second line and the point on the curve 1040 would correspond to an updated placement location for the second avatar, and the first electronic device 101a and the second electronic device 101b would update display of the second avatar to correspond to the updated placement location in the shared three-dimensional environment 1050. Additionally, it should be understood that the first electronic device 101a and/or the second electronic device 101b would follow the above approach for the updating display of the avatar 1005 in the shared three-dimensional environment relative to a virtual object being shared in the multi-user communication session if the virtual object were alternatively a horizontally oriented virtual object. For example, if the virtual object being shared were alternatively a virtual object similar to virtual object 425 described previously above, a predefined shape corresponding to a circle (e.g., rather than the curve 1040) would be applied to the locations of the first electronic device 101a and the second electronic device 101b, similar to circle 440 described previously above, and a line would be extended from a center point of the horizontally-oriented virtual object through the location of the avatar 1005 and to a point on the circle in the shared three-dimensional environment 1050. In some such examples, as similarly described above, the updated placement location for the avatar 1005 would then correspond to an intersection between the line and the point on the circle in the shared three-dimensional environment 1050.

FIGS. 10F-10K illustrate examples of updating display of one or more visual representations of non-collocated users in a three-dimensional environment within a multi-user communication session that includes collocated and non-collocated users when ceasing sharing of content in the three-dimensional environment. In FIG. 10F, while displaying the virtual object 1020 in the three-dimensional environment 1050A, the first electronic device 101a detects an input corresponding to selection of the pill 1022 displayed with the virtual object 1020 in the three-dimensional environment 1050A. For example, as shown in FIG. 10F, the first electronic device 101a detects an air pinch gesture performed by the hand 1003 of the first user 1002, while the gaze 1026 of the first user 1002 is directed to the pill 1022 in the three-dimensional environment 1050A. In some examples, as indicated by the pill 1022 in FIG. 10F, the selection of the pill 1022 is detected by the first electronic device 101a while the content of the virtual object 1020 is shared (e.g., with the second user 1004 of the second electronic device 101b and the third user represented by the avatar 1005) within the multi-user communication session (e.g., and/or after the methods discussed above with reference to FIGS. 10A-10E are performed).

In some examples, as shown in FIG. 10G, in response to detecting the selection of the pill 1022 associated with the virtual object 1020, the first electronic device 101a initiates a process to cease sharing the content of the virtual object 1020 with one or more users in the multi-user communication session. For example, as shown in FIG. 10G, the first electronic device 101a displays selectable option 1024 overlaid on (e.g., and/or in place of) the pill 1022 in the three-dimensional environment 1050A. In some examples, as shown in FIG. 10G, the selectable option 1024 is selectable to stop sharing the content of the virtual object 1020 with the users in the multi-user communication session, including the second user 1004 of the second electronic device 101b and the user of the third electronic device.

In FIG. 10G, while displaying the selectable option 1024 in the three-dimensional environment 1050A, the first electronic device 101a detects a selection input directed to the selectable option 1024. For example, as shown in FIG. 10G, the first electronic device 101a detects an air pinch gesture provided by the hand 1003 of the first user 1002 while the gaze 1026 is directed to the selectable option 1024 in the three-dimensional environment 1050A.

In some examples, in response to detecting the selection of the selectable option 1024, the first electronic device 101a ceases sharing the content of the virtual object 1020 with the second electronic device 101b and the third electronic device. For example, the virtual object 1020 becomes and/or returns to being a private object within the multi-user communication session (e.g., private to the first user 1002 of the first electronic device 101a) and/or ceases to be displayed in the three-dimensional environment 1050A and/or in the three-dimensional environment 1050B. For example, the content of the virtual object 1020 ceases to be viewable by and/or interactive to the second user 1004 of the second electronic device 101b and the user of the third electronic device within the multi-user communication session. In some examples, when the first electronic device 101a ceases sharing the content of the virtual object 1020 with the second electronic device 101b and the third electronic device in the multi-user communication session, the first electronic device 101a updates display of the avatar 1005 corresponding to the user of the third electronic device in the three-dimensional environment 1050A. Particularly, in some examples, as described below, updating display of the avatar 1005 in the three-dimensional environment 1050A includes moving the avatar 1005 and/or reorienting the avatar 1005 relative to the viewpoint of the first electronic device 101a in the three-dimensional environment 1050A based on the (e.g., prior) location of the virtual object 1020 in the three-dimensional environment 1050A.

In some examples, as illustrated in the overhead view 1010 in FIG. 10H, the process for updating display of the avatar 1005 in the shared three-dimensional environment 1050 (e.g., shared between the first electronic device 101a and the second electronic device 101b associated with the local users in the multi-user communication session) is based on a predefined shape (e.g., curve or arc 1040, such as a Bezier curve) that is based on the virtual object 1020 that is (e.g., currently) displayed in the shared three-dimensional environment 1050 based on and/or according to the physical location of the first electronic device 101a and the physical location of the second electronic device 101b in the shared three-dimensional environment 1050. In some examples, as similarly discussed above, the best-fit or predefined shape is selected based on the type of virtual object that is currently displayed in the shared three-dimensional environment 1050 when the input for ceasing the sharing of the content of the virtual object is detected. For example, in FIG. 10G, the virtual object 1020 is a vertically oriented virtual object (e.g., the content of the virtual object 1020 is displayed on a front-facing surface of the virtual object 1020, as previously discussed above), as shown in the overhead view 1010. Accordingly, as shown in the overhead view 1010 in FIG. 10H, the best-fit shape is the curve 1040 (e.g., as opposed to other shapes, such as a circle, as discussed previously herein). In some examples, the curve 1040 has one or more characteristics of the curve 1040 described previously above.

In some examples, one or more candidate locations at which to move and/or redisplay the avatar 1005 corresponding to the user of the third electronic device are determined in the shared three-dimensional environment 1050. For example, as shown in the overhead view 1010 in FIG. 10H, the first electronic device 101a and/or the second electronic device 101b identify a first candidate location 1041a and a second candidate location 1041b in the shared three-dimensional environment 1050. In some examples, as illustrated in the overhead view 1010 in FIG. 10H, the one or more candidate locations in the shared three-dimensional environment 1050 correspond to and/or are based on openings or gaps in (e.g., unoccupied locations within) a spatial arrangement of the local users in the multi-user communication session relative to the (e.g., current) location of the virtual object 1020 in the shared three-dimensional environment 1050. For example, in FIG. 10H, the first electronic device 101a and/or the second electronic device 101b identify the first candidate location 1041a based on a first gap or opening (e.g., an opening between the location of the second user 1004 and the location of the virtual object 1020) and the second candidate location 1041b based on a second gap or opening (e.g., an opening between the location of the first user 1002 and the location of the second user 1004) in the shared three-dimensional environment 1050. Additionally, in some examples, as illustrated in the overhead view 1010 in FIG. 10J, the first candidate location 1041a and the second candidate location 1041b correspond to locations in the shared three-dimensional environment 1050 that correspond to (e.g., are positioned on) the curve 1040 that is associated with the virtual object 1020 in the shared three-dimensional environment 1050.

In some examples, following the determination/identification of the one or more candidate locations in the shared three-dimensional environment 1050 as discussed above, an updated placement location for the avatar 1005 is determined in the shared three-dimensional environment 1050 based on the one or more candidate locations. Particularly, in some examples, the first electronic device 101a and/or the second electronic device 101b select the candidate location that is spatially closest to the (e.g., current) location of the avatar 1005 in the shared three-dimensional environment 1050 as the updated placement location for the avatar 1005 when ceasing the sharing of the content of the virtual object 1020 as discussed above. For example, as illustrated in the overhead view 1010 in FIG. 10I, the first candidate location 1041a is spatially closer to the location of the avatar 1005 in FIG. 10H than the second candidate location 1041b; accordingly, the first electronic device 101a and/or the second electronic device 101b select the first candidate location 1041a as the updated placement location for the avatar 1005 in the shared three-dimensional environment 1050. Thus, as illustrated in the overhead view 1010 in FIG. 10I, when the first electronic device 101a ceases sharing the content of the virtual object 1020 in the shared three-dimensional environment 1050 (e.g., which optionally causes the virtual object 1020 to no longer be displayed in the shared three-dimensional environment 1050 (e.g., is no longer displayed as a shared virtual object in the shared three-dimensional environment 1050)), the first electronic device 101a and/or the second electronic device 101b move and/or redisplay the avatar 1005 at the updated placement location corresponding to the first candidate location 1041a in the shared three-dimensional environment 1050. Additionally, in some examples, as indicated in the overhead view 1010 in FIG. 10I, when the avatar 1005 is redisplayed at the first candidate location 1041a in the shared three-dimensional environment 1050, the avatar 1005 is displayed with an orientation (e.g., an updated orientation) that faces toward the group of local users in the multi-user communication session (e.g., is displayed with an orientation that is based on an average of the orientations of the first electronic device 101a and the second electronic device 101b, as similarly discussed herein above). In this way, the updated placement location for the avatar 1005 corresponds to a location that is based on the current spatial arrangement of the local users in the multi-user communication session (e.g., based on the curve 1040) relative to the prior location of the virtual object 1020, rather than an arbitrary unoccupied location in the shared three-dimensional environment 1050. For example, the location to which the avatar 1005 is moved in the shared three-dimensional environment 1050 accounts for any changes in physical location of the local users in the shared three-dimensional environment 1050 between detecting input for ceasing the sharing of the content of the virtual object 1020 and the redisplay of the avatar 1005.

FIGS. 10J-10K illustrate an alternative example of updating display of one or more visual representations of non-collocated users in a three-dimensional environment within a multi-user communication session that includes collocated and non-collocated users when ceasing sharing of content in the three-dimensional environment. In FIG. 10J, while displaying virtual object 1025 in the three-dimensional environment 1050A, the first electronic device 101a or the second electronic device 101b has detected an input corresponding to a request to cease sharing the content of the virtual object 1025 (e.g., similar to the inputs described above with reference to FIGS. 10F-10G), as similarly discussed above. In some examples, the virtual object 1025 has one or more characteristics of virtual object 425/525 described above. For example, the virtual object 1025 is a horizontally oriented virtual object and/or includes or corresponds to a virtual game user interface or other volumetric application.

In some examples, as similarly discussed above, in response to detecting the input for ceasing sharing the content of the virtual object 1025 in the shared three-dimensional environment 1050, the first electronic device 101a and the second electronic device 101b initiate a process for updating display of the avatar 1005 corresponding to the user of the third electronic device in the three-dimensional environment 1050A. Particularly, in some examples, as similarly discussed above, updating display of the avatar 1005 in the shared three-dimensional environment 1050 includes moving the avatar 1005 and/or reorienting the avatar 1005 relative to the viewpoint of the first electronic device 101a and the viewpoint of the second electronic device 101b in the shared three-dimensional environment 1050 based on the (e.g., prior) location of the virtual object 1025 in the shared three-dimensional environment 1050.

In some examples, as illustrated in the overhead view 1010 in FIG. 10J and as similarly discussed above, the process for updating display of the avatar 1005 in the shared three-dimensional environment 1050 (e.g., shared between the first electronic device 101a and the second electronic device 101b associated with the local users in the multi-user communication session) is based on a predefined shape (e.g., circle 1040a) that is associated with the virtual object 1025 that is (e.g., currently) displayed in the shared three-dimensional environment 1050 based on and/or according to the physical location of the first electronic device 101a and the physical location of the second electronic device 101b in the shared three-dimensional environment 1050. In some examples, as similarly discussed above, the best-fit or predefined shape is selected based on the type of virtual object that is currently displayed in the shared three-dimensional environment 1050 when the input for ceasing the sharing of the content of the virtual object is detected. For example, in FIG. 10J, the virtual object 1025 is a horizontally oriented virtual object (e.g., the content of the virtual object 1025 is displayed on a top surface of the virtual object 1025, as previously discussed above), as shown in the overhead view 1010. Accordingly, as shown in the overhead view 1010 in FIG. 10J, the best-fit shape is the circle 1040a (e.g., as opposed to other shapes, such as a curve or arc, as discussed previously herein). In some examples, the circle 1040a has one or more characteristics of the circle 440/640 described previously above.

In some examples, as similarly discussed above, one or more candidate locations at which to move and/or redisplay the avatar 1005 corresponding to the user of the third electronic device are determined in the shared three-dimensional environment 1050. For example, as shown in the overhead view 1010 in FIG. 10J, the first electronic device 101a and/or the second electronic device 101b identify a first candidate location 1041a and a second candidate location 1041b in the shared three-dimensional environment 1050. In some examples, as illustrated in the overhead view 1010 in FIG. 10J, the one or more candidate locations in the shared three-dimensional environment 1050 correspond to and/or are based on openings or gaps in (e.g., unoccupied locations within) a spatial arrangement of the local users in the multi-user communication session relative to the (e.g., current) location of the virtual object 1025 in the shared three-dimensional environment 1050. For example, in FIG. 10J, the first electronic device 101a and/or the second electronic device 101b identify the first candidate location 1041a based on a first gap or opening between the location of the first user 1002 and the location of the second user 1004 and the second candidate location 1041b based on a second gap or opening between the location of the first user 1002 and the location of the second user 1004 in the shared three-dimensional environment 1050. Additionally, in some examples, as illustrated in the overhead view 1010 in FIG. 10J, the first candidate location 1041a and the second candidate location 1041b correspond to locations in the shared three-dimensional environment 1050 that correspond to (e.g., are positioned on) the circle 1040a that is associated with the virtual object 1025 in the shared three-dimensional environment 1050.

In some examples, following the determination/identification of the one or more candidate locations in the shared three-dimensional environment 1050 as discussed above, an updated placement location for the avatar 1005 is determined in the shared three-dimensional environment 1050 based on the one or more candidate locations. Particularly, in some examples, the first electronic device 101a and/or the second electronic device 101b select the candidate location that is spatially closest to the (e.g., current) location of the avatar 1005 in the shared three-dimensional environment 1050 as the updated placement location for the avatar 1005 when ceasing the sharing of the content of the virtual object 1025 as discussed above. For example, as illustrated in the overhead view 1010 in FIG. 10K, the first candidate location 1041a is spatially closer to the location of the avatar 1005 in FIG. 10J than the second candidate location 1041b; accordingly, the first electronic device 101a and/or the second electronic device 101b select the first candidate location 1041a as the updated placement location for the avatar 1005 in the shared three-dimensional environment 1050. Thus, as illustrated in the overhead view 1010 in FIG. 10K, when the first electronic device 101a or the second electronic device 101b ceases sharing the content of the virtual object 1025 in the shared three-dimensional environment 1050 (e.g., which optionally causes the virtual object 1025 to no longer be displayed in the shared three-dimensional environment 1050 (e.g., is no longer displayed as a shared virtual object in the shared three-dimensional environment 1050)), the first electronic device 101a and/or the second electronic device 101b move and/or redisplay the avatar 1005 at the updated placement location corresponding to the first candidate location 1041a in the shared three-dimensional environment 1050.

It is noted that, in the examples above, the selected candidate location (e.g., the first candidate location 1041a) to which the avatar 1005 corresponding to the user of the third electronic device is moved and/or redisplayed in the shared three-dimensional environment 1050 following the ceasing the sharing of the content of the virtual object 1020/1025 is a location that is sufficient (e.g., in size and/or position) for the display of the avatar 1005 in the shared three-dimensional environment 1050. For example, the selected candidate location corresponds to an area or region in the shared three-dimensional environment 1050 that is not only based on the current spatial arrangement of the local users (e.g., is adjacent or proximate to the current locations of the first user 1002 and the second user 1004 in the shared three-dimensional environment 1050), but is also large enough (e.g., is of a threshold size or area, such as a rectangular or circular area) for the display of the avatar 1005 in the shared three-dimensional environment 1050. In such an instance, if the first electronic device 101a and/or the second electronic device 101b determine that the first candidate location 1041a, which is closer to the location of the avatar 1005 prior to the ceasing of the sharing of the content of the virtual object 1020/1025 as discussed above than the second candidate location 1041b, is not sufficient for the display of the avatar 1005 (e.g., the first candidate location 1041a is less than the threshold size or area), the first electronic device 101a and/or the second electronic device 101b select an alternative candidate location, such as the second candidate location 1041b, that is sufficient for the display of the avatar 1005 in the shared three-dimensional environment 1050.

Accordingly, as outlined above, providing systems and methods for updating display of visual representations of remote users in a shared three-dimensional environment while in a multi-user communication session when content is shared in the multi-user communication session helps prevent and/or reduce visual obstruction between and/or spatial conflict between the visual representations of the remote users and the shared content from the perspectives of the local users in the multi-user communication session (e.g., when the shared content is displayed and/or during the movement of the visual representations), thereby improving user-device interaction and the shared experience of the content. Additionally, automatically updating display of the locations and/or orientations of the visual representations of the remote users in the shared three-dimensional environment relative to the shared content automatically updates the corresponding viewpoints of the remote users at their electronic devices relative to the shared content, which reduces and/or helps avoid user input for manually updating the viewpoints of the remote users for clearly viewing and/or interacting with the content that has been shared in the multi-user communication session, which helps conserve computing resources that would otherwise be consumed to respond to such user input, as another benefit. Further, providing systems and methods for updating display of visual representations of remote users in the shared three-dimensional environment while in the multi-user communication session when content ceases to be shared in the multi-user communication session enables the visual representations to be automatically repositioned in the shared three-dimensional environment based on a current spatial arrangement of the local users in the multi-user communication session, thereby reducing user input required for manually repositioning the visual representations in the shared three-dimensional environment after ceasing the sharing of the content.

It is understood that the examples shown and described herein are merely exemplary and that additional and/or alternative elements may be provided within the three-dimensional environment for interacting with the illustrative content. It should be understood that the appearance, shape, form and size of each of the various user interface elements and objects shown and described herein are exemplary and that alternative appearances, shapes, forms and/or sizes may be provided. For example, the virtual objects representative of user interfaces (e.g., virtual objects 330, 420, 430, 425, 520, 525 and/or 1020) may be provided in an alternative shape than a rectangular shape, such as a circular shape, triangular shape, etc. In some examples, the various selectable options (e.g., pill 422/522/1022, selectable option 1028, and/or representations 431a-431f), user interface elements (e.g., controls 616), etc. described herein may be selected verbally via user verbal commands (e.g., “select option” verbal command). Additionally or alternatively, in some examples, the various options, user interface elements, control elements, etc. described herein may be selected and/or manipulated via user input received via one or more separate input devices in communication with the electronic device(s). For example, selection input may be received via physical input devices, such as a mouse, trackpad, keyboard, etc. in communication with the electronic device(s).

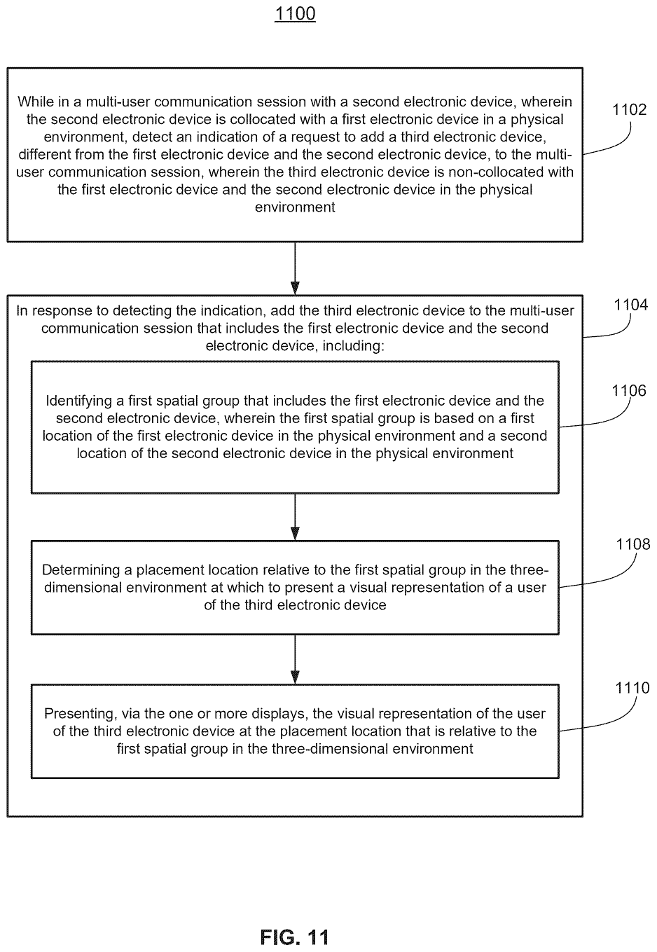

FIG. 11 illustrates a flow diagram illustrating an example process for establishing a multi-user communication session among a plurality of electronic devices in which at least a subset of the plurality of electronic device are non-collocated according to some examples of the disclosure. In some examples, process 1100 begins at a first electronic device in communication with one or more displays and one or more input devices, wherein the first electronic device is collocated with a second electronic device in a physical environment. In some examples, the first electronic device and the second electronic device are optionally a head-mounted display, respectively, similar or corresponding to device 200 of FIG. 2. As shown in FIG. 11, in some examples, at 1102, while in a multi-user communication session with the second electronic device, the first electronic device detects an indication of a request to add a third electronic device, different from the first electronic device and the second electronic device, to the multi-user communication session, wherein the third electronic device is non-collocated with the first electronic device and the second electronic device in the physical environment. For example, as shown in FIG. 4B, first electronic device 101a detects a selection of representation 431f in user interface 430 provided by hand 403 of first user 402, which corresponds to a request to add user “Debbie” to the multi-user communication session between the first electronic device 101a and second electronic device 101b.

In some examples, at 1104, in response to detecting the indication, the first electronic device adds the third electronic device to the multi-user communication session that includes the first electronic device and the second electronic device, including: identifying a first spatial group that includes the first electronic device and the second electronic device, wherein the first spatial group is based on a first location of the first electronic device in the physical environment and a second location of the second electronic device in the physical environment (1106); determining a placement location relative to the first spatial group in the three-dimensional environment at which to present a visual representation of a user of the third electronic device (1108); and presenting, via the one or more displays, the visual representation of the user of the third electronic device at the placement location that is relative to the first spatial group in the three-dimensional environment (1110). For example, as illustrated in overhead view 610 in FIG. 6S, bounding box 645 is applied around the locations of first electronic device 101a and second electronic device 101b in shared three-dimensional environment 650, and a reference point 646 is defined in the shared three-dimensional environment 650 based on the bounding box 645 as illustrated in the overhead view 610 in FIG. 6T. In some examples, one or more placement locations 632a-632c are defined according to circle 640 that is centered on the reference point 646, as illustrated in the overhead view 610 in FIG. 6U, and an avatar 605 corresponding to a user of the third electronic device is presented at one of the placement locations (e.g., first placement location 632a) in the shared three-dimensional environment 650, as show in the overhead view 610 in FIG. 6V.

It is understood that process 1100 is an example and that more, fewer, or different operations can be performed in the same or in a different order. Additionally, the operations in process 1100 described above are, optionally, implemented by running one or more functional modules in an information processing apparatus such as general-purpose processors (e.g., as described with respect to FIG. 2) or application specific chips, and/or by other components of FIG. 2.

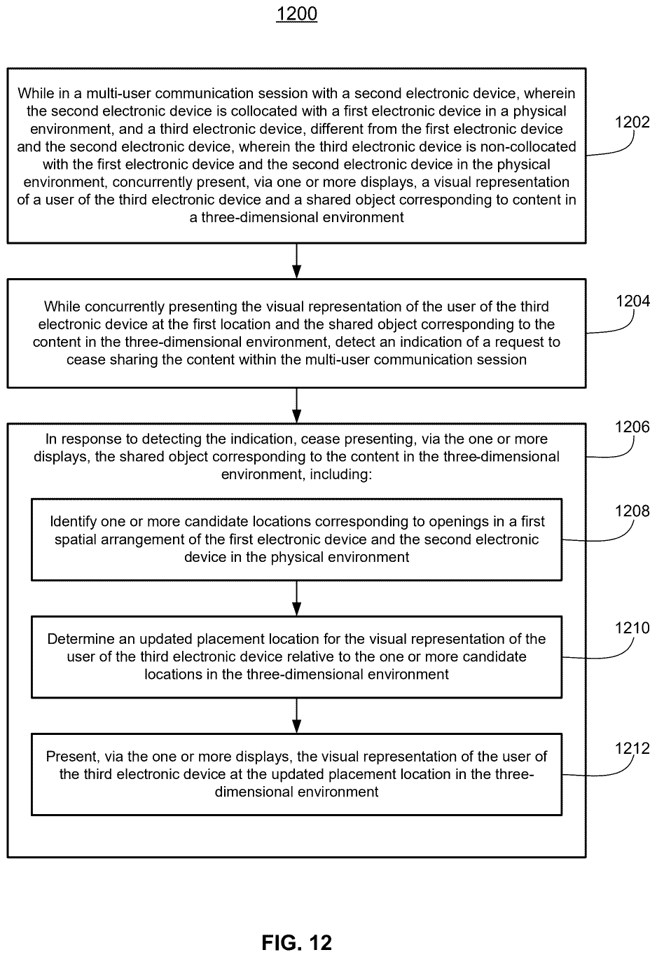

FIG. 12 illustrates a flow diagram illustrating an example process for updating a spatial arrangement of virtual content in a three-dimensional environment relative to a group of collocated users within a hybrid multi-user communication session according to some examples of the disclosure. In some examples, process 1200 begins at a first electronic device in communication with one or more displays and one or more input devices, wherein the first electronic device is collocated with a second electronic device in a physical environment. In some examples, the first electronic device and the second electronic device are optionally a head-mounted display, respectively, similar or corresponding to device 200 of FIG. 2. As shown in FIG. 12, in some examples, at 1202, while in a multi-user communication session with the second electronic device and a third electronic device, different from the first electronic device and the second electronic device, wherein the third electronic device is non-collocated with the first electronic device and the second electronic device in the physical environment, the first electronic device concurrently presents, via the one or more displays, a visual representation of a user of the third electronic device and a shared object corresponding to content in a three-dimensional environment. For example, as shown in FIG. 10F, while in a multi-user communication session with second electronic device 101b associated with second user 1004, first electronic device 101a is concurrently displaying avatar 1005 corresponding to a user of a third electronic device and virtual object 1020, which is shared in the multi-user communication session as indicated by pill 1022, in three-dimensional environment 1050A.

In some examples, at 1204, while concurrently presenting the visual representation of the user of the third electronic device at the first location and the shared object corresponding to the content in the three-dimensional environment, the first electronic device detects an indication of a request to cease sharing the content within the multi-user communication session. For example, as shown in FIG. 10G, the first electronic device 101a detects an input provided by hand 1003 of first user 1002 directed to selectable option 1024 for ceasing sharing the content of the virtual object 1020 in the multi-user communication session.

In some examples, at 1206, in response to detecting the indication, the first electronic device ceases presenting, via the one or more displays, the shared object corresponding to the content in the three-dimensional environment. For example, as illustrated in overhead view 1010 in FIG. 10I, the first electronic device 101a ceases display of the virtual object 1020 in the shared three-dimensional environment 1050. In some examples, at 1208, the first electronic device identifies one or more candidate locations corresponding to openings in a first spatial arrangement of the first electronic device and the second electronic device in the physical environment. In some examples, at 1210, the first electronic device determines an updated placement location for the visual representation of the user of the third electronic device relative to the one or more candidate locations in the three-dimensional environment. In some examples, at 1212, the first electronic device presents, via the one or more displays, the visual representation of the user of the third electronic device at the updated placement location in the three-dimensional environment. For example, as illustrated in the overhead view 1010 in FIG. 10H, the first electronic device 101a identifies first candidate location 1041a and second candidate location 1041b in shared three-dimensional environment 1050 that are based on a spatial arrangement of the first electronic device 101a and the second electronic device 101b, and displays the avatar 1005 corresponding to the user of the third electronic device at the first candidate location 1041a in the shared three-dimensional environment 1050, as shown in the overhead view 1010 in FIG. 10I.

It is understood that process 1200 is an example and that more, fewer, or different operations can be performed in the same or in a different order. Additionally, the operations in process 1200 described above are, optionally, implemented by running one or more functional modules in an information processing apparatus such as general-purpose processors (e.g., as described with respect to FIG. 2) or application specific chips, and/or by other components of FIG. 2.

Therefore, according to the above, some examples of the disclosure are directed to a method comprising, at a first electronic device in communication with one or more displays and one or more input devices, wherein the first electronic device is collocated with a second electronic device in a physical environment: while in a multi-user communication session with the second electronic device and while presenting, via the one or more displays, a shared object in a three-dimensional environment, detecting an indication of a request to add a third electronic device, different from the first electronic device and the second electronic device, to the multi-user communication session, wherein the third electronic device is non-collocated with the first electronic device and the second electronic device in the physical environment; and in response to detecting the indication, adding the third electronic device to the multi-user communication session that includes the first electronic device and the second electronic device, including determining a placement location relative to the shared object in the three-dimensional environment at which to present a visual representation of a user of the third electronic device, wherein the placement location is determined based on a first location of the first electronic device in the physical environment and a second location of the second electronic device in the physical environment, and presenting, via the one or more displays, the visual representation of the user of the third electronic device at the placement location that is relative to the shared object in the three-dimensional environment.

Additionally or alternatively, in some examples, the placement location corresponds to a respective location corresponding to a predefined shape associated with the shared object in the three-dimensional environment, and wherein the predefined shape is based on the first location and the second location in the physical environment. Additionally or alternatively, in some examples, in accordance with a determination that the first location of the first electronic device in the physical environment is closer to the shared object in the three-dimensional environment than the second location of the second electronic device in the physical environment, the predefined shape is defined according to a first respective location in the three-dimensional environment corresponding to the first location in the physical environment, and in accordance with a determination that the second location of the second electronic device in the physical environment is closer to the shared object in the three-dimensional environment than the first location of the first electronic device in the physical environment, the predefined shape is defined according to a second respective location, different from the first respective location, in the three-dimensional environment corresponding to the second location in the physical environment. Additionally or alternatively, in some examples, in accordance with a determination that the first location of the first electronic device in the physical environment is farther from the shared object in the three-dimensional environment than the second location of the second electronic device in the physical environment, the predefined shape is defined according to a first respective location in the three-dimensional environment corresponding to the first location in the physical environment, and in accordance with a determination that the second location of the second electronic device in the physical environment is farther from the shared object in the three-dimensional environment than the first location of the first electronic device in the physical environment, the predefined shape is defined according to a second respective location, different from the first respective location, in the three-dimensional environment corresponding to the second location in the physical environment. Additionally or alternatively, in some examples, in accordance with a determination that the shared object is a first type of object, the predefined shape is a first shape, and in accordance with a determination that the shared object is a second type of object, different from the first type of object, the predefined shape is a second shape, different from the first shape. Additionally or alternatively, in some examples, in accordance with a determination that the first location of the first electronic device in the physical environment satisfies one or more location criteria, the predefined shape is defined according to a second respective location in the three-dimensional environment corresponding to the second location in the physical environment, without intersecting a first respective location in the three-dimensional environment corresponding to the first location in the physical environment, and in accordance with a determination that the second location of the second electronic device in the physical environment satisfies the one or more location criteria, the predefined shape intersects the first respective location in the three-dimensional environment, without intersecting the second respective location in the three-dimensional environment.

Additionally or alternatively, in some examples, the one or more location criteria include a criterion that is satisfied when a respective electronic device is located at a respective location in the physical environment that is behind a front surface of the shared object that includes content in the three-dimensional environment. Additionally or alternatively, in some examples, the one or more location criteria include a criterion that is satisfied when a respective electronic device is located at a respective location in the physical environment that is more than a threshold distance from the shared object in the three-dimensional environment. Additionally or alternatively, in some examples, the shared object is presented in the three-dimensional environment in response to detecting respective input for sharing the shared virtual object in the multi-user communication session, in accordance with a determination that the first electronic device detected the respective input that is provided by a user of the first electronic device, the predefined shape is defined according to a first respective location in the three-dimensional environment corresponding to the first location in the physical environment, and in accordance with a determination that the second electronic device detected the respective input that is provided by a user of the second electronic device, the predefined shape is defined according to a second respective location, different from the first respective location, in the three-dimensional environment corresponding to the second location in the physical environment. Additionally or alternatively, in some examples, the physical environment includes one or more physical objects, and the respective location corresponding to the predefined shape does not overlap with a respective object of the one or more physical objects.

Additionally or alternatively, in some examples, when the visual representation of the user of the third electronic device is presented at the placement location that is relative to the shared object in the three-dimensional environment, the first electronic device remains positioned at the first location in the physical environment and the second electronic device remains positioned at the second location in the physical environment. Additionally or alternatively, in some examples, the placement location in the three-dimensional environment is different from the first location and the second location in the physical environment. Additionally or alternatively, in some examples, the placement location is further determined based on a first orientation of the first electronic device in the physical environment and a second orientation of the second electronic device in the physical environment. Additionally or alternatively, in some examples, determining the placement location based on the first location and the second location in the physical environment includes determining a distance between the first location and the second location in the physical environment. Additionally or alternatively, in some examples, prior to detecting the indication, the multi-user communication session further includes a fourth electronic device that is collocated with the first electronic device and the second electronic device in the physical environment, the method further comprising, in response to detecting the indication, adding the third electronic device to the multi-user communication session that includes the first electronic device, the second electronic device, and the fourth electronic device, including: determining a placement location relative to the shared object in the three-dimensional environment at which to present the visual representation of a user of the third electronic device, wherein the placement location is determined based on the first location, the second location, and a third location of the third electronic device in the physical environment; and presenting, via the one or more displays, the visual representation of the user of the third electronic device at the placement location that is relative to the shared object in the three-dimensional environment.

Additionally or alternatively, in some examples, determining the placement location based on the first location, the second location, and the third location in the physical environment includes determining a first distance between the first location and the second location in the physical environment and a second distance between the second location and the third location in the physical environment, in accordance with a determination that the first distance is greater than the second distance, the placement location is located between the first location and the second location, and in accordance with a determination that the second distance is greater than the first distance, the placement location is located between the second location and the first location. Additionally or alternatively, in some examples, the method further comprises: while presenting the visual representation of the user of the third electronic device at the placement location that is between the first location and the second location because the first distance is greater than the second distance, detecting a second indication of a request to add a fifth electronic device, different from the first electronic device, the second electronic device, the third electronic device, and the fourth electronic device, to the multi-user communication session, wherein the fifth electronic device is non-collocated with the first electronic device, the second electronic device, and the fourth electronic device in the physical environment; and in response to detecting the second indication, adding the fifth electronic device to the multi-user communication session that includes the first electronic device, the second electronic device, the third electronic device, and the fourth electronic device, including presenting, via the one or more displays, a visual representation of a user of the fifth electronic device at a second placement location that is relative to the shared object in the three-dimensional environment and that is between the second location and the third location. Additionally or alternatively, in some examples, when the visual representation of the user of the third electronic device is presented at the placement location in the three-dimensional environment, the visual representation is oriented to face toward the shared object in the three-dimensional environment from the viewpoint of the first electronic device. Additionally or alternatively, in some examples, the method further comprises: while in the multi-user communication session with the second electronic device and the third electronic device, and while presenting the shared object and the visual representation of the user of the third electronic device at the placement location in the three-dimensional environment, detecting a second indication of a request to add a fourth electronic device, different from the first electronic device, the second electronic device, and the third electronic device, to the multi-user communication session, wherein the fourth electronic device is non-collocated with the first electronic device and the second electronic device in the physical environment; and in response to detecting the second indication, adding the fourth electronic device to the multi-user communication session that includes the first electronic device, the second electronic device, and the third electronic device, including determining a second placement location relative to the shared object in the three-dimensional environment at which to present a second visual representation of a user of the fourth electronic device, wherein the second placement location is determined based on the first location and the second location in the physical environment and the placement location of the visual representation of the user of the third electronic device in the three-dimensional environment, and presenting, via the one or more displays, the second visual representation of the user of the fourth electronic device at the second placement location that is relative to the shared object in the three-dimensional environment. Additionally or alternatively, in some examples, the first electronic device, the second electronic device, and the third electronic device include a head-mounted display.

Additionally or alternatively, in some examples, the physical environment includes one or more physical objects, and the placement location is further determined based on one or more physical properties of the one or more physical objects. Additionally or alternatively, in some examples, the shared object is associated with a first spatial template including a plurality of seats in the three-dimensional environment according to which participants in the multi-user communication session are arranged, and in accordance with a determination that at least a first physical property of the one or more physical properties of the one or more physical objects causes a first seat of the plurality of seats of the first spatial template to be obstructed relative to the shared object, the placement location corresponds to a second seat, different from the first seat, of the plurality of seats that is not obstructed by the one or more physical properties of the one or more physical objects relative to the shared object in the three-dimensional environment. Additionally or alternatively, in some examples, the second seat of the plurality of seats corresponds to a location in the three-dimensional environment that is a respective distance from a first location corresponding to the first seat in the three-dimensional environment. Additionally or alternatively, in some examples, the respective distance is a distance required for the visual representation of the user of the third electronic device to be unobstructed by the at least the first physical property of the one or more physical properties of the one or more physical objects in the three-dimensional environment relative to the shared object when the visual representation of the user of the third electronic device is presented at the placement location. Additionally or alternatively, in some examples, the respective distance is more than a threshold distance from the shared object in the three-dimensional environment. Additionally or alternatively, in some examples, the respective distance is within a maximum distance from the first location corresponding to the first seat in the three-dimensional environment. Additionally or alternatively, in some examples, when the visual representation of the user of the third electronic device is presented at the placement location in the three-dimensional environment, a user of the first electronic device, a user of the second electronic device, and the user of the third electronic device each has an unobstructed view of content of the shared object in the three-dimensional environment. Additionally or alternatively, in some examples, in accordance with a determination that the placement location is adjacent to the user of the first electronic device in the three-dimensional environment, a first angular separation between the visual representation of the user of the third electronic device and a viewpoint of the first electronic device is more than a threshold angle relative to a reference vector through the shared object, and in accordance with a determination that the placement location is adjacent to the user of the second electronic device in the three-dimensional environment, a second angular separation between the visual representation of the user of the third electronic device and a viewpoint of the second electronic device is more than the threshold angle relative to the reference vector through the shared object.

Some examples of the disclosure are directed to a method comprising, at a first electronic device in communication with one or more displays and one or more input devices, wherein the first electronic device is collocated with a second electronic device in a physical environment: while in a multi-user communication session with the second electronic device and while presenting, via the one or more displays, a shared object in a three-dimensional environment, detecting an indication of a request to add a third electronic device, different from the first electronic device and the second electronic device, to the multi-user communication session, wherein the third electronic device is non-collocated with the first electronic device and the second electronic device in the physical environment; and in response to detecting the indication, adding the third electronic device to the multi-user communication session that includes the first electronic device and the second electronic device, including associating the multi-user communication session with a first spatial template in the three-dimensional environment, wherein associating the multi-user communication session with the first spatial template includes identifying a first spatial group that includes the first electronic device and the second electronic device, wherein the first spatial group is based on a first location of the first electronic device in the physical environment and a second location of the second electronic device in the physical environment, and aligning the first spatial group with a first plurality of seats within the first spatial template in the three-dimensional environment.

Additionally or alternatively, in some examples, associating the multi-user communication session with the first spatial template further includes, in accordance with a determination that an alignment between the first spatial group and the first plurality of seats causes at least one of the first location of the first electronic device and the second location of the second electronic device to exceed a threshold alignment of one or more seats of the plurality of seats, modifying the first spatial template such that the at least one of the first location of the first electronic device and the second location of the second electronic device are aligned to the one or more seats within the threshold alignment. Additionally or alternatively, in some examples, the threshold alignment is based on a first distance between the first location of the first electronic device and a first seat of the one or more seats and a second distance between the second location of the second electronic device and a second seat, different from the first seat, of the one or more seats. Additionally or alternatively, in some examples, the first plurality of seats within the first spatial template correspond to unoccupied seats within the first spatial template. Additionally or alternatively, in some examples, modifying the first spatial template includes resizing the first spatial template in the three-dimensional environment. Additionally or alternatively, in some examples, modifying the first spatial template is based on a first orientation of the first electronic device at the first location and a second orientation of the second electronic device at the second location. Additionally or alternatively, in some examples, associating the multi-user communication session with the first spatial template further includes, in accordance with a determination that the alignment between the first spatial group and the first plurality of seats does not cause at least one of the first location of the first electronic device and the second location of the second electronic device to exceed the threshold alignment of one or more seats of the plurality of seats, forgoing modifying the first spatial template. Additionally or alternatively, in some examples, adding the third electronic device to the multi-user communication session that includes the first electronic device and the second electronic device further includes presenting, via the one or more displays, a visual representation of a user of the third electronic device at a respective location in the three-dimensional environment, wherein the respective location corresponds to a respective seat that is different from the first plurality of seats within the first spatial template.

Additionally or alternatively, in some examples, aligning the first spatial group with the first plurality of seats within the first spatial template in the three-dimensional environment includes: assigning a first seat of the first plurality of seats within the first spatial template to the first electronic device in the three-dimensional environment, wherein the first seat is within a threshold distance of the first location of the first electronic device; and assigning a second seat, different from the first seat, of the first plurality of seats within the first spatial template to the second electronic device in the three-dimensional environment, wherein the second seat is within the threshold distance of the second location of the second electronic device. Additionally or alternatively, in some examples, the first spatial group is bounded by a first bounding box surrounding the first location of the first electronic device and the second location of the second electronic device. Additionally or alternatively, in some examples, prior to detecting the indication, the multi-user communication session further includes a fourth electronic device that is collocated with the first electronic device and the second electronic device in the physical environment, the method further comprising in response to detecting the indication, adding the third electronic device to the multi-user communication session that includes the first electronic device, the second electronic device, and the fourth electronic device, including associating the multi-user communication session with the first spatial template in the three-dimensional environment, wherein, in accordance with a determination that a respective location of the fourth electronic device in the physical environment is more than a threshold distance from the first location and the second location in the physical environment, the first spatial group includes the first electronic device and the second electronic device without including the fourth electronic device. Additionally or alternatively, in some examples, adding the third electronic device to the multi-user communication session that includes the first electronic device and the second electronic device further includes: presenting, via the one or more displays, a visual representation of a user of the third electronic device at a respective location in the three-dimensional environment; and updating presentation of an orientation of the shared object in the three-dimensional environment based on a first orientation of the first electronic device, a second orientation of the second electronic device, and a third orientation of the visual representation of the user of the third electronic device in the three-dimensional environment. Additionally or alternatively, in some examples, the method further comprises: while in the multi-user communication session with the second electronic device and the third electronic device, and while presenting the shared object and the visual representation of the user of the third electronic device in the three-dimensional environment, detecting a second indication of a request to add a fourth electronic device, different from the first electronic device, the second electronic device, and the third electronic device, to the multi-user communication session, wherein the fourth electronic device is non-collocated with the first electronic device and the second electronic device in the physical environment; and in response to detecting the second indication, adding the fourth electronic device to the multi-user communication session that includes the first electronic device, the second electronic device, and the third electronic device, including presenting, via the one or more displays, a second visual representation of a user of the fourth electronic device at a second respective location in the three-dimensional environment, without updating presentation of the orientation of the shared object.

Additionally or alternatively, in some examples, adding the third electronic device to the multi-user communication session that includes the first electronic device and the second electronic device further includes presenting a visual representation of a user of the third electronic device at a respective location in the three-dimensional environment, wherein the respective location corresponds to a respective seat that is different from the first plurality of seats within the first spatial template, the method further comprising: while in the multi-user communication session with the second electronic device and the third electronic device, and while presenting the shared object and the visual representation of the user of the third electronic device in the three-dimensional environment, detecting a second indication of a request to add a fourth electronic device, different from the first electronic device, the second electronic device, and the third electronic device, to the multi-user communication session, wherein the fourth electronic device is non-collocated with the first electronic device and the second electronic device in the physical environment; and in response to detecting the second indication, adding the fourth electronic device to the multi-user communication session that includes the first electronic device, the second electronic device, and the third electronic device, including presenting, via the one or more displays, a second visual representation of a user of the fourth electronic device at a second respective location in the three-dimensional environment, wherein the second respective location corresponds to a second respective seat that is different from the respective seat and the first plurality of seats within the first spatial template. Additionally or alternatively, in some examples, in accordance with a determination that the shared object is a first type of object, the first spatial template is a first type of spatial template, and in accordance with a determination that the shared object is a second type of object, different from the first type of object, the first spatial template is a second type of spatial template, different from the first type of spatial template. In some examples, aligning the first spatial group with the first plurality of seats within the first spatial template in the three-dimensional environment includes applying a physics-based model that simulates attraction between the first location of the first electronic device and a first seat of the first plurality of seats within the first spatial template and between the second location of the second electronic device and a second seat, different from the first seat, of the first plurality of seats within the first spatial template in the three-dimensional environment. Additionally or alternatively, in some examples, the first electronic device, the second electronic device, and the third electronic device include a head-mounted display.

Additionally or alternatively, in some examples, presenting the visual representation of the user of the third electronic device at the placement location that is relative to the shared object in the three-dimensional environment includes, in accordance with a determination that a width of the shared object in the three-dimensional environment is within a width threshold: determining a reference point in the three-dimensional environment that is based on the first location of the first electronic device or the second location of the second electronic device in the physical environment and a center point of the shared object in the three-dimensional environment; and orienting the visual representation of the user of the third electronic device to face toward the reference point in the three-dimensional environment from the viewpoint of the first electronic device.

Some examples of the disclosure are directed to a method comprising, at a first electronic device in communication with one or more displays and one or more input devices, wherein the first electronic device is collocated with a second electronic device in a physical environment: while in a multi-user communication session with the second electronic device, detecting an indication of a request to add a third electronic device, different from the first electronic device and the second electronic device, to the multi-user communication session, wherein the third electronic device is non-collocated with the first electronic device and the second electronic device in the physical environment; and in response to detecting the indication, adding the third electronic device to the multi-user communication session that includes the first electronic device and the second electronic device, including determining a placement location in the three-dimensional environment at which to present a two-dimensional representation of a user of the third electronic device, wherein the placement location is determined based on a first pose of the first electronic device in the physical environment and a second pose of the second electronic device in the physical environment, and presenting, via the one or more displays, the two-dimensional representation of the user of the third electronic device at the placement location in the three-dimensional environment.

Additionally or alternatively, in some examples, the first pose of the first electronic device corresponds to a first position and a first orientation of the first electronic device in the physical environment, and the second pose of the second electronic device corresponds to a second position and a second orientation of the second electronic device in the physical environment. Additionally or alternatively, in some examples, the placement location of the visual representation of the user of the third electronic device is a fixed distance from the first position and the second position in the physical environment. Additionally or alternatively, in some examples, the placement location of the visual representation of the user of the third electronic device corresponds to an average orientation that is based on the first orientation and the second orientation. Additionally or alternatively, in some examples, determining the placement location in the three-dimensional environment at which to present the two-dimensional representation of the user of the third electronic device includes: in accordance with a determination that the first pose of the first electronic device is a first respective pose and the second pose of the second electronic device is a second respective pose, the placement location is a first distance from the first electronic device and the second electronic device in the three-dimensional environment; and in accordance with a determination that the first pose of the first electronic device is a third respective pose, different from the first respective pose, and the second pose of the second electronic device is a second respective pose, different from the second respective pose, the placement location is a second distance, different from the first distance, from the first electronic device and the second electronic device in the three-dimensional environment. Additionally or alternatively, in some examples, the method further comprises: while in the multi-user communication session with the second electronic device and the third electronic device and while presenting the two-dimensional representation of the user of the third electronic device at the placement location in the three-dimensional environment, detecting an indication of input received at the third electronic device corresponding to a request to represent the user of the third electronic device as a three-dimensional representation; and in response to detecting the indication of the input, replacing presentation of the two-dimensional representation of the user of the third electronic device with a three-dimensional representation of the user of the third electronic device at the placement location in the three-dimensional environment. Additionally or alternatively, in some examples, the method further comprises: while in the multi-user communication session with the second electronic device and the third electronic device and while presenting the three-dimensional representation of the user of the third electronic device at the placement location in the three-dimensional environment, detecting a second indication of a request to add a fourth electronic device, different from the first electronic device, the second electronic device, and the third electronic device, to the multi-user communication session, wherein the fourth electronic device is non-collocated with the first electronic device and the second electronic device in the physical environment; and in response to detecting the indication, adding the fourth electronic device to the multi-user communication session that includes the first electronic device, the second electronic device, and the third electronic device, including presenting, via the one or more displays, a two-dimensional representation of a user of the fourth electronic device at a second placement location in the three-dimensional environment, and updating presentation of at least one of a position and an orientation of the three-dimensional representation of the user of the third electronic device in the three-dimensional environment based on the second placement location.

Additionally or alternatively, in some examples, prior to the first electronic device detecting the indication, the multi-user communication session is associated with a respective spatial template that includes a plurality of seats in the three-dimensional environment, a first seat of the plurality of seats within the respective spatial template is reserved for two-dimensional representations of electronic devices within the multi-user communication session; and the placement location of the two-dimensional representation of the user of the third electronic device in the three-dimensional environment corresponds to the first seat of the plurality of seats. Additionally or alternatively, in some examples, when the two-dimensional representation of the user of the third electronic device is presented at the placement location in the three-dimensional environment, the multi-user communication session remains associated with the respective spatial template in the three-dimensional environment. Additionally or alternatively, in some examples, the method further comprises: while in the multi-user communication session with the second electronic device and the third electronic device and while presenting the two-dimensional representation of the user of the third electronic device at the placement location in the three-dimensional environment, detecting an indication of input corresponding to a request to share content in the multi-user communication session; and in response to detecting the indication of input, presenting, via the one or more displays, a shared object at a respective location in the three-dimensional environment based on the respective spatial template, and maintaining presentation of the two-dimensional representation of the user of the third electronic device at the placement location in the three-dimensional environment. Additionally or alternatively, in some examples, the method further comprises: while in the multi-user communication session with the second electronic device and the third electronic device and while presenting the two-dimensional representation of the user of the third electronic device at the placement location in the three-dimensional environment, detecting a second indication of a request to add a fourth electronic device, different from the first electronic device, the second electronic device, and the third electronic device, to the multi-user communication session, wherein the fourth electronic device is non-collocated with the first electronic device and the second electronic device in the physical environment; and in response to detecting the indication, adding the fourth electronic device to the multi-user communication session that includes the first electronic device, the second electronic device, and the third electronic device, including replacing presentation, via the one or more displays, of the two-dimensional representation of the user of the third electronic device with a virtual window that concurrently includes the two-dimensional representation of the user of the third electronic device and a two-dimensional representation of a user of the fourth electronic device, wherein the virtual window is presented at the placement location in the three-dimensional environment.

Additionally or alternatively, in some examples, the two-dimensional representation of the user of the third electronic device occupies a first portion of the virtual window and the two-dimensional representation of the user of the fourth electronic device occupies a second portion, different from the first portion, of the virtual window, the method further comprising: while in the multi-user communication session with the second electronic device and the third electronic device and while presenting the virtual window at the placement location in the three-dimensional environment, detecting an indication of input received at the third electronic device corresponding to a request to represent the user of the third electronic device as a three-dimensional representation; and in response to detecting the indication of the input, removing the two-dimensional representation of the user of the third electronic device from the virtual window in the three-dimensional environment, and presenting, via the one or more displays, a three-dimensional representation of the user of the third electronic device at a respective location in the three-dimensional environment that is based on the first portion of the virtual window. Additionally or alternatively, in some examples, the method further comprises: while in the multi-user communication session with the second electronic device and the third electronic device and while presenting the virtual window at the placement location in the three-dimensional environment, detecting an indication of input received at the third electronic device corresponding to a request to represent the user of the third electronic device as a three-dimensional representation; and in response to detecting the indication of the input, removing the two-dimensional representation of the user of the third electronic device from the virtual window in the three-dimensional environment, and presenting, via the one or more displays, a three-dimensional representation of the user of the third electronic device at a respective location in the three-dimensional environment, wherein the respective location causes the three-dimensional representation of the user of the third electronic device to be oriented toward the virtual window in the three-dimensional environment from the viewpoint of the first electronic device. Additionally or alternatively, in some examples, the first electronic device, the second electronic device, and the third electronic device include a head-mounted display.

Some examples of the disclosure are directed to a method comprising, at a first electronic device in communication with one or more displays and one or more input devices, wherein the first electronic device is collocated with a second electronic device in a physical environment: while in a multi-user communication session with the second electronic device, detecting an indication of a request to add a third electronic device, different from the first electronic device and the second electronic device, to the multi-user communication session, wherein the third electronic device is non-collocated with the first electronic device and the second electronic device in the physical environment; and in response to detecting the indication, adding the third electronic device to the multi-user communication session that includes the first electronic device and the second electronic device, including identifying a first spatial group that includes the first electronic device and the second electronic device, wherein the first spatial group is based on a first location of the first electronic device in the physical environment and a second location of the second electronic device in the physical environment, determining a placement location relative to the first spatial group in the three-dimensional environment at which to present a visual representation of a user of the third electronic device, and presenting, via the one or more displays, the visual representation of the user of the third electronic device at the placement location that is relative to the first spatial group in the three-dimensional environment.

Additionally or alternatively, in some examples, the placement location is different from the first location of the first electronic device and the second location of the second electronic device in the physical environment. Additionally or alternatively, in some examples, in accordance with a determination that one or more criteria are satisfied, the first spatial group is bounded by a first bounding box surrounding the first location of the first electronic device and the second location of the second electronic device. Additionally or alternatively, in some examples, a width of the first bounding box corresponds to a distance between the first location and the second location in the physical environment. Additionally or alternatively, in some examples, the one or more criteria include a criterion that is satisfied when a distance between the first location and the second location in the physical environment is less than a threshold distance. Additionally or alternatively, in some examples, the first spatial group is associated with a reference point in the three-dimensional environment according to which the placement location is determined in the three-dimensional environment. Additionally or alternatively, in some examples, the first spatial group corresponds to a circle that is centered on the reference point in the three-dimensional environment, and the placement location in the three-dimensional environment corresponds to a location on the circle. Additionally or alternatively, in some examples, a radius of the circle is determined by the first location and the second location in the physical environment. Additionally or alternatively, in some examples, the reference point is determined in the three-dimensional environment based on a first orientation of the first electronic device and a second orientation of the second electronic device. Additionally or alternatively, in some examples, the visual representation of the user of the third electronic device is presented at the placement location with a respective orientation that faces toward the reference point in the three-dimensional environment.

Additionally or alternatively, in some examples, the method further comprises: while in the multi-user communication session with the second electronic device and the third electronic device, detecting a second indication of a request to add a fourth electronic device, different from the first electronic device, the second electronic device, and the third electronic device, to the multi-user communication session, wherein the fourth electronic device is non-collocated with the first electronic device and the second electronic device in the physical environment; and in response to detecting the second indication, adding the fourth electronic device to the multi-user communication session that includes the first electronic device, the second electronic device, and the third electronic device, including identifying a second spatial group that includes the first electronic device, the second electronic device and the third electronic device, wherein the second spatial group is based on the first location of the first electronic device in the physical environment, the second location of the second electronic device in the physical environment, and the placement location of the visual representation of the user of the third electronic device in the three-dimensional environment, determining a second placement location relative to the second spatial group in the three-dimensional environment at which to present a visual representation of a user of the fourth electronic device, and presenting, via the one or more displays, the visual representation of the user of the fourth electronic device at the placement location that is relative to the second spatial group in the three-dimensional environment. Additionally or alternatively, in some examples, the method further comprises: while in the multi-user communication session with the second electronic device and the third electronic device, detecting an indication of a request to share content in the three-dimensional environment; and in response to detecting the indication, presenting, via the one or more displays, a shared object corresponding to the shared content in the three-dimensional environment, and updating presentation of the visual indication of the user of the third electronic device in the three-dimensional environment, including moving the visual indication of the user of the third electronic device from a viewpoint of the first electronic device in the three-dimensional environment.

Additionally or alternatively, in some examples, updating presentation of the visual indication of the user of the third electronic device in the three-dimensional environment includes: applying a predefined shape relative to the shared object in the three-dimensional environment that is based on the first location of the first electronic device and the second location of the second electronic device; defining a line between a center of the shared object in the three-dimensional environment and a portion of the predefined shape; and moving the visual indication of the user of the third electronic device to a respective location in the three-dimensional environment that corresponds to an intersection between the line and the portion of the predefined shape. Additionally or alternatively, in some examples, in accordance with a determination that the shared object is a first type of object, the predefined shape is a first shape, and in accordance with a determination that the shared object is a second type of object, different from the first type of object, the predefined shape is a second shape, different from the first shape. Additionally or alternatively, in some examples, when the presentation of the visual representation of the user of the third electronic device is updated in the three-dimensional environment, the visual representation is oriented to face toward the shared object in the three-dimensional environment from the viewpoint of the first electronic device. Additionally or alternatively, in some examples, the first electronic device, the second electronic device, and the third electronic device include a head-mounted display.

Some examples of the disclosure are directed to a method comprising, at a first electronic device in communication with one or more displays and one or more input devices, wherein the first electronic device is collocated with a second electronic device in a physical environment: while in a multi-user communication session with the second electronic device and a third electronic device, different from the first electronic device and the second electronic device, wherein the third electronic device is non-collocated with the first electronic device and the second electronic device in the physical environment, concurrently presenting, via the one or more displays, a visual representation of a user of the third electronic device and a shared object corresponding to content in a three-dimensional environment; while concurrently presenting the visual representation of the user of the third electronic device at the first location and the shared object corresponding to the content in the three-dimensional environment, detecting an indication of a request to cease sharing the content within the multi-user communication session; and in response to detecting the indication, ceasing presenting, via the one or more displays, the shared object corresponding to the content in the three-dimensional environment, including: identifying one or more candidate locations corresponding to openings in a first spatial arrangement of the first electronic device and the second electronic device in the physical environment; determining an updated placement location for the visual representation of the user of the third electronic device relative to the one or more candidate locations in the three-dimensional environment; and presenting, via the one or more displays, the visual representation of the user of the third electronic device at the updated placement location in the three-dimensional environment.

Additionally or alternatively, in some examples, the updated placement location in the three-dimensional environment is different from a first location of the first electronic device in the physical environment and a second location of the second electronic device in the physical environment. Additionally or alternatively, in some examples, while the shared object corresponding to the content is presented in the three-dimensional environment, the first spatial arrangement of the first electronic device and the second electronic device is based on a first spatial template associated with the shared object in the three-dimensional environment. Additionally or alternatively, in some examples, the first spatial template associated with the shared object is based on an object type of the shared object. Additionally or alternatively, in some examples, while the shared object corresponding to the content is presented in the three-dimensional environment, the visual representation of the user of the third electronic device is presented at a respective location in the three-dimensional environment corresponding to a first seat of a plurality of seats within the first spatial template associated with the shared object. Additionally or alternatively, in some examples, in response to detecting the indication: in accordance with a determination that the first spatial template is a first type of spatial template, the updated placement location is a first location in the three-dimensional environment; and in accordance with a determination that the first spatial template is a second type of spatial template, different from the first type of spatial template, the updated placement location is a second location, different from the first location, in the three-dimensional environment. Additionally or alternatively, in some examples, identifying the one or more candidate locations corresponding to the openings in the first spatial arrangement of the first electronic device and the second electronic device includes evaluating one or more distances between a first location of the first electronic device in the physical environment and a second location of the second electronic device in the physical environment. Additionally or alternatively, in some examples, the updated placement location in the three-dimensional environment corresponds to a first candidate location of the one or more candidate locations, wherein the first candidate location satisfies one or more selection criteria.

Additionally or alternatively, in some examples, while the shared object corresponding to the content is presented in the three-dimensional environment, the visual representation of the user of the third electronic device is presented at a first location in the three-dimensional environment, and the one or more selection criteria include a criterion that is satisfied when a respective candidate location of the one or more candidate locations is spatially closest to the first location in the three-dimensional environment of the one or more candidate locations. Additionally or alternatively, in some examples, the one or more selection criteria include a criterion that is satisfied when a respective candidate location of the one or more candidate locations corresponds to a region having at least a threshold size in the three-dimensional environment. Additionally or alternatively, in some examples, while the shared object corresponding to the content is presented in the three-dimensional environment, the first electronic device is located at a first location in the physical environment and the second electronic device is located at a second location in the physical environment, and after the indication is detected, the first electronic device is located at a third location in the physical environment and the second electronic device is located at a fourth location in the physical environment. Additionally or alternatively, in some examples, when the indication is detected, the multi-user communication session further includes a fourth electronic device that is collocated with the first electronic device and the second electronic device in the physical environment, and in response to detecting the indication, the one or more candidate locations corresponding to the openings in the first spatial arrangement of the first electronic device and the second electronic device is further based on a respective location of the fourth electronic device within the first spatial arrangement. Additionally or alternatively, in some examples, identifying the one or more candidate locations corresponding to the openings in the first spatial arrangement of the first electronic device, the second electronic device, and the fourth electronic device includes evaluating one or more distances between a first location of the first electronic device in the physical environment, a second location of the second electronic device in the physical environment, and a third location of the fourth electronic device in the physical environment. Additionally or alternatively, in some examples, the first electronic device, the second electronic device, and the third electronic device each includes a head-mounted display.

Some examples of the disclosure are directed to a first electronic device comprising: one or more processors; memory; and one or more programs stored in the memory and configured to be executed by the one or more processors, the one or more programs including instructions for performing any of the above methods.

Some examples of the disclosure are directed to a non-transitory computer readable storage medium storing one or more programs, the one or more programs comprising instructions, which when executed by one or more processors of a first electronic device, cause the first electronic device to perform any of the above methods.

Some examples of the disclosure are directed to a first electronic device, comprising one or more processors, memory, and means for performing any of the above methods.

Some examples of the disclosure are directed to an information processing apparatus for use in a first electronic device, the information processing apparatus comprising means for performing any of the above methods.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the disclosure and its practical applications, to thereby enable others skilled in the art to best use the disclosure and various described examples with various modifications as are suited to the particular use contemplated.

What is claimed is:

1. A method comprising:
at a first electronic device in communication with one or more displays and one or more input devices, wherein the first electronic device is collocated with a second electronic device in a physical environment:
while in a multi-user communication session with the second electronic device and while presenting, via the one or more displays, a shared object in a three-dimensional environment, detecting an indication of a request to add a third electronic device, different from the first electronic device and the second electronic device, to the multi-user communication session, wherein the third electronic device is non-collocated with the first electronic device and the second electronic device in the physical environment; and
in response to detecting the indication, adding the third electronic device to the multi-user communication session that includes the first electronic device and the second electronic device, including:
determining a placement location relative to the shared object in the three-dimensional environment at which to present a visual representation of a user of the third electronic device, wherein the placement location is determined based on a first location of the first electronic device in the physical environment and a second location of the second electronic device in the physical environment; and
presenting, via the one or more displays, the visual representation of the user of the third electronic device at the placement location that is relative to the shared object in the three-dimensional environment.

2. The method of claim 1, wherein the placement location corresponds to a respective location corresponding to a predefined shape associated with the shared object in the three-dimensional environment, and wherein the predefined shape is based on the first location and the second location in the physical environment.

3. The method of claim 1, wherein, when the visual representation of the user of the third electronic device is presented at the placement location that is relative to the shared object in the three-dimensional environment, the first electronic device remains positioned at the first location in the physical environment and the second electronic device remains positioned at the second location in the physical environment.

4. The method of claim 1, wherein the placement location is further determined based on a first orientation of the first electronic device in the physical environment and a second orientation of the second electronic device in the physical environment.

5. The method of claim 1, wherein, prior to detecting the indication, the multi-user communication session further includes a fourth electronic device that is collocated with the first electronic device and the second electronic device in the physical environment, the method further comprising:
in response to detecting the indication, adding the third electronic device to the multi-user communication session that includes the first electronic device, the second electronic device, and the fourth electronic device, including:
determining a placement location relative to the shared object in the three-dimensional environment at which to present the visual representation of a user of the third electronic device, wherein the placement location is determined based on the first location, the second location, and a third location of the third electronic device in the physical environment; and
presenting, via the one or more displays, the visual representation of the user of the third electronic device at the placement location that is relative to the shared object in the three-dimensional environment.

6. The method of claim 1, wherein:
the physical environment includes one or more physical objects; and
the placement location is further determined based on one or more physical properties of the one or more physical objects.

7. The method of claim 6, wherein:
the shared object is associated with a first spatial template including a plurality of seats in the three-dimensional environment according to which participants in the multi-user communication session are arranged; and
in accordance with a determination that at least a first physical property of the one or more physical properties of the one or more physical objects causes a first seat of the plurality of seats of the first spatial template to be obstructed relative to the shared object, the placement location corresponds to a second seat, different from the first seat, of the plurality of seats that is not obstructed by the one or more physical properties of the one or more physical objects relative to the shared object in the three-dimensional environment.

8. The method of claim 7, wherein the second seat of the plurality of seats corresponds to a location in the three-dimensional environment that is a respective distance from a first location corresponding to the first seat in the three-dimensional environment.

9. A first electronic device comprising:
one or more processors;
memory; and
one or more programs stored in the memory and configured to be executed by the one or more processors, the one or more programs including instructions for performing a method comprising:
while in a multi-user communication session with a second electronic device, wherein the first electronic device is collocated with the second electronic device in a physical environment, and while presenting, via one or more displays, a shared object in a three-dimensional environment, detecting an indication of a request to add a third electronic device, different from the first electronic device and the second electronic device, to the multi-user communication session, wherein the third electronic device is non-collocated with the first electronic device and the second electronic device in the physical environment; and
in response to detecting the indication, adding the third electronic device to the multi-user communication session that includes the first electronic device and the second electronic device, including:
determining a placement location relative to the shared object in the three-dimensional environment at which to present a visual representation of a user of the third electronic device, wherein the placement location is determined based on a first location of the first electronic device in the physical environment and a second location of the second electronic device in the physical environment; and
presenting, via one or more displays, the visual representation of the user of the third electronic device at the placement location that is relative to the shared object in the three-dimensional environment.

10. The first electronic device of claim 9, wherein the placement location corresponds to a respective location corresponding to a predefined shape associated with the shared object in the three-dimensional environment, and wherein the predefined shape is based on the first location and the second location in the physical environment.

11. The first electronic device of claim 9, wherein, when the visual representation of the user of the third electronic device is presented at the placement location that is relative to the shared object in the three-dimensional environment, the first electronic device remains positioned at the first location in the physical environment and the second electronic device remains positioned at the second location in the physical environment.

12. The first electronic device of claim 9, wherein the placement location is further determined based on a first orientation of the first electronic device in the physical environment and a second orientation of the second electronic device in the physical environment.

13. The first electronic device of claim 9, wherein, prior to detecting the indication, the multi-user communication session further includes a fourth electronic device that is collocated with the first electronic device and the second electronic device in the physical environment, the method further comprising:
in response to detecting the indication, adding the third electronic device to the multi-user communication session that includes the first electronic device, the second electronic device, and the fourth electronic device, including:
determining a placement location relative to the shared object in the three-dimensional environment at which to present the visual representation of a user of the third electronic device, wherein the placement location is determined based on the first location, the second location, and a third location of the third electronic device in the physical environment; and
presenting, via the one or more displays, the visual representation of the user of the third electronic device at the placement location that is relative to the shared object in the three-dimensional environment.

14. The first electronic device of claim 9, wherein:
the physical environment includes one or more physical objects; and
the placement location is further determined based on one or more physical properties of the one or more physical objects.

15. The first electronic device of claim 14, wherein:
the shared object is associated with a first spatial template including a plurality of seats in the three-dimensional environment according to which participants in the multi-user communication session are arranged; and
in accordance with a determination that at least a first physical property of the one or more physical properties of the one or more physical objects causes a first seat of the plurality of seats of the first spatial template to be obstructed relative to the shared object, the placement location corresponds to a second seat, different from the first seat, of the plurality of seats that is not obstructed by the one or more physical properties of the one or more physical objects relative to the shared object in the three-dimensional environment.

16. The first electronic device of claim 15, wherein the second seat of the plurality of seats corresponds to a location in the three-dimensional environment that is a respective distance from a first location corresponding to the first seat in the three-dimensional environment.

17. A non-transitory computer readable storage medium storing one or more programs, the one or more programs comprising instructions, which when executed by one or more processors of a first electronic device, cause the first electronic device to perform a method comprising:
while in a multi-user communication session with a second electronic device, wherein the first electronic device is collocated with the second electronic device in a physical environment, and while presenting, via one or more displays, a shared object in a three-dimensional environment, detecting an indication of a request to add a third electronic device, different from the first electronic device and the second electronic device, to the multi-user communication session, wherein the third electronic device is non-collocated with the first electronic device and the second electronic device in the physical environment; and
in response to detecting the indication, adding the third electronic device to the multi-user communication session that includes the first electronic device and the second electronic device, including:
determining a placement location relative to the shared object in the three-dimensional environment at which to present a visual representation of a user of the third electronic device, wherein the placement location is determined based on a first location of the first electronic device in the physical environment and a second location of the second electronic device in the physical environment; and
presenting, via one or more displays, the visual representation of the user of the third electronic device at the placement location that is relative to the shared object in the three-dimensional environment.

18. The non-transitory computer readable storage medium of claim 17, wherein the placement location corresponds to a respective location corresponding to a predefined shape associated with the shared object in the three-dimensional environment, and wherein the predefined shape is based on the first location and the second location in the physical environment.

19. The non-transitory computer readable storage medium of claim 17, wherein, when the visual representation of the user of the third electronic device is presented at the placement location that is relative to the shared object in the three-dimensional environment, the first electronic device remains positioned at the first location in the physical environment and the second electronic device remains positioned at the second location in the physical environment.

20. The non-transitory computer readable storage medium of claim 17, wherein the placement location is further determined based on a first orientation of the first electronic device in the physical environment and a second orientation of the second electronic device in the physical environment.

21. The non-transitory computer readable storage medium of claim 17, wherein, prior to detecting the indication, the multi-user communication session further includes a fourth electronic device that is collocated with the first electronic device and the second electronic device in the physical environment, the method further comprising:
in response to detecting the indication, adding the third electronic device to the multi-user communication session that includes the first electronic device, the second electronic device, and the fourth electronic device, including:
determining a placement location relative to the shared object in the three-dimensional environment at which to present the visual representation of a user of the third electronic device, wherein the placement location is determined based on the first location, the second location, and a third location of the third electronic device in the physical environment; and
presenting, via the one or more displays, the visual representation of the user of the third electronic device at the placement location that is relative to the shared object in the three-dimensional environment.

22. The non-transitory computer readable storage medium of claim 17, wherein:
the physical environment includes one or more physical objects; and
the placement location is further determined based on one or more physical properties of the one or more physical objects.

23. The non-transitory computer readable storage medium of claim 22, wherein:
the shared object is associated with a first spatial template including a plurality of seats in the three-dimensional environment according to which participants in the multi-user communication session are arranged; and
in accordance with a determination that at least a first physical property of the one or more physical properties of the one or more physical objects causes a first seat of the plurality of seats of the first spatial template to be obstructed relative to the shared object, the placement location corresponds to a second seat, different from the first seat, of the plurality of seats that is not obstructed by the one or more physical properties of the one or more physical objects relative to the shared object in the three-dimensional environment.

24. The non-transitory computer readable storage medium of claim 23, wherein the second seat of the plurality of seats corresponds to a location in the three-dimensional environment that is a respective distance from a first location corresponding to the first seat in the three-dimensional environment.
